(19) United States
(12) Patent Application Publication
(10) Pub. No.: US 2025/0303362 A1
(43) Pub. Date: Oct. 2, 2025

(54) SCR REACTOR SYSTEM, SCR REACTOR ASSEMBLY, SCR REACTOR APPARATUS, AND MIXING DEVICE, AND METHODS OF USING AND ASSEMBLING EACH OF THE SAME

(71) Applicant: UMICORE AG & CO. KG, Hanau-Wolfgang (DE)

(72) Inventors: Thomas Nathan WHITE, Fort Mill, SC (US); Joseph Craig SHARP, Sugarland, TX (US)

(73) Assignee: UMICORE AG & CO. KG, Hanau-Wolfgang (DE)

(21) Appl. No.: 18/621,572

(22) Filed: Mar. 29, 2024

(51) Int. Cl. B01D 53/86; B01D 53/90; B01F 25/422; B01F 25/431; B01F 101/00; F23J 15/00

(52) U.S. Cl. CPC B01D 53/8631; B01D 53/90; B01F 25/422; B01F 25/4315; B01F 25/43197; F23J 15/003; B01D 2251/2062; B01D 2257/404; B01D 2258/0283; B01D 2259/124; B01F 2101/2204; F23J 2215/10; F23J 2219/10

(57) ABSTRACT

An intermixer or mixing device with frame structure and suspended bluff body array for use in a stationary (e.g., non-auto) SCR catalyst environment to reduce RMS levels of a mix of NOₓ pollutant and reduction reagent. SCR reactor apparatus with SCR catalyst module block supported on the intermixer. The SCR reactor apparatus works in an SCR reactor assembly having the SCR reactor apparatus at a first SCR1 layer plus a downstream SCR2 layer. The reduced RMS level of the mix coming from the SCR1 layer is readily able to be treated by the SCR2 layer. An SCR system features the SCR reactor assembly and a combustion source such as a coal-fired plant. Methods of assembly and operating each of the mixing device, SCR reactor apparatus, assembly and system are also featured.

### FIELD OF THE INVENTION

The inventive subject matter is inclusive of an SCR reactor system comprised of a combustion gas source (as in a coal fired plant) and an SCR reactor assembly. The SCR reactor assembly comprises exhaust passage ductwork that receives/supports, in exhaust gas flow series, a reduction reagent injector (RRI), a first SCR catalyst article (SCR1) with an associated mixing device or intermixer (SCR1-IM), and a second SCR catalyst article (SCR2) positioned downstream of the SCR1-IM. The SCR1-IM forms an SCR reactor apparatus. Methods of assembling and utilizing each of the same are also featured in the present invention. The invention finds particular utility in stationary SCR systems as in those used to reduce NOₓ while avoiding slippage of a reduction reagent (such as ammonia). Examples of combustion gas sources include thermal power plants (e.g., coal fired power plants), utility boilers, fluid catalytic cracking units (FCC), process heaters, gas turbines, chemical plants, biofuel combustion plants, etc.

### BACKGROUND OF THE INVENTION

In the combustion of a fuel, such as coal, oil, natural gas, peat, waste, etc., in a combustion plant, as in a power plant or a waste incineration plant, an exhaust gas is generated with pollutants such as nitrogen oxides. For separating the nitrogen oxides, usually denoted NOₓ, from the generated exhaust gas one technique employed (often to meet stringent regulations directed at NOₓ reduction) is selective catalytic reduction (or “SCR”). An SCR technique that is frequently used is one featuring an SCR reactor assembly wherein a reduction reagent (also referenced in the art as a reducing agent), usually ammonia or urea, is mixed with the exhaust gas. The combustion exhaust gas, mixed with the reduction reagent, is then passed through an SCR reactor with SCR catalyst to achieve a selective reaction of the reduction reagent with the NOₓ to form nitrogen gas and water vapor.

The reduction reagent (e.g., ammonia) is often supplied to the gas duct by injector nozzles positioned upstream of the first in line SCR catalyst article in the SCR reactor. In an effort to facilitate an even distribution of the concentration of NOₓ and reduction reagent over a given cross section of the gas duct, and thus also over a given cross section of the SCR reactor, it is known to use mixing plates that are positioned in the duct immediately adjacent to the injector nozzles (slightly upstream of the injectors or mounted directly on the ammonia injectors (e.g., see U.S. Pat. No. 8,017,084) or immediately downstream (e.g., see U.S. Pat. Nos. 7,448,794 and 7,547,134)) of those ammonia injectors with a focus of generating a turbulent field relative to the ammonia as soon as it is injected into the ductwork.

While the above-described plating near the ammonia injector region can facilitate the avoidance of excess ammonia and/or excess NOₓ zones across the cross section of the exhaust gas flow leading into the first SCR reactor zone, such systems still have difficulty meeting the more and more rigidly regulated NOₓ reduction levels and reduction reagent slip levels measured at the exit region of the SCR reactor. This has led to a need for either heavily loaded SCRs (e.g., either or both of SCR1 and SCR2 are provided with high catalyst loads) or further added downstream SCRs as in an SCR3 positioned downstream of the SCR2, for example.

SCR reactor system 10 in FIG. 1 shows a conventional system with SCR reactor assembly 11 and combustion gas source 5 (e.g., a coal-fired plant such as one that outputs high levels of NOₓ and other pollutants). FIG. 1 shows an exhaust gas flow FL that is generated by combustion gas source 5 flowing away from combustion gas source 5 through suitable exhaust piping 13 (partially shown with source outlet end 13A and reactor entrance end 13B) and into flow communication with the inlet end 12 of SCR reactor assembly 11. Inlet end 12 is defined by reactor frame structure 14 which includes ductwork 16 to direct the exhaust flow through SCR reactor assembly 11 to its outlet end 18 (for further downstream flow as through a (non-illustrated) smokestack).

FIG. 1 further shows reduction reagent injection means RRI for carrying out the above referenced reduction reagent introduction (e.g., ammonia, as in liquid or anhydrous, or a urea sourced injection) in the form of injection nozzles such as those found in an ammonia injection grid or “AIG”. A discussion of AIGs can be found in U.S. Pat. No. 11,635,010 to the present Application's common Applicant, Umicore AG (inventor Sharp et al.), which U.S. Pat. No. 11,635,010 is incorporated herein, in its entirety, by reference (in a non-license conveyance manner).

FIG. 1 shows, via a partial cutout view, the mixed reduction reagent and exhaust gas flow FL being passed to an upstream mix homogenizer or distribution layer 20 (shown as a metal grid structure placed in line with the noted mix flow upstream of the conventional SCR reactor layers C-SCr1, C-SCr2, and C-SCr3 layers).

With reference to the break-away views featured in FIG. 1 there can is shown the assembly of three SCR reactor layers C-SCr1, C-SCr3 and C-SCr3, with each of C-SCr1 and C-SCr2 being shown in assembled form (with all modules 22 in place), while C-SCr3 shows the support structure grid SG3 on which modules 22 at that level are yet to be installed. Each of C-SCr1 to C-SCr3 features a support grid (e.g., a lattice structure of I-beam and/or C-beams, etc.) like SG3 shown in the third layer C-SCr3 but are covered over in each of C-SCr1 and C-SCr2 by the installed modules.

FIG. 1 also shows, by way of its broken away expanded view, one of the modules 22 which preferably each have a commonality in structure as well as preferably a commonality of SCR catalyst material (although alternate embodiments can feature different module designs as in layer to layer (e.g., less vertical stacking of the below described module elements 24) and/or different SCR catalyst material utilized such as different SCR catalyst material between the different C-SCr1, C-SCr2, C-SCr3 . . . layering). In the FIG. 1 example there can be seen that each C-SCr layer has a plurality of modules 22 supported by a respective underlying support structure grid SG (only SG3 shown). The number of modules 22 is driven by the nature of the SCR reactor assembly as in the size of the reactor assembly 11 which in turn is generally driven by the nature of the combustion source 5, etc. The FIG. 1 embodiment shows an example with 18 modules supported at each layer (3×6 module array with only some shown in the cutaway view of the ductwork 16). Further, the illustrated reactor assembly 11 may be one of a plurality being fed by a manifold type intake relative to the combustion gas flow (e.g., a coal fired plant often has a larger number of modules as featured in FIG. 1 which can be accommodated by way of either a larger ductwork assembly (larger area occupied by each support structure grid SG) and/or a large number of respective support assemblies arranged in parallel, for instance).

Each module 22 shown in FIG. 1 has a plurality of module elements 24. A representative one of the multiple modules for placement in the three layers C-SCr1, C-SCr2, and C-SCr3 can be seen in the expanded view in FIG. 1 of module 22A (sourced from C-SCr2 as but an example of one of the many modules featured). Module 22A is shown as having an upper (or top “T”) level set of module elements (24AT, 24BT, 24CT, 24DT, 24ET, 24FT, 24GT and 24HT) as well as an equal numbered lower (or bottom “B”) set of module elements 24 represented by (24BB, 24DB, 24FB, 24GB and 24HB—with equivalent bottom modules for locations A, C and E being not visible in FIG. 1 due to the overlying module element) for a total of 16 module elements for each module 22. Conventional modules also come in a variety of alternate configurations and different module and modular element designs, but FIG. 1 provides an informative example of the conventional approach to module configurations (as well as module element configurations as set out below) and placements in a conventional SCR reactor assembly.

FIG. 1 shows a further level breakdown illustration of a representative module element 24AT of the various module elements 24 in module 22A. That is, a breakaway expanded view of one of the 16 stacked module elements for module 22A. Each module element 24 can come in the form of a module element comprised of an outer casing (e.g., steel) or skin 30 which supports SCR catalyst material internally. For example, as shown in FIG. 1, the module element 24AT is provided with a single or monolithic corrugated SCR catalyst component 25. This monolithic SCR catalyst component is shown in greater detail via the expanded view of the circled top inlet end 251 of module element 24AT. An example of such a module element can be seen in US Pub. 2011/0217221 to Thoegersen, which describes a module element featuring a 466 mm/466 mm×322 mm (or 560 mm height) metal casing within which is the monolithic catalyst component 25.

The breakaway view in FIG. 1 further shows that each module has an underlying frame device 27. Frame device 27 has a peripheral frame support portion 29 in which the lower module element stack is received. Additionally, frame support portion 29 has a crisscross faming region on which the module elements are suspended off the ground. Further corner vertical struts CF extend down at the corners of the peripheral frame support portion as to provide for fork-lift tine FT reception for moving the modules into position.

While the FIG. 1 design illustrated finds use in some environments, it has its limitations. For example, the need for the three separate C-SCr1, C-SCr2 and C-SCr3 layers with suitable void spacing between the C-SCr1-C-SCr2 and C-SCr2-C-SCr3 pairs results in large volume space occupation, a requirement for many expensive components (with associated increased installation and cleaning time), and extended flow and added backpressure summation. Any effort to remove a downstream C-SCr in such systems can lead to a failure to meet desired NOₓ removal levels and/or undesirable levels of ammonia slip (as when increasing the amount of ammonia in an input ammonia/NOₓ level ratio to avoid regions of inadequate ammonia supply with the NOₓ in the exhaust flow only to lead to leakage in the over introduced ammonia).

Additionally, any occupied volume or number of components reduction effort involving a dispensing of a downstream C-SCr3 layer in favor of a system having only C-SCr1 and C-SCr2 layers, requires an increased catalyst material presentiment in the remaining C-SCr1 and/or C-SCr2 to meet a same level of NOₓ reduction. An increased catalyst material requirement can lead to added expense relative to what is often expensive material and can be undesirable from multiple standpoints inclusive of catalyst material less efficient usage due to over coating and/or increased backpressure levels, as increased catalyst coating can lead to greater pore blockage and/or increased leakage of catalyst material downstream.

Also, in conventional systems such as shown in FIG. 1, the concentration of NOₓ and reduction reagent is not evenly distributed (the issue of mal-distribution) in the exhaust gas over a given cross section of the SCR reactor layer or wall (e.g., at the inlet of one of more of C-SCr1, C-SCr2 and C-SCr3). This mal-distribution issue poses a problem since a stoichiometric ratio between the NOₓ and the reducing agent is essential for achieving a good reduction of the NOₓ content of the flue gas and a low slip of the reducing agent from the SCR reactor. If there is an issue of mal-distribution in an exhaust flow and reducing agent mix reaching an SCR reactor layer, there will be pockets of “over NOₓ” relative to the preferred NH₃/NOₓ molar mixture as well as pockets of “over NH₃”, with the former leading to issues in reaching a desired NOₓ removal by the time of passage out of the reactor exhaust outlet 18 and the latter leading to the potential for ammonia slip at the reactor exhaust outlet 18.

In other words, an SCR catalyst is designed to achieve a desired performance based on prescribed inlet conditions. In operation, these parameters will vary both spatially and temporally. The catalyst is designed to account for a specified amount of variation, which is defined in the technical specification under the mal-distribution criteria. These criteria reflect the boundaries of variations in temperature, flow rate, and NH₃/NOₓ molar (or volumetric) ratio, which will deliver adequate SCR system performance.

A determination of high mal-distribution levels for an NH₃ and NOₓ mix leading to an SCR catalyst system is informative as to the potential for increased NOₓ output and/or increased NH₃ slippage through the SCR catalyst (and associated difficulty with keeping within emission level standards).

Typically, an allowable variation in temperature is expressed as a mean temperature and ±tolerance. The allowable variation in flow rate and NH₃/NOₓ molar ratio is also expressed in % standard deviation. The % standard deviation can be calculated as follows: The standard deviation is defined as:

$$\sqrt{\frac{{{\sum }^{N}}_{i = 1} {( {X}_{i} - {X}_{average} )}^{2}}{N - 1}}$$

Where:
Xi=Measured value (flow rate or NH₃/NOₓ ratio at specific point i)
N=Total number of individual data.
X_{average}=average value

Mal-distribution values of at or below 10% RMS (root mean square) at the receiving inlet of the SCR catalyst is illustrative of that which is sought out in the prior art in an effort to reach the emissions standard requirements for many locations.

A variety of attempts to avoid undesired levels of mal-distribution include the aforementioned upstream approaches featuring mixing plates that are positioned in the duct immediately upstream of the ammonia injectors or mounted on the ammonia injectors themselves (e.g., see U.S. Pat. No. 8,017,084) or immediately downstream (e.g., see U.S. Pat. Nos. 7,448,794 and 7,547,134) of those ammonia injectors with a focus of generating a turbulent field relative to the ammonia as soon as it is injected into the ductwork. An additional example of efforts for mal-distribution avoidance can be seen in distribution layer grid 20 shown in FIG. 1. Additional examples of mal-distribution treatment include the positioning of an intermediate mixing body in the void area between C-SCr1 and C-SCr2 such as represented by the interstage heat exchanger described in U.S. Pat. No. 7,776,297 to Chichanowicz.

Despite the mal-distribution prevention efforts described above, there remains the problem in the field of an imbalance of ammonia to NOₓ content in the flue gas inclusive of that exiting the first catalyst layer. This higher ammonia to NOₓ mal-distribution negatively impacts the downstream (e.g., second) layer's catalytic ability to reduce NOₓ and ammonia. This usually, depending on the catalyst charge design, results in the installation of a third catalyst layer and/or increased catalyst loading or a reduced catalyst service life due to, for example, poisoning of charged catalyst and/or blockage of pores, etc. for the original two catalyst layers to meet the NOₓ reduction and ammonia slip emission requirements.

Accordingly, while the above-described efforts to avoid undesirable levels of mal-distribution have had some impact, there remains a need for further improvement in this field; as in improvements in lowering mal-distribution areas as to lessen SCR reactor component numbers or component volume or length needs within the SCR reactor and/or to avoid relatively high catalyst loading, etc., to meet regulatory requirements.

### SUMMARY DISCUSSION

The invention is suitable for use in the reduction of pollutants that arise under combustion of fossil or biomass fuels and is well suited for SCR applications (particularly stationary SCR environments) in which a high NOₓ reduction and low ammonia slip is required following passage through an SCR reactor device such as one having multiple SCR catalyst layers or walls. In general terms, the invention reduces the imbalance of reduction reagent (as in ammonia) to NOₓ exiting an upstream catalyst layer (e.g., the first catalyst layer) to a much lower mal-distribution by assembling a module's frame device as to have, within it, blunt or bluff body mixing plates as to define an intermixer (an interior, integrated mixer device that functions as a mixing means). Thus, for each desired module in an SCR layer(s) of choice there is positioned at the exit end of each said module an integrated intermixer structure such as one with a blunt of bluff body array strategically positioned to receive the exhaust flow prior to its exiting of the module (module's downstream positioned frame structure). Hence, the intermixer is positioned for blunt body plate contact of the exhaust flow exiting the exit end(s) of the module(s) (and thus also the module elements that are supported in the module's frame device and through which the mix flows). There is thus provided a module with integrated intermixer (at its downstream end portion) that is provided in an upstream SCR catalyst layer (as in the first SCR or SCR1 catalyst layer) and is designed toward lowering mal-distribution across the full area of the exhaust flow reaching the next in line SCR catalyst layer (as in a second SCR or SCR2 catalyst layer, which is preferably the last in series SCR catalyst layer under preferred embodiments of the invention).

In this way there is a achieved a higher NOₓ reduction and a lower ammonia slip relative to exhaust exiting the most downstream SCR layer (preferably the noted just one second catalyst layer via the improved mixing) in the SCR layer series for a given SCR reactor assembly. This invention thereby facilitates reaching desired NOₓ reduction levels and slip avoidance and can provide for an avoidance or reduction in the issues described above (e.g., the avoidance of high catalyst loading requirements and/or a reduction in the number of components and/or a reduction in overall ductwork volume (particularly in new plant designs being assembled) as brought about, for instance, by a lesser need for the addition of a third SCR layer due to two SCR layers being suitable for desired reduction and slip avoidance levels).

The present invention thus facilitates satisfying the NOₓ and ammonia slip regulations such as those requiring NOₓ reduction greater than or equal to 95% (e.g., at or above 95% to just below 100% as in 99%) with an ammonia slip less than or equal to 5 ppmvdc and more preferably less than or equal to 2 ppmvdc (parts per million on a volumetric basis, dry gas and corrected to standard conditions).

With the strategically positioned intermixer of the present invention and its ability to lower mal-distribution, the present invention is well suited for use with SCR reactors having any form of SCR catalyst available in the art, inclusive of vanadium-based SCR catalysts, doped ammonia and/or zeolite supported SCR catalysts, etc.

Various aspects of the present invention are numbered below in conjunction with providing a summary of features under the present invention.

Aspect 1. A selective catalytic reduction (SCR) apparatus that is particularly well suited for use in a stationary (e.g., non-auto) SCR catalyst environment, comprising: an SCR module unit or block having one or more SCR module elements and an intermixer, wherein the intermixer includes a peripheral frame structure that supports an array of bluff bodies and on which peripheral frame structure is received the one or more SCR module elements such that a combination of gas flow components passing through the one or more module elements is contacted by the array of bluff bodies before exiting the SCR apparatus.

Aspect 2. The SCR reactor apparatus of noted aspect 1, wherein the SCR module unit comprises a plurality of module elements with each containing SCR catalyst material.

Aspect 3. The SCR reactor apparatus according to either aspect 1 or aspect 2, wherein the bluff bodies are received entirely within the confines of the peripheral frame structure both from a standpoint of confinement relative to a direction of flow of the combination and relative to a cross-sectional plane perpendicular to that direction of flow.

Aspect 4. The SCR reactor apparatus according to any one of the preceding aspects, wherein the peripheral frame structure is at least a three tier structure and the angled bluff bodies are arranged in a bluff body array supported on an intermediate tier as to be suspended within the peripheral frame structure.

Aspect 5. The SCR reactor apparatus according to any one of the preceding numbered aspects wherein the combustion gas includes NOₓ pollutant, and the reduction reagent includes NH₃ with the combination being intermixed by the intermixer.

Aspect 6. The SCR reactor apparatus according to any one of the preceding numbered aspects wherein the bluff body array includes both angled and different oriented bluff bodies.

Aspect 7. The SCR reactor apparatus according to any one of the preceding numbered aspects wherein the bluff body array includes different oriented bluff bodies arranged in different orientation rows.

Aspect 8. The SCR reactor apparatus according to any one of the preceding numbered aspects wherein different oriented bluff bodies includes bluff bodies with the same angle value of incline but in different orientations that are defined by different bluff body rotation directions relative to a plane extending through the intermixer at a center of one or more of the bluff bodies.

Aspect 9. The SCR reactor apparatus according to any one of the preceding numbered aspects wherein all the bluff bodies share a common angle of rotation.

Aspect 10. The SCR reactor apparatus according to any one of the preceding numbered aspects wherein the bluff body angle of rotation is from 30° to 70°, and more preferably from 45° to 60°.

Aspect 11. The SCR reactor apparatus according to any one of the preceding aspects, wherein the intermixer comprises a plurality of star shaped bluff bodies that are arranged in different angle direction orientations in series across the peripheral frame structure of the intermixer.

Aspect 12. The SCR reactor apparatus according to any one of the preceding numbered aspects wherein the intermixer introduces backpressure of less than 0.1 IWC, and more preferably less than 0.06 IWC.

Aspect 13. The SCR reactor apparatus according to any one of the preceding numbered aspects wherein a center of all bluff bodies of the bluff body array are located on a common plane.

Aspect 14. The SCR reactor apparatus according to any one of the preceding numbered aspects wherein the bluff body array includes different oriented bluff bodies arranged in different orientation rows, and the intermixer different orientation rows include some bluff bodies having left side initial flow contact lead edging placed above a plane extending though the bluff bodies and some bluff bodies having right side initial flow contact lead edging placed above said plane as to define a right-left or left-right sequence in the bluff body array.

Aspect 15. The SCR reactor apparatus according to any one of the preceding numbered aspects wherein the bluff bodies have a right/left/right/left (or left/right/left/right) array orientation sequence across the plane extending through the bluff bodies.

Aspect 16. The SCR reactor apparatus according to any one of the preceding numbered aspects wherein the one or more SCR module elements comprise a corrugated support body having a plurality of channels through which the combination flows prior to reaching the intermixer.

Aspect 17. The SCR reactor apparatus according to any one of the preceding numbered aspects wherein the one or more SCR module elements having SCR catalyst material includes a plurality of module elements having an outer (preferably metal) casing within which is positioned SCR catalyst material, and the modules elements are supported on an upper portion of the peripheral frame structure of the intermixer.

Aspect 18. The SCR reactor apparatus according to any one of the preceding numbered aspects wherein there is a double layer of stacked module elements in flow through alignment that are supported on an upper portion of the peripheral frame structure of the intermixer.

Aspect 19. The SCR reactor apparatus according to any one of the preceding numbered aspects wherein the peripheral frame structure of the intermixer includes one or more cleaning gas burst access windows, which one or more windows are on a common plane perpendicular to the flow direction as to provide cleaning gas burst contact access relative to the bluff body array of the intermixer.

Aspect 20. The SCR reactor apparatus according to any one of the preceding numbered aspects wherein the peripheral frame structure has a three-tier configuration with an upper frame portion for supporting module elements of the SCR module unit, an intermediate frame portion for supporting the bluff body array, and a lower frame portion for underlying ductwork framing support contact.

Aspect 21. An SCR reactor assembly, comprising:
ductwork that channels a combination of exhaust gas and reduction reagent within an inlet portion of the ductwork;
a first SCR1 catalyst layer structure that comprises the SCR reactor apparatus according to any one of the preceding numbered aspects and is positioned for flow contact with the channeled combination;
a second SCR2 catalyst layer structure that is positioned within the ductwork as to be positioned downstream from the first SCR1 catalyst layer structure and is positioned for contact with the combination after the combination is subjected to a reduction in RMS value.

Aspect 22. The assembly of aspect 21 wherein the SCR1 layer structure has a total length LL and the upstream to downstream length LM occupied by the peripheral frame structure of the intermixer within the SCR1 layer structure is less than 20% percent of that length LL.

Aspect 23. The SCR reactor assembly of either of aspect 21 or aspect 22 wherein the bluff body array of the SCR1 layer structure includes different oriented bluff bodies arranged in different orientation rows at the interface of the one or more SCR module elements and the intermixer.

Aspect 24. The SCR reactor assembly according to any one of the preceding numbered aspects wherein a different orientation of the bluff bodies includes the same angle value of incline but in different orientations, with the different orientations in the bluff bodies being defined by different rotation directions to a plane extending through the peripheral frame structure of the intermixer at a center of one or more of the bluff bodies.

Aspect 25. The SCR reactor assembly according to any one of the preceding numbered aspects wherein an SCR2 layer structure inlet is positioned downstream of the SCR1 layer structure outlet (a length L_{V}), which is preferably essentially the same length as the distance between the outlet end of the intermixer and the downstream SCR2 layer structure inlet, and a void defined by the ductwork over the length L_{V} is preferably free of any turbulence generator device.

Aspect 26. The SCR reactor assembly according to any one of the preceding numbered aspects further comprising a reduction reagent injector preferably an ammonia or ammonia precursor injector having an injector outlet that feeds into the ductwork upstream of the SCR1 layer structure.

Aspect 27. An SCR reactor system comprising the SCR reactor assembly of according to any one of the preceding numbered aspects and a combustion source that feeds combustion gas to an inlet of the ductwork.

Aspect 28. The SCR reactor system of aspect 26 wherein the combustion source is a coal fired plant.

Aspect 29. A method of operating the reactor system of aspect 27 or aspect 28 comprising feeding combustion gas generated by the combustion gas source to an inlet end of the ductwork for channeling of the combustion gas together with a reduction reagent to the SCR1 layer structure in the ductwork and exhausting a mix of the combustion gas and reduction reagent toward an outlet end of the ductwork.

Aspect 30. A method of assembly the SCR reactor apparatus according to any one of the preceding numbered aspects, comprising providing an intermixer at a downstream end of the module unit with SCR catalyst material.

Aspect 31. A method of assembling the SCR reactor assembly according to any one of the preceding numbered aspects, comprising positioning each of the first SCR1 catalyst layer structure and a second SCR2 catalyst layer structure within the ductwork.

Aspect 32. A mixing device for mixing a reduction reagent and pollutant traveling with an exhaust flow from a combustion source, the mixing device comprising:

a frame structure configured for receiving an SCR module unit and a bluff body array received within the periphery of the frame structure in a position to abut the flow of exhaust gas and reduction reagent mix exiting the module unit.

Aspect 33. The mixing device of according to any one of the preceding numbered aspects wherein the bluff body array includes a plurality of plates that are dimensioned to be encompassed by the frame structure both from a peripheral standpoint and a flow direction standpoint.

Aspect 34. A mixing device for mixing a reduction reagent and pollutant traveling with an exhaust flow from a combustion source, the mixing device comprising:
a bluff body array; and
a frame structure configured to receive a selective catalytic reduction (SCR) module unit, wherein the bluff body array is secured to the frame structure as to be positioned internally within the periphery of the frame structure and such that the flow of exhaust gas and reduction reagent mix exiting the module unit is mixed within the bluff body array.

Aspect 34. The mixing device of Aspect 33 wherein the frame structure is configured to receive a stationary (e.g., non-auto) SCR module unit comprised of a set of SCR module elements.

### BRIEF DESCRIPTION OF THE DRAWINGS

FIG. 1 shows a conventional SCR reactor system with combustion gas source and SCR reactor assembly, with enlarged breakouts of components of the SCR reactor layers in the system.

FIG. 2 shows an SCR reactor system in accord with the present invention which includes an integrated intermixer in the SCR1 layer.

FIG. 2A shows an enlarged view of a region in FIG. 2 extending downstream of the distribution device and to the end of the SCR2 layer and thus showing an upstream module (or SCR reactor apparatus) with its intermixer in the SCR1 layer as well as a flow aligned, downstream module in the downstream SCR2.

FIG. 3 shows a graph comparing ammonia slip levels and deNOₓ performance at various mal-distribution levels for NH₃/NOₓ in an exhaust stream (i.e., a graph showing the effect of NH₃/NOₓ mal-distributions on SCR performance).

FIG. 4 shows a view similar to the reactor view of FIG. 2A but with the SCR2 layer removed and the SCR1 layer region expanded for a better view of a different intermixer design featured in the SCR1 layer.

FIG. 5 shows a top plan view of the intermixer of FIG. 4.

FIG. 6 shows a perspective view of the IM (IMA) shown in FIG. 4 with “transparent” depictions of the intermixer support frame and a schematic presentation of the bluff body arrangement in the bluff body array for that intermixer.

FIG. 7 shows a plan view like that of FIG. 5 but with the support components for the bluff bodies removed for easier viewing of the array arrangement.

FIG. 8A shows a frame long side elevational view depiction of the array of FIG. 7, again involving a “transparent” presentation of the closest long side wall of the frame structure of the intermixer.

FIG. 8B presents a frame short side elevational view of the array with similar transparent frame presentation as in FIG. 8A.

FIG. 8C shows a view like FIG. 8A but at the A-A cross-section line of FIG. 8B.

FIG. 8D shows a view like FIG. 8A but at the B-B cross-section line of FIG. 8B.

FIG. 9 provides a closer view of the bluff body featured in FIG. 7.

FIG. 10 shows a side elevational view of what is shown in perspective in FIG. 4.

FIG. 11 shows a front elevational viewing of that which is shown in FIG. 4.

FIG. 12 shows a similar view to that of FIG. 5 but with a modified bluff body array assembly.

FIG. 12A shows a cross-sectional view taken along cross-section C-C in FIG. 12.

FIG. 12B shows an example of an array adjustment unit for the array of FIG. 12.

FIG. 13 shows the reactor structure as featured in FIG. 2A but with added emphasis on the structure grid support portion supporting each module or SCR reactor apparatus.

FIG. 14 shows a cut-away view of that which is shown in FIG. 13 with added focus on the intermixer array.

FIG. 15 shows a view of that which is shown in FIG. 14 along the IM frame long side (again with frame transparency).

FIG. 16 shows a schematic plan view of the array of FIG. 14.

FIG. 17 shows a short side end view of the array of FIG. 14.

FIG. 18 shows a CFD flow simulation of the velocity magnitude for a flow travelling through the intermixer of FIG. 14.

FIG. 19 shows the velocity magnitude CFD flow simulation of FIG. 18 from the SCR1 catalyst module unit or block outlet to the SCR2 catalyst module unit or block inlet.

FIGS. 20A(1); 20A(2); 20B(1); 20B(2); 20C(1); 20C(2); 20D(1); 20D(2); 20E(1); 20E(2); and 20F(1); 20F(2) show respective CFD flow simulation sets based on various normalized NH₃ concentration profiles assumed leaving the outlet of the SCR1 module block of FIG. 13 (“1”-set) as well as the simulated normalized NH₃ concentration flow patterns for that flow upon reaching the SCR2 inlet (“2”-set).

FIG. 21 shows a perspective view of an SCR reactor structure like that of FIGS. 2A and 13, but with a different intermixer array present.

FIG. 22 shows a cut-away view of that which is shown in FIG. 21 with a focus on the intermixer array.

FIG. 23 shows a view of that which is shown in FIG. 21 along the intermixer frame long side (again with frame transparency).

FIG. 24 shows a schematic plan view of the array of FIG. 21.

FIG. 25 shows a short side end view of the array of FIG. 21.

FIG. 26 shows a CFD flow simulation of the velocity magnitude for a flow travelling through the intermixer of FIG. 21.

FIG. 27 shows the velocity magnitude CFD flow simulation of FIG. 26 from the SCR1 catalyst module block outlet to the SCR2 catalyst module block inlet.

FIGS. 28A(1); 28A(2); 28B(1); 28B(2); 28C(1); 28C(2); 28D(1); 28D(2); 28E(1); 28E(2); and 28F(1); 28F(2) show a similar set of views like that in the FIG. 20 set but for the SCR reactor structure in FIG. 21.

FIG. 29 shows a perspective view of an SCR reactor structure like FIGS. 2A and 13, but with a different intermixer array present.

FIG. 30 shows a cut-away view of that which is shown in FIG. 29 with a focus on the intermixer array.

FIG. 31 shows a view of that which is shown in FIG. 29 along the intermixer frame long side.

FIG. 32 shows a schematic plan view of the array of FIG. 29.

FIG. 33 shows a short side end view of the array of FIG. 29.

FIG. 34 shows a CFD flow simulation of the velocity magnitude for a flow travelling through the intermixer of the SCR reactor structure in FIG. 29.

FIG. 35 shows the velocity magnitude CFD flow simulation of FIG. 34 from the SCR1 catalyst module block outlet to the SCR2 catalyst module block inlet.

FIGS. 36A(1); 36A(2); 36B(1); 36B(2); 36C(1); 36C(2); 36D(1); 36D(2); 36E(1); 36E(2); and 36F(1); 36F(2) show a similar set of views like that in the FIG. 20 set but for the SCR reactor structure in FIG. 29.

FIG. 37 shows a perspective view of an SCR reactor structure like FIGS. 2A and 13, but with a different intermixer array present.

FIG. 38 shows a cut-away view of that which is shown in FIG. 37 with a focus on the intermixer array.

FIG. 39 shows a view of that which is shown in FIG. 37 along the intermixer frame long side (again with frame transparency).

FIG. 40 shows a schematic plan view of the array of FIG. 37.

FIG. 41 shows a short side end view of the array of FIG. 37.

FIG. 42 shows a CFD flow simulation of the velocity magnitude for a flow travelling through the intermixer of the reactor in FIG. 37.

FIG. 43 shows the velocity magnitude CFD flow simulation of FIG. 42 from the SCR1 catalyst module block outlet to the SCR2 catalyst module block inlet.

FIGS. 44A(1); 44A(2); 44B(1); 44B(2); 44C(1); 44C(2); 44D(1); 44D(2); 44E(1); 44E(2); and 44F(1); 44F(2) show a similar set of views like that in the FIG. 20 set but for the SCR reactor structure in FIG. 37.

FIG. 45 shows a perspective view of an SCR reactor structure like FIGS. 2A and 13, but with a different intermixer array present.

FIG. 46 shows a cut-away view of that which is shown in FIG. 45 with a focus on the intermixer array.

FIG. 47 shows a view of that which is shown in FIG. 45 along the intermixer frame long side (again with frame transparency).

FIG. 48 shows a schematic plan view of the array of FIG. 45.

FIG. 49 shows a short side end view of the array of FIG. 45.

FIG. 50 shows a CFD flow simulation of the velocity magnitude for a flow travelling through the intermixer of the SCR reactor structure in FIG. 45.

FIG. 51 shows the velocity magnitude CFD flow simulation of FIG. 50 from the SCR1 catalyst module block outlet to the SCR2 catalyst module block inlet.

FIGS. 52A(1); 52A(2); 52B(1); 52B(2); 52C(1); 52C(2); 52D(1); 52D(2); 52E(1); 52E(2); and 52F(1); 52F(2) show a similar set of views like that in the FIG. 20 set but for the SCR reactor structure in FIG. 45.

FIG. 53 shows a perspective view of an SCR reactor structure like FIGS. 2A and 13, but with a different intermixer.

FIG. 54 shows a cut-away view of that which is shown in FIG. 53 with a focus on the intermixer.

FIG. 55 shows a view of that which is shown in FIG. 53 along the intermixer frame long side.

FIG. 56 shows a schematic plan view of the array of FIG. 53.

FIG. 57 shows a short side end view of the array of FIG. 53.

FIG. 58 shows a CFD flow simulation of the velocity magnitude for a flow travelling through the intermixer of the SCR reactor structure in FIG. 53.

FIG. 59 shows the velocity magnitude CFD flow simulation of FIG. 58 from the SCR1 catalyst module block outlet to the SCR2 catalyst module block inlet.

FIGS. 60A(1); 60A(2); 60B(1); 60B(2); 60C(1); 60C(2); 60D(1); 60D(2); 60E(1); 60E(2); and 60F(1); 60F(2) show a similar set of views like that in the FIG. 20 set but for the SCR reactor structure in FIG. 53.

FIG. 61 shows a perspective view of an SCR reactor structure like FIGS. 2A and 13, but with a different intermixer.

FIG. 62 shows a cut-away view of that which is shown in FIG. 61 with a focus on the intermixer.

FIG. 63 shows a view of that which is shown in FIG. 61 along the intermixer frame long side.

FIG. 64 shows a schematic plan view of the array of FIG. 61.

FIG. 65 shows a short side end view of the array of FIG. 61.

FIG. 66 shows a CFD flow simulation of the velocity magnitude for a flow travelling through the intermixer of the SCR reactor structure in FIG. 61.

FIG. 67 shows the velocity magnitude CFD flow simulation of FIG. 66 from the SCR1 catalyst module block outlet to the SCR2 catalyst module block inlet.

FIGS. 68A(1); 68A(2); 68B(1); 68B(2); 68C(1); 68C(2); 68D(1); 68D(2); 68E(1); 68E(2); and 68F(1); 68F(2) show a similar set of views like that in the FIG. 20 set but for the SCR reactor structure in FIG. 61.

FIG. 69 shows a perspective view of an intermixer featuring a modified array grid and attachment means.

FIG. 70 shows a front view of that which is shown in FIG. 69.

FIG. 71 shows a more detailed view of referenced detail A in FIG. 70.

FIG. 72 shows a bottom view of that which is shown in FIG. 69.

FIG. 73 shows a left-side view of that which is shown in FIG. 69.

FIG. 74 shows a right-side view of that which is shown in FIG. 69.

FIG. 75 shows a more detailed view of referenced detail B in FIG. 74

FIG. 76A shows a cut-away front view of the retaining plate of FIG. 69.

FIG. 76B shows an end view of the retaining plate of FIG. 76A.

FIG. 77A shows a cut-away, closer view of the T-shaped lifting lug in an “up” ready for engagement state.

FIG. 77B shows a cut-away closer view of the T-shaped lifting lug of FIG. 77A in a “down” disengagement state.

FIG. 78 shows a top end view of the capturing C-bracket of FIG. 77A.

FIG. 79 shows a perspective view of another intermixer featuring a modified array of bluff bodies.

FIG. 80 shows the intermixer of FIG. 79 in position relative to a SCR module block with stacked module elements.

FIG. 81 a short end right side view of that which is shown in FIG. 79.

### DESCRIPTION OF INVENTION

Described below are examples of various embodiments of the inventive subject matter featuring an arrangement that is directed at reducing the imbalance of reduction reagent (e.g., ammonia) to NOₓ (NH₃/NOₓ “ratio”) exiting an upstream SCR (e.g., SCR1) layer. Under an aspect of the present invention, reducing this imbalance to a much lower mal-distribution across the duct flow passageway area is achieved by assembling an upstream (e.g., SCR1) layer as to have one or more modules each with an integrated mixer or “intermixer”. The inclusion of the intermixer within, for example, the SCR1 layer of the one or more SCR1 modules with associated intermixer (SCR1-IM) at the module's exit provides an increased level of turbulence at a location not appreciated in the prior art. The SCR-IM (SCR1-IM used as an example) is designed to reduce mal-distribution levels, preferably across a full cross-section of the flow exiting the SCR1 layer (e.g., via multiple modules with respective intermixers preferably occupying the entire SCR1 layer) or, by design, in one or more regions of that full cross-section that are deemed in need of modules with enhanced mixing means such that the exhaust flow reaching the SCR2 is properly mixed to achieve an improved overall NOₓ reduction and/or lessening in catalyst load and/or lessening of void length between the SCR1 and SCR2. In so doing, the SCR1-IM features modules with blunt body mixing means as in blunt or bluff body plates at the exit of the modules and thus at the exits of the first SCR catalyst layer thereby ensuring a higher NOₓ reduction and a lower ammonia slip in the exhaust ultimately exiting through the downstream second catalyst layer (SCR2).

The inventive subject matter is thereby directed at, for example, enhancements over the prior art as in reducing a need for high loads of catalyst material on the first and/or second layers and/or the need for a third layer of catalyst to meet certain NOₓ reduction levels. The inventive subject matter is designed to be well suited for facilitating the meeting of NOₓ reduction levels such as those featured in regulatory provisions (e.g., NOₓ reduction of ≥95% as in 99% with an ammonia slip less than or equal to 5 ppmvdc as in less than or equal to 2 ppmvdc) directed at pollution control such as regulations imposed on combustion fuel operating systems such as coal fired plants or other combustion exhaust gas sources. The advanced mixing via the strategically positioned intermixer has particular utility in plants that generate exhaust particulate (e.g., coal fired plants), as the intermixer works well in presenting a suitable flow mix to the downstream SCR layer despite the lower flow rate in the particulate laden exhaust (a lower flow rate designed to avoid too rapid catalyst degradation due to the particulate contact).

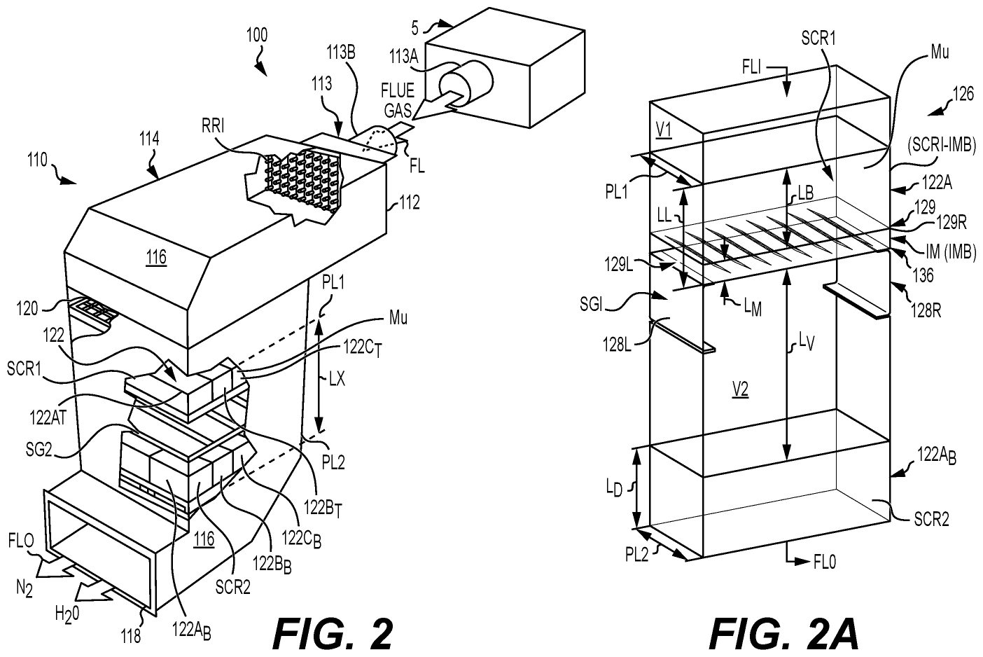

FIG. 2 shows an example of the present invention that features an SCR reactor system 100 comprised of (i) a combustion gas source 5 that generates NOₓ and (ii) an SCR reactor assembly 110. Examples of combustion gas sources that are considered for feeding to the SCR reactor assembly of the present invention include thermal power plants, gas turbines, coal-fired power plants, fluid catalytic cracking (FCC) plants and plant and refinery heaters and boilers in the chemical processing industry, furnaces, coke ovens, as well as municipal waste plants and incinerators, etc. The list of fuels used in these applications includes, for instance, one or more or any combination of the following, natural gas, crude oil, light or heavy oil, pulverized coal, biomass (e.g., wood, crops, manure, fats and oils, sewage, garbage), etc.

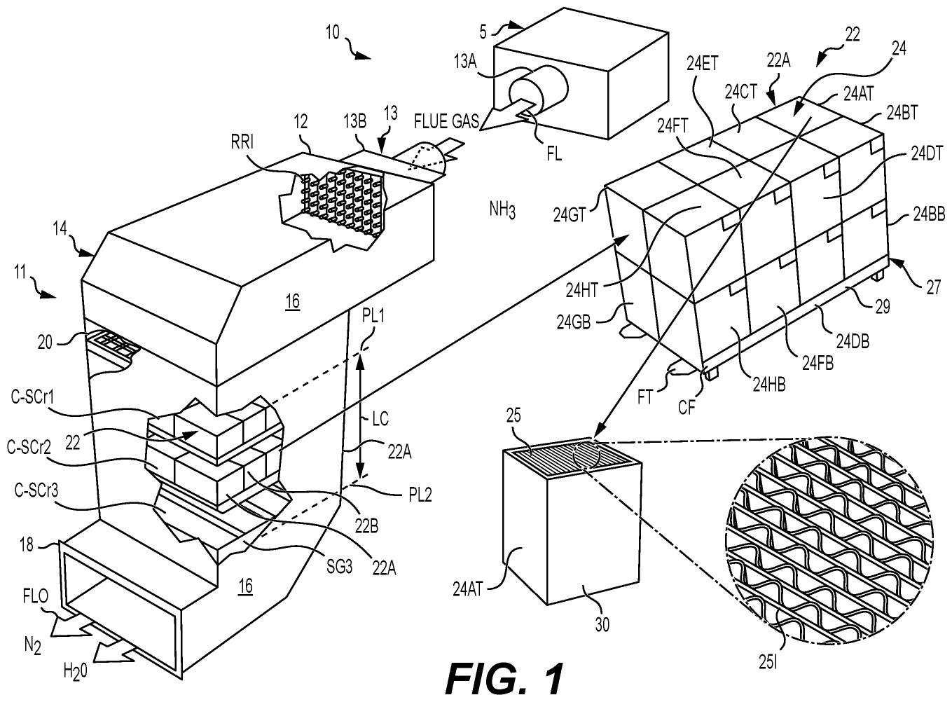

Thus, the SCR reactor system 100 of FIG. 2 shares some similarities with the conventional SCR reactor system 10 shown in FIG. 1 but has some significant differences which are detailed below.

As shown in FIG. 2, SCR reactor assembly 110 has its inlet end 112 in exhaust flow communication with the downstream end or reactor connection end 113B of piping 113. The opposite upstream end of piping 113 features exhaust source connection end 113A that receives the exhaust gas outputted by combustion gas source 5 (e.g., one of the aforementioned sources such as a coal fired plant). Exhaust gas flow FL is shown flowing away from combustion gas source 5 (e.g., a coal-fired plant which can output high levels of NOₓ and other pollutants) toward inlet 112 of SCR reactor assembly 110. Inlet 112 is defined by reactor frame structure 114 which includes ductwork 116 to direct the exhaust flow through assembly 110 to its outlet end 118 (for further downstream flow as through a (non-illustrated) smokestack).

FIG. 2 shows means RRI for carrying out the above referenced reduction reagent introduction (e.g., ammonia, as in liquid or anhydrous ammonia, or urea injection) in the form of injection nozzles such as those found in an ammonia injection grid or “AIG”.

FIG. 2 shows the mixed reduction reagent and exhaust gas flow FL being passed to an upstream distribution layer 120 (shown as a metal grid structure placed in line with the noted mix flow upstream of the SCR reactor layers SCR1 and SCR2). With the introduction of the intermixer IM of the present invention such upstream distribution layer 120 or other upstream turbulence generator means can be dispensed with in some environments or can be featured as a supplemental component for facilitating intermixing with the intermixer IM positioned at the downstream end of the SCR1 layer.

FIG. 2 shows only two SCR layers: SCR1 layer and SCR2 layer as this is all that is needed under aspects of the present invention. This is based on the inclusion of the intermixer IM which in preferred embodiments is designed to avoid the presence of a third C-SCr3 layer as featured in the conventional embodiment of FIG. 1. The avoidance of a third SCR layer can include, for example, the removal of a conventional C-SCr2 layer in a preexisting plant being refurbished (due to a fixed volume situation of such a preexisting SCR reactor) and the placement of the present invention's SCR1-IM and an SCR2 at the former C-SCr3 location (or the removal of an C-SCr3 and the placement of SCR1-IM and SCR2 as the locations of C-SCr1 and C-SCr2). In newly produced plants the SCR reactor assembly 110 can be designed with ductwork factoring in the improvement of the SCR1-IM and the potential decrease in the number of SCR layers (and associated volume need reduction) required to achieve the desired goals.

Also, FIG. 2 shows each of the layers SCR1 and SCR2 are composed of modules 122 which can be similar in design to modules 22 in FIG. 1 (but for the below described intermixer feature of modules 122). Modules 122 (or SCR1-IM) also feature respective module units Mu (or the SCR1 portion of SCR1-IM) which preferably are comprised of a set of module elements 124 as in module elements 24 featured in FIG. 1, although alternate embodiments of the present invention feature alternate module element designs different than module elements 24. The SCR material that is supported at the SCR1 layer and SCR2 layer can be any suitable catalyst material and the characteristics of that catalyst material from SCR1 layer to SCR2 layer can be the same or different such as different in loading, material make up (different metals (e.g., Cu and Fe in Zeolite supports, PGM or non-presence thereof, etc.); different catalyst composition supports as in honeycomb monoliths or coated corrugated strips, etc.; different catalyst particle substrates as in zeolites or zeolite types, alumina, titania or other support particles, different coating loads, zones and/or layering, inclusive of other types of materials in addition to the SCR catalyst material as in NOₓ absorbers or oxygen absorbers (e.g., ceria), etc.).

According to an exemplary embodiment the SCR1 and SCR2 layers each comprise (typically via their respective catalyst material supporting module elements in the one or more modules 122) base metal catalysts, typically utilizing a titanium dioxide carrier impregnated with the active components (e.g., oxides of tungsten and vanadium), and/or any suitable other NOₓ reduction catalyst. The SCR material should be suited for handling the anticipated exhaust flow temperature reaching it (e.g., 300° F. to 1100° F. or roughly 150 to 600° C. for many combustions sources 5) to provide for a suitable life cycle.

Embodiments under the invention are inclusive of having the SCR1 and SCR2 layers being the same but for the inclusion of the intermixer IM in the upstream most SCR1 layer as to define the illustrated SCR1-IM modules of the SCR reactor structure (as in otherwise entirely the same in configuration, SCR catalyst material, SCR substrate, etc.) such that a universal approach can be taken when assembling the walls represented by layers SCR1 and SCR2. Alternate embodiments, however, are inclusive of having SCR1 and SCR2 not exactly the same (in addition to the IM presence differential preferred), although potentially having one or more of the remaining attributes in common, as in having a different catalyst material on SCR1 as compared to SCR2, but a common configuration. For instance, in view of the downstream positioning of the SCR2 layer (and hence typically cooler) the SCR2 catalyst material can include materials that are different than that of SCR1. For instance, the SCR2 at a cooler location may include PGM material that is not present in SCR1 or a higher PGM load as compared to the upstream SCR1, as in Pd or more Pd in SCR2 as compared to SCR1 as to reduce the potential for PGM (e.g., Pd) volatility. “PGM” material in the context of the present invention is considered to include platinum, palladium, rhodium, iridium, osmium, and ruthenium, with the subgroup of platinum, palladium and rhodium being preferred as the PGM when featured in the present invention.

Examples of suitable module elements 124 for inclusion in the one or modules in the SCR reactor layers include Umicore AG's “DNX” series catalysts. Umicore's SCR DeNOₓ DNX® catalysts are based on a corrugated fiber-reinforced titanium dioxide (TiO₂) carrier plate. The plates are homogeneously impregnated with the active components, in that the entire ceramic plate is composed of a uniform distribution of tungsten trioxide (WO₃) and vanadium pentoxide (V₂O₅). Within this series is included the DNX-HD™ catalyst which is particularly suitable for operation in a high-dust environment and is thus well suited for use in SCR installations on coal-fired boilers burning coal with high dust content (e.g., the cell density (CPSI) is selected to accommodate the dust content in the flue gas).

The “DNX” series of Umicore AG catalyst is further inclusive of the “single” or “non-dual” type SCRs, with an example of a suitable constitution for the “single” version being U.S. Pat. No. 7,431,904 B2 to Høj. Additionally suited in some environments of the present invention, either in combination with a DNX® catalyst or alone relative to SCR1 and/or SCR2, are dual function “DNO” type catalyst also available from Umicore AG and being represented by WO 2014/124830 A1 to Castellino et al. and WO 2017/220473 A1 to Pedersen et al. As seen therein, the “DNO” catalyst can also include a corrugated fiber-reinforced titanium dioxide (TiO₂) carrier plate with the plates homogeneously impregnated with the active components such that the entire ceramic plate is composed of a uniform distribution of tungsten trioxide (WO₃) and vanadium pentoxide (V₂O₅), plus (in conjunction with providing a dual function attribute) a zone (e.g., a downstream zone under illustrative embodiments of the present invention) that features the addition of an impregnated precious metal solution (as in impregnation with a PGM such as a palladium solution with an example described in WO 2017/220473 A1).

Umicore's DNX® catalyst are supplied in one version of modular element configurations with aluminized carbon-steel casings (illustrative of the above noted “metal containment structure” or “skin” 30 in FIG. 1) with the above described monolithic SCR catalyst structure protected therein (e.g., the corrugated catalyst structure such as shown in the final breakout in FIG. 1 for the module element 24 (or in module element 124 in FIG. 2). Per some design requirements, each module element 124 comes as a square cross-section of 466 mm×466 mm (18.4 inches×18.4 inches). Thus, with a module unit Mu comprised of, for instance, the described 2×4 module element set on the bottom within the confines of the frame structure of the IM (frame and bluff body plate array combination) and the same 2×4 module element set stacked on top and in flow alignment the four adjacent module elements of the lower 2×4 module element set, occupy a length of (4×466 mm or 1864 mm) such that a preferred long length frame side of the frame device of the IM of the present invention extends for a length of about 2000 mm as to confine the 4 adjacent module elements in a desired position in the SCR layer. With the same 466 mm length for each module in the 2 adjacent module elements (or 2×466 mm equals 932 mm) the short side length of the frame device of the IM has about a 1000 mm length as to provide for the confinement in the other direction of the 16 module element “block” set. The foregoing is only presented as to be illustrative of the nature of potential module and module elements thereof relationships as alternate embodiments are featured under the present invention as having or less of the module elements within a module “block” as well as different natured module elements as in honeycomb module element types, etc.

Per the discussion above, while the noted Umicore's DNX® catalysts (with ceramic plate with a uniform distribution of tungsten trioxide (WO₃) and vanadium pentoxide (V₂O₅)) is illustrative of an SCR material and configuration well suited for module elements under embodiments of the present invention, various other types of SCR materials and configurations are also contemplated under the present invention. For instance, where the environment is suitable, alternate SCR material, as in micro-porous material (e.g., zeolites) alone, or as supports for added catalytic material (e.g., iron and/or copper or PGM zoning are illustrative), are featured.

FIGS. 2 and 2A also show that there can be provided multiple modules 122 (with each module comprised of its respective IM and module element “block” or module unit Mu) stacked side by side (preferably abutting) on underlying support grids (e.g., SG1) to occupy the desired cross-section area within ductwork 116. While the present invention includes the notion of a single module confined within ductwork when such an SCR reactor dictates (a very small unit example), typical examples of SCR reactors for use with combustion sources 5 such as those describe above feature multiple modules on each SCR layer involved. For instance, while partially enclosed due to the cut-out depiction in FIG. 2, each SCR layer occupied by modules 122 has a set of 5 (along the longer side of the rectangular reactor frame structure 114 (which includes ductwork 116 and support structure grids such as SG2) and a set of 3 modules along the shorter side of the reactor frame structure 114. Thus, there is shown a set of 15 modules on each SCR layer each preferably with an associated IM (i.e., a set of 15 SCR1-IMs for example). Such a set up would be retained within the confines of the ductwork 116 which would have a common configuration as in one represented by a rectangle of about 3×2000 mm (6000 mm) and about 5×1000 mm (5000 mm). Some combustion gas sources inclusive of coal fired plants can involve even larger sizes or a plurality of parallel running SCR reactor assemblies such as 110 in FIG. 2 (e.g., two times the above 6000×5000 mm size or even larger sizes such as 8×2000 mm [16000 mm] by 15×1000 mm [15000 mm] for even larger sized (almost square cross-sectioned) ducting of SCR reactors designed to handle a combustion source such as that of a coal fired plant).

SCR reactor assembly 110 in FIG. 2 illustrates an example of the present invention and is shown as having one less SCR layer than shown in the prior art FIG. 1 reactor assembly. In the illustrated case there can be seen only the structural (lattice) support grid SG2 at the conventional C-SCr2 location forming part of reactor frame structure 114 (with the SCR1 and SCR3 layer counterpart lattice grid supports (SG1 and SG3) being shown covered over the by the respective modules 122). This reduction from three SCR layers down to two for some environments is considered attributable to the SCR1-IM advantages provided under the present invention. While only a SCR1-IM and SCR2 (the SCR2 shown in the conventional C-SCr3 location) are shown in FIG. 2, alternate versions of the present invention can have more SCR layers as in having SCR3 SCR4 . . . , etc. For instance, for extremely high NOₓ production, as may be found in some chemical process plants, an additional SCR layer may prove helpful. The advantage of the present invention, however, lies in a better maintenance of a desirable NH₃/NOₓ ratio across the full exhaust flow cross-section at the time of initial contact with SCR2. The improved NH₃/NOₓ ratio provides for the benefits such as the noted avoidance of what under the prior art may require additional SCR layers (e.g., no need for an SCR3, SCR4 or SCR5 as might other have been required under a conventional approach due to the benefits associated with the one or more intermixers placed within one or more SCR layers (at least the first in a series of SCR layers is preferably provided with an IM or multiple SCR layers in the series are provided with an IM feature with preferably the last one in the series being free of an IM). Moreover, it can be seen that even relative to what may be deemed a moderately sized SCR reactor assembly, the ability to remove, for example, a full 15 module set by avoiding having to use a third SCR layer (C-SCr2 location left empty via SCR1-IM and SCR2 improved combination) results in the avoidance of having to use (purchase, install, clean, etc.) 15 modules (and some 240 associated module elements) for the particular embodiment shown.

The lessening of the number of C-SCr layers under conventional attempts can be done in some instances by heavier SCR catalyst loads on one or more of the C-SCr layers. For instance, there can be attempted placing the first and/or second C-SCr layers under a heavier C-SCr catalytic load to lessen the number of C-SCr layers from 3 to 2 layers. Such additional loading approaches, however, can lead to other undesired issues as in higher levels of system back pressure, not to mention the added cost for increased overall catalyst material load levels. The improved SCR-IM feature of the present invention is considered to provide the benefits associated with a lessening of the number of SCR layers while still being able to meet specific regulatory NOₓ reduction and slip avoidance levels, as well as the associated reduction of SCR layering benefits of less equipment and plant volume occupation, enhanced back pressure levels. Alternatively, or in addition thereto, the SCR-IM configuration of the present invention can also provide for reduced catalyst loading requirements for a common number of SCR layers as used in a conventional set up (e.g., three SCR1, SCR2 and SCR3 layers as in a conventional C-SCr1, C-SCr2 and C-SCr3 set up but with at least one of the SCR1-3 layers having less catalyst material loading than an equivalent C-SCr layer).

For newly designed SCR plant assemblies, the ability to avoid a third (or extra(s), in general) SCR layer (while still meeting the same regulatory standards) enables an SCR reactor assembly volume reduction as seen by the lessening of length represented by Lc (FIG. 1) so that Lx is less than Lc with each length represented by the length in exhaust gas flow direction between an initial SCR1 exhaust contact cross-sectional plane PL1 and the last SCR layer's exhaust gas exit cross-sectional plane PL2. Examples of reduction potential values include the removal of a distance represented, for instance, by L_{V} plus L_{D} (an SCR layer block and associated void removal) as in 2750 to 3250 mm reduction in overall length.

FIG. 2 also shows distribution grid 120, which is an example of an upstream flow turbulence generator positioned upstream of plane PL1, which can be utilized as a supplemental gas combination mixing means or, in suited environments, not utilized as when the SCR-IM provides sufficient intermixing on its own. Examples of potentially optional upstream mixing means include those in close vicinity to the ammonia injectors, and/or in stream insertions such as distribution grid 120. With the SCR-IM turbulence generator capabilities and strategic positioning relative to the SCR flows, the presence of an upstream turbulence generator such as an AIG turbulence generators and/or flow distribution grids can be retained as to sum the benefits associated therewith in combination with the SCR1-IM benefits under the invention, although for certain environments, the removal of one or both of such upstream flow facilitators (upstream of PL1 and inside the ductwork) is envisioned.

FIG. 2A shows a breakaway view of a portion of SCR reactor assembly 110 (referenced as SCR reactor structure 126) which is shown in somewhat schematic view. The expanded portion of reactor assembly 110 is shown from a void (V1) location upstream of plane PL1 (shown downstream from the optional distribution grid 120) to plane PL2. Further, SCR1 of SCR1-IM and SCR2 are shown as schematic blocks in SCR reactor 126 to illustrate that the inter mixer IM is suitable for working in conjunction with a variety of SCR types; both from a standpoint of catalyst material types and SCR structural types featured under the present invention. For example, while in FIG. 2 there is included a plurality of modules 122A_{T}, 122B_{T}, 122C_{T} . . . for the SCR1 layer and 122A_{B}, 122B_{B}, 122C_{B}) for the SCR2 layer, embodiments of the invention also include a single module occupying the entire cross-sectional area of the ductwork associated with a much smaller output source. FIG. 2A shows an expanded view of one of the sets of flow aligned upper and lower modules drawn from the multiple embodiments shown in FIG. 2 (with module “A” of that group being featured in FIG. 2A as represented by 122A_{T} for SCR1 and 122A_{B} for the SCR2 layer downstream. The modules 122A_{T} and 122A_{B} have their blocks shown in schematic fashion in recognition of the varied modular elements that may be featured in such modules (as in the aforementioned 2×4 double vertically stacked set with the modules elements being, for instance, DNX® catalyst module elements available from UMICORE AG (the present Applicant)). FIG. 2A also shows how the SCR1 layer is different than the SCR2 layer in that the SCR1 layer has the intermixer of the present invention (SCR1-IM) while in this embodiment the SCR2 layer does not (although it can have a frame device as in 27 in FIG. 1). In preferred embodiments both the module Mu nature and module element nature for each of the SCR1-IM and SCR2 layers are the same but for the inclusion of the IM in the associated upstream SCR layer or layers.

Further, each of the modules present in SCR1-IM and SCR2 are supported on a respective support structure grid SG1 and SG3 (with SG2 shown unfilled in view of the noted ability to remove an SCR layer and with preexisting combustion plants the preferred approach is to put the SCR-IM and SCR2 on the preexistent C-SCr1 and C-SCr3 layers). FIG. 2A also shows SCR2 as being free of its own intermixer (although in alternate embodiments particularly those that feature more than two SCR layers, for instance, the SCR2 layer can have a similar SCR2-IM combination representing the SCR2 layer that can feed to a third SCR3 layer if present). As FIG. 2A only shows one of the multiple modules 122 featured for each SCR layer there can be seen only segments of beams 128L and 128R forming components of the support grid lattice SG1 (a pair of facing “C-beams” in this embodiment). The support structure grid beams utilized can be welded or otherwise fixed to interior support regions of the reactor frame structure 114 to provide a beam grid support platform for the module placement.

SCR reactor structure 126 in FIG. 2A features void V1 of ductwork 114 (a partial length view of the full void with or without the aforementioned upstream turbulence generators) that receives exhaust gas flow FLI from the combustion gas source 5 which comes in contact with SCR1 at upstream plain PL1. Also, the upstream portion of frame device 129 of the IM is shown positioned at the exit end of the module unit Mu of module 122A with the downstream portion of IM frame device 129 resting on the underlying support grid structure SG1 running thereunder. IM frame device 129 features the confining peripheral frame structure 136 that preferably has a depth sufficient to provide a tray retention shape relative to the bottom region of the module unit Mu resting or fixed thereon. Peripheral frame structure 136 also preferably has one or more open peripheral windows (one, two, three or four relative to the four sides shown from frame device 129, with two windows referenced as 129L and 129R shown in FIG. 2A). These window(s) in frame device 129 provide a suitable access port as for the shooting of cleaning bursts into the window(s) of the frame device and into contact with the below described retained buffer body array (e.g., gas cannons (not shown) designed to periodically or on demand shoot burst of cleaning gas (e.g., air) into the interior region of the peripheral frame structure 136).

A suitable flow length LL, for instance, for SCR1 layer (SCR1-IM) is 800 mm to 1200 mm comprised of length L_{B} for the SCR1 module block Mu and length L_{M} for the mixer IM. For example, in one embodiment a non-limiting example of length L_{B} is 800 mm with the length L_{M} being 200 mm. A suitable percentage for L_{M} relative to L_{L} (L_{M}/L_{L}) is 10 to 30% as in 20% (e.g., L_{M} being 200 mm of an L_{L} of 1000 mm or 20%). SCR2 preferably has a similar height relationship relative to the conventional SCR1 layer relative to its own module block with supporting underlying frame device 29 comprised of the upper platform and corner leg posts (see broken out module 22 (22A) in FIG. 1).

FIG. 2A also shows (schematically) module 122A_{B} of the SCR2 layer in position within ductwork 114 downstream (in a preferred upstream module to downstream, corresponding axial positioned, module common flow reception direction) of SCR1-IM. The upstream to downstream length L_{D} for the SCR2 layer can be the same or different as the SCR1 layer (e.g., with the module unit of each of the SCR1 and SCR2 layers being the same and the respective frame structures 129 and frame 27 (FIG. 1) for module 122A_{B} being similar in height or the same in height despite the IM nature of the SCR1-IM. The relative upstream to downstream length represented by each of the SCR1 and SCR2 layers can thus remain the same as in a conventional embodiment which facilitates refurbishing in that the same sized components are being replaced with the improved SCR1-IM). Thus, L_{B} plus L_{M} is equal to the L_{D} dimension shown for SCR2 (with L_{D} being for the module 122A_{B} shown generically (with both the SCR2 frame structure and module elements assembled block set not being shown in detail in FIG. 2A for convenience). Further the catalyst material composition for each of SCR1 and SCR2 can be the same or different relative to any one of the standard material characteristics for SCR catalyst in general, as in different SCR material (SCR1 having catalyst material free of PGM material (e.g., a DNX® catalyst module available from UMICORE AG (the present Applicant) and with the downstream SCR2 being inclusive of PGM layering zoning and/or arrangement (e.g., DNO® dual catalyst also available from UMICORE AG).

The present invention intermixer IM is suitable for use with any form of SCR module unit found in the art, including one with any SCR catalytically active composition such as those provided on a “catalyst carrier material” (e.g., on a porous particle's exterior and/or inside the pores of such a particle—as in carrier material of titanium dioxide, alumina, silica, and/or molecular sieves such as zeolite/zeotypes). Thus, such catalyst carrier material is designed to receive a catalyst or catalyst composition, and which can be provided together (as in a washcoat and/or dry impingement spray) for attachment to, for example, any one of the described catalyst support substrates.

A molecular sieve is a material with pores, i.e. with very small holes, of uniform size. In the context of the present invention, a molecular sieve is preferably zeolitic. Zeolites are made of corner-sharing tetrahedral SiO4 and AlO4 units. They are also called “silicoaluminates” or “aluminosilicates”. In the context of the present invention, these two terms are used synonymously.

A “catalyst support substrate” is a support to which the catalyst or catalyst composition (such as, for example, a catalyst composition provided in and/or on a porous carrier particle) is affixed and shapes the final catalyst. Examples include monolithic catalyst support structures such as the well-known honeycomb wall-flow, flow-through and corrugated sheets monoliths. The catalyst support substrates are designed to enable exhaust gas to travel there along as to facilitate a desired form of catalytic contact with the catalyst composition provided thereon. The catalyst support substrate is thus a support substrate for the catalyst or catalyst composition (and can also represent a support substrate for catalyst carrier particle material if such is utilized to hold the catalyst or catalyst composition (as often found in washcoat applications)). The catalyst support structure itself, can be extruded, for example, with catalyst material incorporated.

Thus, the nature of the SCR in the SCR layers of the present invention can vary to correspond with any of the conventional SCR types in use, as well as its intended environment. Accordingly, each catalyst module 122 can feature its modular elements provided with any of the aforementioned SCR catalyst types. Preferred embodiments under the invention include coated catalyst support substrates. Also, while the flow route represented by inlet flow FLI in FIG. 2A and outlet flow FLO is shown having a vertical orientation for the type of SCR reactor system represented in FIGS. 2 and 2A, alternate flow direction orientations as in horizontal are also featured under the present invention, as dictated by the SCR reactor needs associated with the combustion source and associated plant environment. Although not shown, this could involve, for example, frame structure 129 having a lengthened upstream-to-downstream encompassing tray or framing pattern to help retain the relative module elements (e.g., in a single stack rather than a double stack) in a desired orientation (the IM being at the downstream end of the SCR (upstream) layer or layers if more than two layers).

After exiting the downstream end of SCR1 (MU) (at a level conforming with the lower arrow for SCR1 block length L_{B}) the flow is received by intermixer IM (IMB), before heading into void V2. Void V2 extends from the downstream end of intermixer IM (which is preferably commensurate with the downstream end of the peripheral frame structure 136 of frame device 129 to an upstream end of the SCR2 layer. Void V2 is shown in FIG. 2A as having a length L_{V} that represents the exhaust flow passage length from the time it starts to be imparted with turbulence generated by the intermixer IM (IMB) till it reaches initial contact with module 122A_{B} at the SCR2 layer.

Length L_{V} is designed to present to the inlet of module 122A_{B} a highly intermixed (good NH₃/NOₓ ratio mix) for the full catalyst region involved or a high percentage intermix relative to volume and flow passageway limitations associated with the plant in which the SCR reactor system 100 is being utilized. Suitable L_{V} lengths can be determined with the benefit of knowing the particular IM characteristics, the SCR reactor assembly 100 characteristics and that of the combustion source 5.

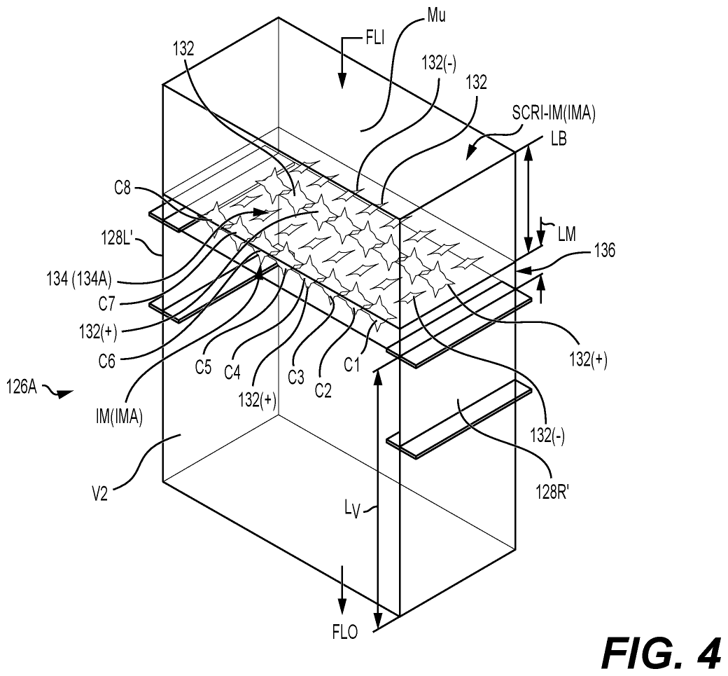

FIG. 4 shows SCR reactor structure 126A which is somewhat similar to reactor structure 126 depicted in FIG. 2A, but with a different intermixer IM (“IMA”) embodiment in FIG. 4 as compared to IM (IMB) in FIG. 2A. Relative to FIG. 2A, FIG. 4 also shows a different perspective view orientation, with module 122A_{B} of the SCR2 layer not shown as the ductwork is shown extending only down to the downstream end of void V2, which coincides essentially with the inlet end of the SCR2 layer. The IMA of FIG. 4 has a different array arrangement for its bluff bodies.

Reactor 126A also shows the usage of I-beam type supports 128L′ and 128R′ in place of the inward C-structured supports 128L and 128R shown in FIG. 2A in the support grid SG1 (noting that the C-shaped grids can be those beams of the support grid located closest to the interior of the ductwork while the I-beams can be those that cross in the open interior or one of the other of the two types can be used entirely through the area of SG1).

FIG. 4 illustrates the combination of SCR1 module block or unit Mu and intermixer IM (IMA) and thus a combination of SCR1-IM (SCR1-IMA), with the SCR1 block comprising one or more (e.g., a stacked set) of the modular elements 124 as described above. Intermixer IMA features a plurality of exhaust gas flow redirection members or gas mixing members 132. In the inventive embodiment shown in FIG. 4, intermixer IMA includes members 132 that are blunt body gas mixing plates or bluff bodies that represent flow impacting means designed to present an obstacle that redirects the exhaust flow in a manner that is designed, in non-strip-stream fashion, to generate turbulence eddies immediately behind (downstream) in the wake of the flow stream being split by the bluff bodies. This bluff body split is designed to create a flow pattern wherein gas components are intensely mixed. For example, the faster split flow sections and turbulence eddies wake flow sections are designed, after an initial high intensity mixing mode, to be further mixed as the different flow segments are joined back together as the flow travels within void V2 till reaching the inlet end of the SCR2 layer.

Examples of such flow impacting means 132 include plating that is oriented as to generate the noted turbulence flow pattern between edge contact regions. This can include, for example, relatively thin (e.g., 10 mm or less as in 6 mm or less) plates that are preferably other than in a 0° orientation (with 0° being a position wherein each of the plating's gas contact surfaces is parallel (vertical in this instance) to the flow direction passing there past (e.g., a thin plate oriented entirely vertically relative to a vertical exhaust flow passageway). This includes +/−15° to 75°, or +/−30° to 60° as in 45° and 60° orientations. The +/−reflects the direction of surface deviation relative to the aforementioned 0° as in (relative to the noted vertical plane) an orientation angle α being deemed positive (+) when a first flow contact edge of the bluff is rotated to the left or counterclockwise away from the bisecting vertical plane (as to cause the flow between similarly rotated plates to be directed to the right within the ductwork)) and is deemed negative (−) when a first flow contact edge of the bluff body is rotated clockwise away from that vertical bisecting plane (to the right of the bisecting vertical plane as to generate a leftward flow within the duct when the flow travels through a pair of similarly aligned plates).

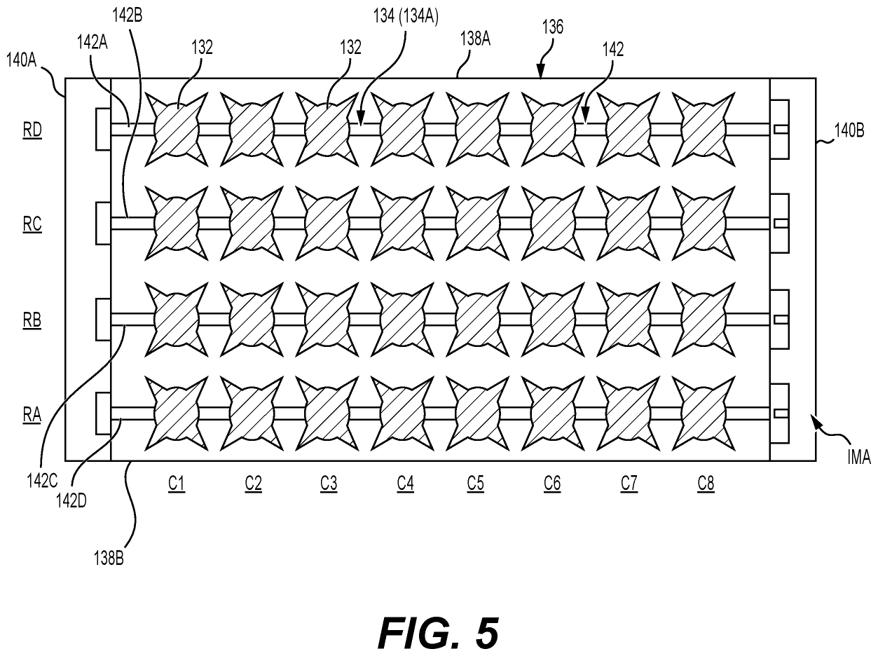

In FIGS. 4 and 5, intermixer IMA features a plurality of mixing members in the form of bluff bodies 132, which in the embodiment illustrated are star shaped plates arranged in an array 134 (134A) comprised of rows RA-RD and columns C1-C8. The bluff body array 134A is provided in the interior of peripheral frame structure 136 of frame device 129, which, in the FIG. 4 illustrated invention is a rectangular frame structure generally conforming in shape and size to the interior space occupied by the respective module unit Mu of the SCR1 layer in ductwork 114 of reactor assembly 110. Hence, the IMA frame structure includes two long sides 138A, 138B, and two shorter sides 140A, 140B (generally conforming with the noted 2×4 modular element double stack defining module unit Mu). Frame structure 129 is formed of a material that is of sufficient strength to support the array and SCR module unit Mu received thereby despite back pressure forces on the exhaust flow past the bluff bodies and the greater turbulence that develops. Also, frame device 129 needs to be of a material capable of handling the exhaust gas temperature generated by combustion gas source 5 (e.g., a fossil fuel SCR application often has an operating temperature range of 300° to 1,100° F. (roughly 150° to 600° C.)). Suitable material for the frame structure includes, for example, aluminum (e.g., for lower range temperature uses) and more preferably carbon steel and stainless steel (which are well suited for the full operating temperature range noted).

The IMA blunt body plate material, which is also subject to the noted operational temperature range and is subject to exhaust flow passage contact is also formed of a suitable material for the environment as in carbon steel or stainless steel.

FIG. 5 further illustrates support bars or rods 142 (as in the referenced row bars 142A to 142D) each supporting a plurality of the blunt bodies 132, and each extending in parallel to long walls 138A and 138B as to define blunt body columns C1 to C8, respectively. Blunt bodies 132 are preferably rigidly fixed to their supporting bars 142A to 142D as by welding or some other fixation means such as mechanical fasteners (which have the potential in some instances of enabling the replacement of damaged or overcoated with soot blunt bodies). Alternate embodiments feature an arrangement where the support bars extend parallel to the short side walls of peripheral frame structure 136 as to flip the column and row arrangement shown. FIG. 5 shows the bar and bluff body relationship in somewhat schematic fashion as preferred embodiments feature the support bars 142 passing through central apertures of the bluff bodies with the bluff bodies angled relative to the (skewing bars 142.

Under versions of the present invention, bluff bodies 132 are all angled at a common angle value, and all have a common orientation (as seen in FIG. 2A). In alternate embodiments such as featured in FIG. 4, all the bluff bodies 132 are at a common angle value but have different plus/minus orientations depending on which row (and/or column) they fall. In alternate embodiments bluff bodies can have both varying angles and varying orientations within a common array (not shown) as well as different sub-zones as in a full peripheral outer set of bluff bodies having one orientation and/or angle and a remaining interior set of bluff bodies in an array having an alternate orientation and/or angle (not shown).

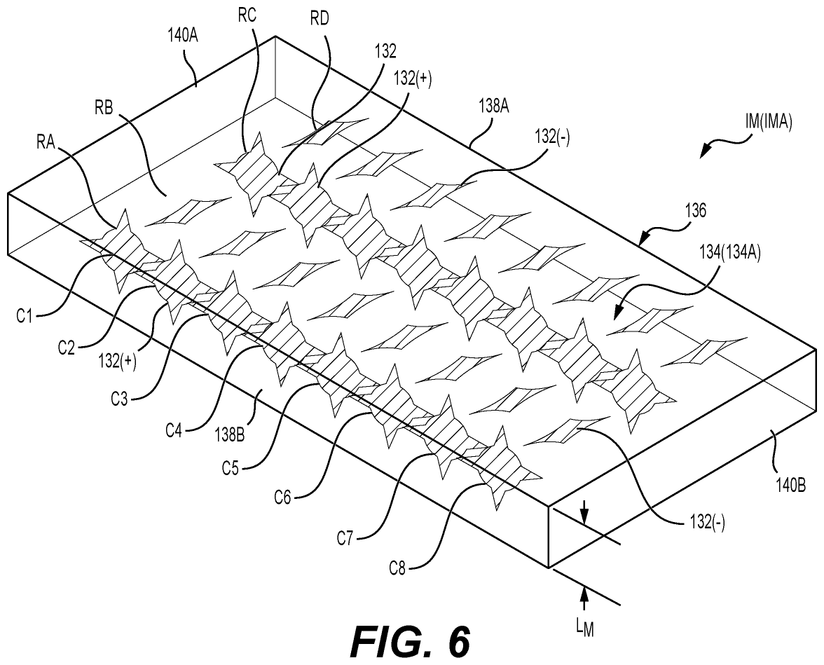

In FIGS. 4 and 6 bluff body array 134A can be seen as having its bluff bodies all with a common angle value (e.g., 60°), but with different row-to-row orientations. That is, an alternating column plus/minus orientation is set up with two of the four rows having first contact edges on the left side up from the horizontal (132(+)) (leading to a right directed flow through direction) and the remaining spaced apart two rows having first flow contact edges on the right side up from the horizontal (132(−)) leading to a left directed flow through direction).

In a preferred embodiment the bluff bodies 132 have their respective support bars 142 passing through a central aperture formed in each bluff body and are fixed in an angle state in series along the bar, preferably with equal longitudinal spacing between each (direction of elongation of the bars in the longitudinal). This rod-through center mounting helps in the stability of the blunt bodies once welded or otherwise fixed to the bars. Alternate embodiments feature a series of blunt bodies, “side mounted” along the bar bodies, rather than having the rod pass through a center aperture in each blunt body. The angling of the blunt bodies when having a center aperture results in the plates having a left side edge either higher or lower with respect to a horizontal plane depending on the plus or minus orientation as compared to a no angle or vertical oriented blunt body. Also, the relative facing along the bar is preferably of a similar row to row spacing as to have the plates occupy a significant percentage (from a flow direction blockage, or flow contact standpoint) as in a blockage state (taken from a plan view visual presence % perspective) of at least 50% relative to the whole cross-sectional area represented by the interior surface of peripheral frame structure 136.

FIG. 6 shows a perspective view of the intermixer IM (IMA) featured in FIGS. 4 and 5 by itself, and with the support bars 142 removed for added clarity as to the blunt or bluff bodies 132 that are shown arranged in the row/column array 134 (134A) encased within peripheral frame structure 136 (with the encasement being preferably both from a standpoint of peripheral encasement (horizontal plane extending through the center of the IM has the frame encompassing the full array) and vertical encasement relative to retainment between two horizontal planes lying flush on the respective top and bottom edging of peripheral frame structure 136 (i.e., the bluff body plates preferably do not stick out in the upstream to downstream flow direction outside the volume encompassed by the frame structure 136 when the plates are in their fixed state)). Further, to facilitate module manipulation from one location to another (e.g., from a storage site to placement on one of the support grids (e.g., SG1)) the array can be suspended in an intermediate vertical height area of the peripheral frame structure 136 with the lowest edge of the supported array sufficiently above the lower edge of the peripheral frame structure as to provide for fork-lift tine insertion (inclusive of suitable tine slots (not shown) provided in the lower region of the peripheral frame structure 136).

FIG. 6 additionally illustrates rows of bluff bodies RA to RD as well as the transverse alignment of the bluff bodies to form the noted columns C1 to C8. FIG. 6 shows the different orientation from row-to-row featuring rows A and C having a left-side, upward clockwise rotation from the horizontal (a 132(+) or Plus (+) mode of angling) [or relative to the above described angle α referencing, a counterclockwise rotation of a vertically oriented plate away from the vertical bisecting plane) and each of rows B and D having bluff bodies with left side, counter clockwise down below the horizontal orientation (a 132(−) or Negative (−) mode of angling) [or a clockwise rotation of a vertical plate away from the bisecting vertical plane]. As noted above, the angle of presentation for the bluff bodies can be all the same or varied (e.g., a row-to-row angle difference and/or column-to-column difference or a strategically arranged array such as one with sub-set regions having different angle values and/or orientations as well as a set up with more random angling positioning depending on the flow-through environment). Also, each module can have a common IM configuration or a variety can be provided relative to situations where there are multiple modules involved at an SCR layer with IM functioning. For the FIG. 6 illustrated invention example there is featured a same angle value for all the bluff bodies (i.e., a 60° a angle with respect to the bisecting vertical plane reference or a 30° lift from the horizontal for each) but with the different row-to-row plus/minus (+/−) orientation differential. Also, rows RA and RC are aligned to channel the flow from a left initiation state to a right outflow state (“right” out flow), while the rows RB and RD cause an opposite “left” out flow.

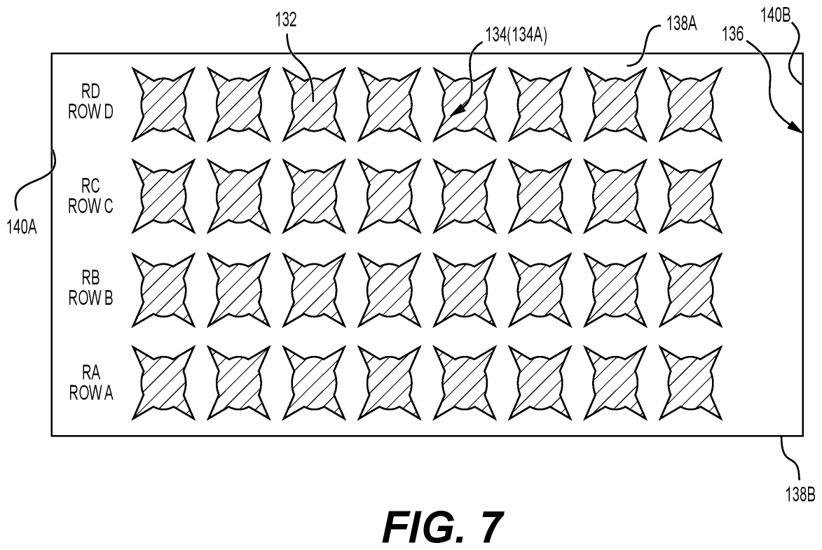

FIG. 7 shows a view like FIG. 5, but (like FIG. 6) has the bar supports removed for added clarity as to array 134A of bluff bodies 132. FIG. 7 illustrates peripheral rectangular frame portion 136 of intermixer IMA and the relative spacing of the bluff bodies within the interior area of the peripheral frame structure 136. The area occupation presented by the bluff bodies as compared to the overall open space defined by the interior surface of frame portion 136 can vary depending on variables such as exhaust flow rate (e.g., exhaust flow conditions often are in a range of 100,000 lb/hr to 11,000,000 lb/hr for many types of combustion gas sources described herein); exhaust type; relative spacing of upstream/downstream components, exhaust material components, etc. A ratio of overall area of plan view occupation of the bluff bodies 132 (“BA”) to the open area (“OA”) defined by the interior surface of the frame portion 136 (again defined by a plan view looking down at the frame structure at the location of array support) features a (BA/OA) ratio value that is preferably in a range of 40 to 80%, such as 50 to 70% or more preferably 55% to 65%. Adjustments can be made to suit the environment as in lessening the BA/OA ratio when it generates an undesired level of backpressure; or increasing the ratio when NOₓ reduction and/or ammonia slip levels exiting either the IM or a downstream SCR2 are undesirable under a given BA/OA ratio and a ratio and/or bluff plate angle change can help reduce that issue.

The peripheral shape or three-dimensional configuration of the bluff bodies can also be configured to best suit the circumstances as in the amount of reduction of NOₓ under a given ammonia slip cap, as well as flow rates, exhaust material make-up, etc. The bluff bodies 132 featured in the illustrated FIG. 5 embodiment features a star-shaped plate configuration that is generally flat in three-dimensional configuration that is formed of a suitable material as in carbon steel or stainless steel. Bent or cupped (pyramidal) shaped plates are also contemplated for use in the present invention but the featured flat plates are deemed well suited for the intended bluff body influence on the flow.

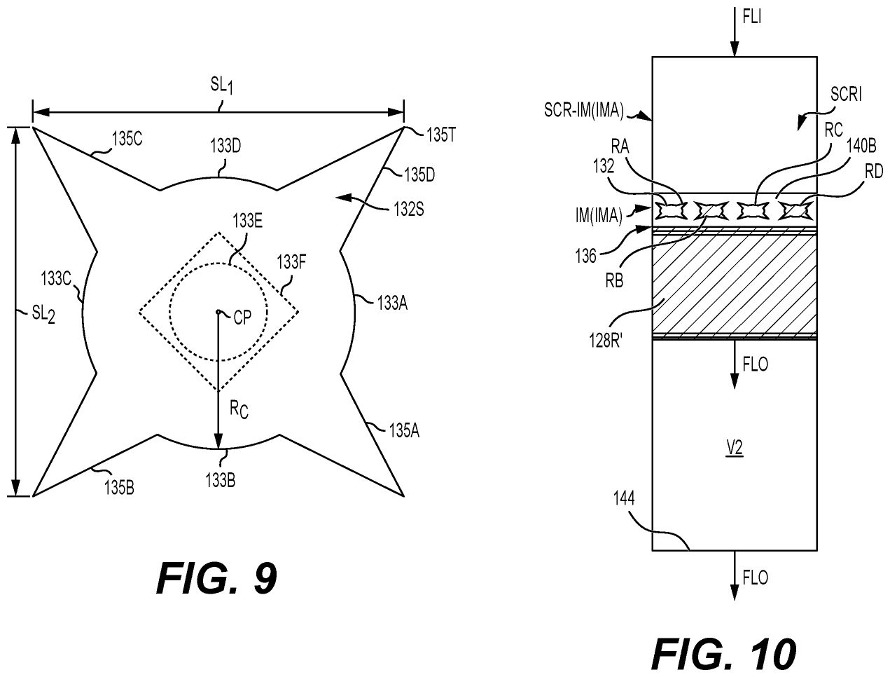

FIG. 9 shows an example of a generally star shaped bluff body (132S) that can be utilized in an array, such as array 134A shown in FIG. 5. Mixing plates having generally star shaped configurations are also described, for instance, in U.S. Pat. Nos. 7,448,794 and 7,547,134 to Hansen (but in those prior art references the plates are used in the above-described different sense of upstream positioning relative to the first in line SCR1).

In the FIG. 9 “star” configured bluff body 132S there can be seen a flat plate (at least generally flat) having a central aperture 133E through which mount bar 142 extends such that bluff body 132S can be mounted (fixed or releasably attached) on the mount bar at a desired orientation (as in the 60° a angle depicted in FIG. 4 (plus or minus orientation depending on which bar it is mounted)). The star shaped configuration is one example of having a peripheral shape other than a rectangular (square or different length sided) bluff body configuration which is designed to generate a desired turbulence pattern in the exhaust flow passing downstream of the bluff body. For the star shaped bluff body 132S example shown in FIG. 9, what normally would be a square shape has peripheral material removed to form the circular periphery segments 133A to 133D and the projecting star end segments 135A to 135D each extending out to a tip 135T. As a non-limiting example, a 200 mm×200 mm square plate (SL₁×SL₂) can be reformed (slightly lessened in area) with a 75 mm radius circular section RC at its center point CP to define the circular peripheral (between tips) segments 133A to 133D (concentric with the central aperture 133E), while a reference 75 mm central square 133F defines the star point bases which extend out to the corners (tips as in 135T) of the 200 mm reference square. This size can be scaled up and down to suit the environment, as in the IM cross-sectional area, exhaust flow speed, desired turbulence generation, etc.

With such a plate configuration as described, a further non-limiting example of sizing correlation is represented relative to the peripheral area featured in FIG. 5 of the peripheral frame structure of the IMA featuring roughly a 2000 mm×1000 mm (length×width) rectangular outer periphery and a 200 mm IM peripheral frame structure height. With such an IM frame structure, suitable spacing dimensions relative to the center of bar 142 to center of bar can be 250 mm with an additional 125 mm from the closest long wall 138A (138B) to the adjacent-most respective mount bar 142. Also, a spacing of 200 mm from center of star to the next one along the row length (defining the spacing between columns) with a 300 mm spacing between the center of the last star in a row to an adjacent short side wall of frame portion 136. The above dimensions are not meant to be limiting but illustrative of potential sizing for an embodiment envisioned under the present application (as with other specific dimension referencing in the present application).

The SCR1-IM (e.g., SCR1-IMA) combination preferably has a common length (vertical height in this instance) as a standard SCR layer in a reactor structure such as reactor 10 in FIG. 1. Further, the SCR1-IM and SCR2 layer can be provided with a common module shape and volume as in each having a common flow direction length. Thus, relative to the FIG. 2A configuration, the IM can occupy the lower portion of a commonly configured module unit that corresponds with the SCR2 module unit's configuration (with FIG. 2A showing a generic SCR1 layer comprised of, for example, a conventional frame 27 plus the double stack set of module elements 24 featured in the conventional module unit described in FIG. 1).

The relative spacing of the downstream end of the SCR1-IM and the upstream end of the SCR2 layer, which corresponds to the longitudinal length L_{V} (FIG. 2A) of void V2, is designed with the goal of providing sufficient time to achieve the noted maximum lowering of the mal-distribution by the time the exhaust flow reaches the SCR2 layer, although space constraints, etc. may entail shortening to accommodate other factors that cannot be easily avoided. Alternatively, when there is involved a preexisting plant refurbishing (new catalyst system installation in a preexisting plant with, for example, degraded catalyst layers, the void length can be made relative to the preexisting C-SCr1 output (to be replaced with a new SCR1-IM) to the inlet of the C-SCr3 inlet (the new SCR2) with the empty support structure grid SG2 preferably retained due to its limited blockage in the void V2 region and the difficulty of removing the same from a preexisting reactor frame structure 114).

A suitable longitudinal length L_{V} for void V2 is designed to accommodate the various inputs and variables involved and can be predetermined with the assistant of CFD simulation for a given set of parameters for a new plant design or a plant being refurbished per the above, with an example suitable for the above-described dimensions for reactor apparatus being 1900 mm which is inclusive of each of the longitudinal lengths of the structural supports 128L and 128R to each side in added support contact with the IM's lower edge. Each of IM supports 128L and 128R share a configuration that provides an inward extending support flange (as provided by opposing C-frames or I-frames). Supports 128L and 128R of the associated SG grid provide a location for the IM to either be simply rested upon (with gravity retentions) or to be fixed in position (particularly as when other than vertical). With reference to the above-described non-limiting examples for a reactor such as one designed to handle exhaust gas generated from a coal fired plant as an example of combustion gas source 5, a suitable flow length for supports 128L and 128R is 678 mm leaving a remaining void V2 longitudinal section of 1222 to make up the noted V2 length of 1900 mm. Again, these values are intended to be non-limiting and are presented merely to help better appreciate, for example, relative relationships, etc.

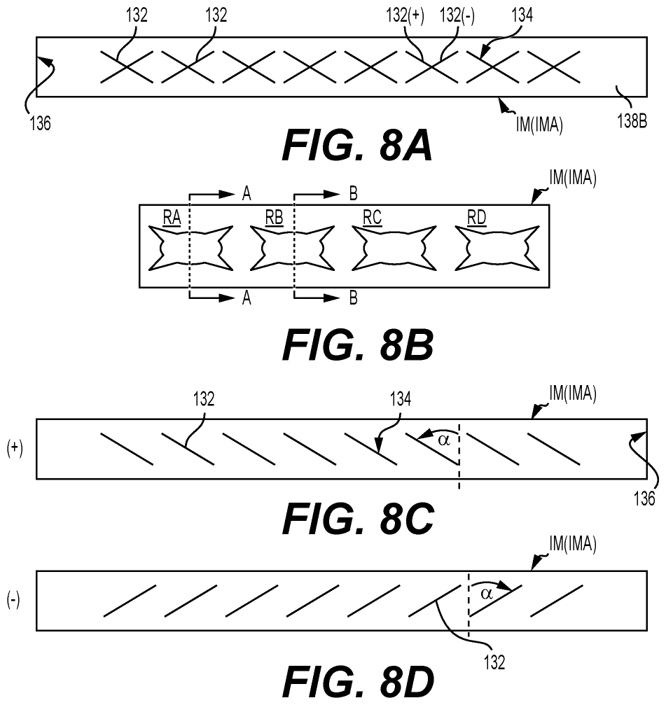

Reference is made to FIGS. 8A, 8B, 8C and 8D. FIG. 8A shows a schematic front elevational view of IMA with the long side walls (138B) of the IMA presented as transparent (lined area only) to enable a better visualization of the blunt body array 134 from that viewpoint. As can be seen, the alternate orientation from row-to-row transversely across the structure represented by the peripheral frame portion 136 results in the “X” cross appearance for the array (an equal angle above and below the horizontal for each segment of the X-cross appearance in view of the common angle embodiment featured in FIG. 8C). FIG. 8B shows an elevational view of short side 140B with the same transparent/line only depiction such that the first blunt or bluff body 132 set located in the far-right column of FIG. 7 can be visualized with two of the four rows having one (+/−) orientation with the remaining two of the four rows having the opposite (+/−) orientation. This different (+/−) orientation can be seen in the FIGS. 8C and 8D depictions taken, respectively, along cross-sections A-A and B-B shown in FIG. 8B, with angle α (counterclockwise (+) or clockwise (−) rotation from the bisecting vertical plane) being shown therein.

The addition of an IM with its bluff bodies (as in IMA shown in FIGS. 4 and 5 with the star shaped bluff bodies 132) and the relative angle of blockage versus clear space regions, as well as the pass-through flow rate of the exhaust gas and other parameters of reactor system 100, is designed to add preferably less than 0.20 IWC (inches water column) to the overall pressure drop at the SCR1 layer. Preferred inventive IM set-ups featuring the inclusion of the IM in the SCR1-IM is designed to add 0.10 or less IWC, and even more preferably, 0.075 or less IWC to the overall pressure drop of the SCR-IM as compared to the pressure drop associated with a conventional SCR1 like that of SCR2. For the illustrated example featured in FIG. 4, an overall pressure drop of 0.06 IWC is featured due to the inclusion of the IMA.

The noted overall pressure drop is developed due to the partial blockage nature of the IM but the improved turbulence intermixing brought about by the IM in the SCR1-IM provides a benefit beyond any issue of increased backpressure under aspects of the invention.

FIG. 10 shows a short-side-frame elevational view of that which is shown in FIG. 4, with IM support 128R′ (an I-beam vs the inward C shape of 128R) of the support grid SG1 supporting SCR1-IM (preferably multiples of SCR-IM are supported on the support grid SG1 corresponding to the number of modules shown in FIG. 2 as being supported on the SG1 support grid for the SCR1 layer). Inlet flow FLI of the exhaust gas passes through the SCR module element block set (e.g., the 16-block set described above) SCR1-IM and thus through array 134A of IMA (with the IMA including the array 134A and frame device 129 inclusive of the peripheral frame structure 136 in which the array 134A is supported for flow contact). After exiting the SCR1-IM the mixed flow travels into void V2. In view of the varied nature of the modules' relationships with the underlying support grid beam type, reference below is to just “128L” and “128R” with the type being that which is best suited for the location of the grid relative to the ductwork cross-section.

FIG. 10 shows void V2 (as defined by the interior surface of ductwork 116) extending in linear, vertical fashion downstream as to define exhaust flow FLO (exhaust flow having already exited each SCR1-IM of the SCR1 layer). Exhaust flow reaches the end of void V2 at plane 144 which preferably also represents the border location relative to the inlet end of the next in line SCR2 layer (not depicted in FIG. 10). FIG. 10 further shows the short side 140B of frame 136 (presented as transparent for view purposes as in FIG. 8B or configured as to present an access window via appropriate framing) wherein there can be seen the closest one of bluff bodies 132 on their respective support bars (bars not shown for added clarity here) having a lighter/darker view sequence to reflect the different (+/−) arrangement of the bluff bodies relative to rows RA to RD.

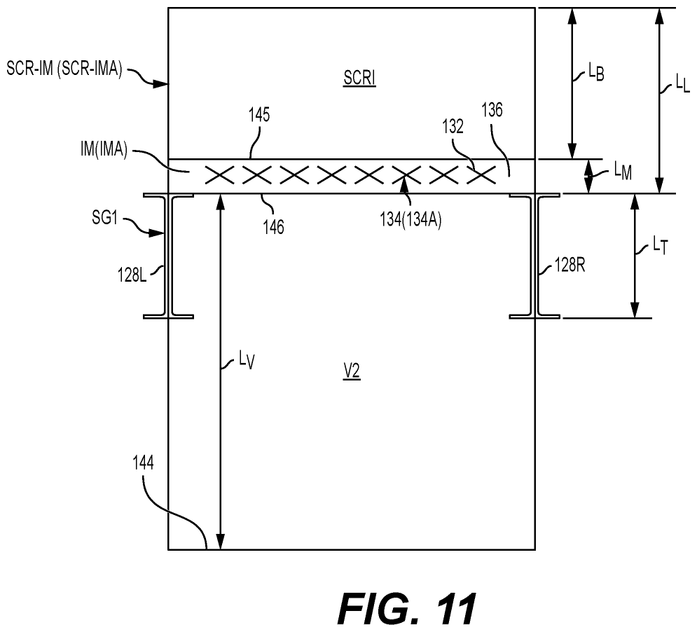

FIG. 11 presents an elevational view of the same components as depicted in FIG. 10, only, rather than a short side wall view as in FIG. 10, from a long side wall viewpoint relative to peripheral frame structure 136 (a view into long side edge 138B of IM (IMA) which is presented “transparent” to better illustrate bluff bodies 132 in their array 134 (134A) supported within peripheral frame structure 136). Array 134 shown in FIG. 11 correlates with that which is shown in FIG. 6 (also in a common long frame wall “transparent” view) and thus also with the same array 134 shown schematically in a top plan view in FIG. 7.

The SCR-IMA shown in FIG. 11 represents an SCR1 layer relative to the exhaust flow being treated by the SCR reactor and has an overall flow length of L_{L} made up of the SCR1 module block of flow length L_{B} plus the flow length L_{M} for the IMA (as defined by the flow length between the upper edge 145 (or upstream edge if the reactor has a different orientation as in horizontal instead of the vertical orientation depicted) and the lower (or downstream) edge 146 of peripheral frame structure 136 of IMA frame device 129). Reference is made to the above example length discussion noting a 1000 mm flow length for the SCR1-IM (made up of SCR1 module block of 800 mm and a 200 mm flow length for IM) which 1000 mm flow length also preferably corresponds with the flow length of the downstream SCR2 (not shown in FIG. 11) such that the relative “layer” length of each of SCR1-IM and SCR2 are equal with SCR2 preferably having a module element underlying frame structure (frame device 27 in FIG. 1) with the frame structure presenting generally a common exterior configuration (but with frame device 27 being devoid of the SCR1's IM having a modified frame structure 129 for supporting the associated bluff body array as (and which is preferably a three-tier structure) to place those bluff bodies in the exhaust flow exiting the SCR1 module block and in a suspended state within the frame structure multi-tier frame structure). Also, the noted flow length L_{L} for the noted dimension examples can be the same as the short side length (1000 mm) of frame structure 136 (with the long side 140B of frame structure 136 being, for example, 2000 mm in such a non-limiting dimensioned example).

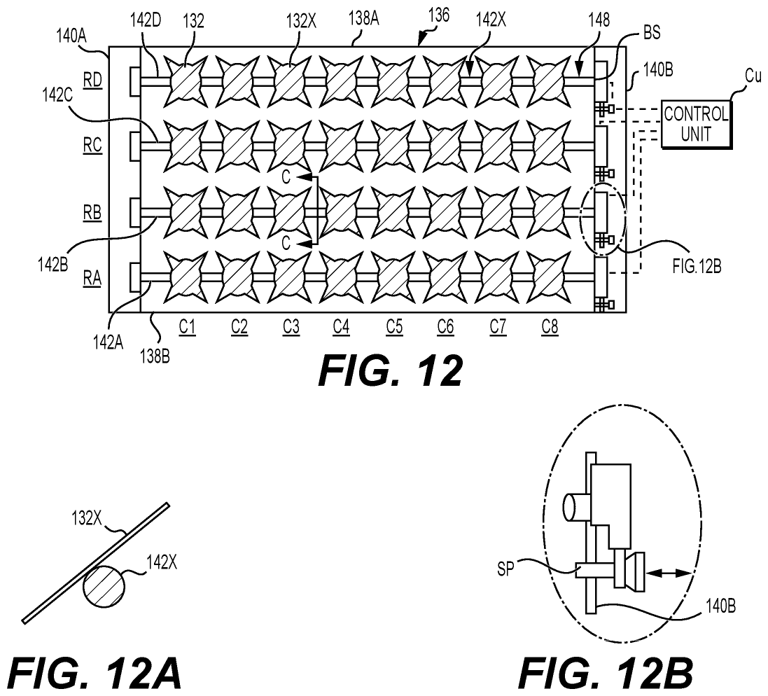

FIG. 12 shows a similar view to that shown in FIG. 5 but with a modified bar support assembly 148 featuring, instead of a central aperture mounted bluff body as in FIG. 5, a tangent side mounted bluff body 132X (as shown by the FIG. 12 C-C cross section shown FIG. 12A). Each bluff body 132X (with an example shown in the form of a star plate as previously described) is fixed to mount bar 142X rigidly (e.g., a weld) or mechanically (e.g., as by a connection strap or clamp arrangement (not shown)). Under such an arrangement, rotation adjustment (as in any point along the plus/minus angle ranges described above for bluff body 132) can be implemented via, for example, a mechanical rotation spring biased snap pin SP (FIG. 12B) that is put in place relative to a series of holes formed in the side frame short wall around each bar mount location as featured in FIG. 12B (as but one example of rotation setting adjustment means).

In an alternate embodiment, and as shown schematically in the right side of FIG. 12, a motorized arrangement can be utilized as the rotation setting adjustment means. Under such an optional approach, there is shown control unit Cu (e.g., a processor having suitable software and/or firmware to achieve specific orientation and/or angle parameters for bluff bodies in an array) as in one providing feedback and/or feedforward bluff plate adjustments during live stream exhaust flow through the IM and/or ahead of time for anticipated plant run settings. Suitable bluff body control adjustment means includes, for example, one common motor with a plurality of clutch engagement pulley lines that are each controlled/set to desired angle locations by way of controller Cu or individual motors as in step-motors for individual control of the rotation setting of the mount bars and hence the bluff body 132X orientation for those bluff bodies supported by that adjusted mount bar 142X as through the use of magnetic bearing sensors BS with relative location feedback.

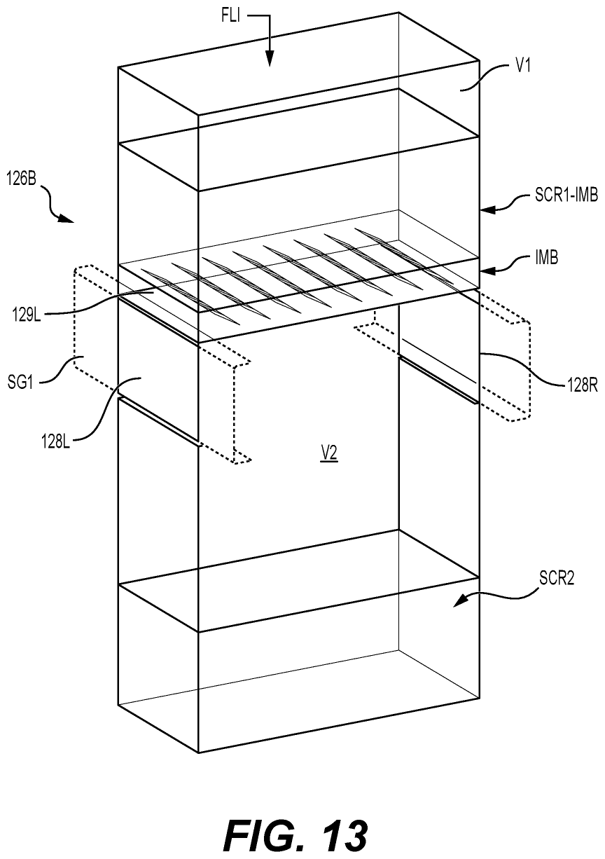

FIG. 13 shows SCR reactor structure 126B which shares similarities to reactor structure 126 featured in FIG. 2A (an array having a single angle and single orientation fully across the array for IMB). Reactor structure 126B has a similar SCR1 and SCR2 layer and module block arrangement as featured in FIG. 2A (preferably inclusive of similar dimensioning and the inclusion of voids V1 and V2, supports 128L and 128R for the SG1 support grid, a common up-to-down (upstream-to-downstream) flow arrangement with inlet FLI and post SCR1-IMB outlet flow FLO, and the potential for access gaps or windows as in gaps 129L and 129R (e.g., access openings for soot removal)). SCR reactor structure 126B has a different array pattern than SCR reactor structure 126A, and hence the different intermixer structure of SCR reactor structure 126B is referenced as IMB in FIGS. 2A and 13 (and correspondingly its intermixer-SCR combination is referenced as SCR1-IMB). FIG. 13 illustrates the underlying support grid SG1 that is a lattice support allowing the noted plurality of modules (with associated set of module elements) to be positioned in side-to-side contact such that the IM featured in the associated frame device 129 for each module is retained with generally a notion of maximum output with little outflow disruption by the respective grid beams of SG1. By way of a combination C-shape 128L and I-beam 128R′ the SG1 support grid can be set up in conjunction with the ductwork interior as with the C-shaped beams running along the interior of the ductwork and the I-beams running within the interior to allow for the side-by-side module placement to fill up the entire cross-sectional area at that location of the ductwork.

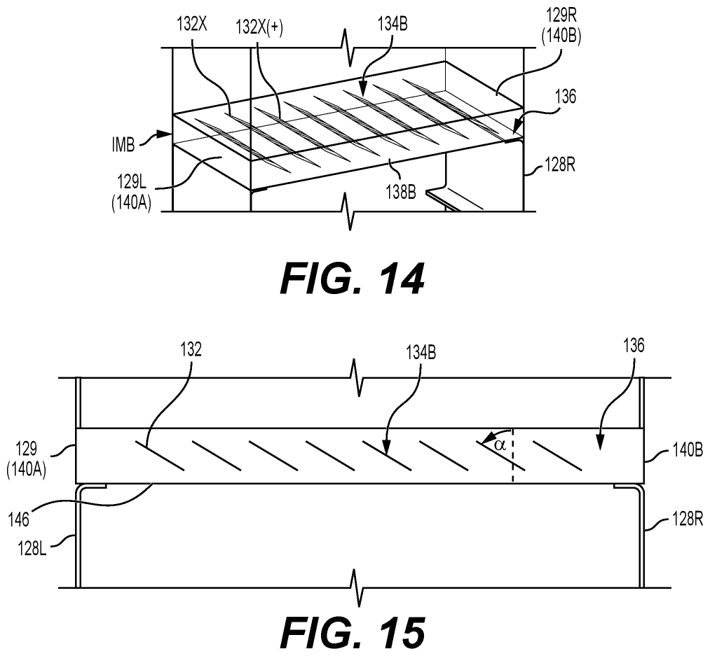

FIG. 14 shows a breakaway perspective view as to the region surrounding IMB in FIG. 13. FIG. 15 shows the same region in an elevational view facing a “transparent” version of the long side of the IMB frame portion 136. As seen from FIGS. 14 and 15, the intermixer IMB has its bluff bodies 132 in a different array pattern 134B than array 134A of FIGS. 4 and 7 although is comprised of the same number of bluff bodies, the same star shaped plating, and has a common value angle throughout feature as array 134A (e.g., any one of the aforementioned angles, but with α=60° being featured in FIGS. 14 and 15). Unlike the array 134A featuring both plus and minus orientations, array 134B has a common orientation (first contact left edge rotated up in clockwise fashion from the horizontal in the view shown as to represent a positive (132(+)) orientation per the above-described frame of referencing).

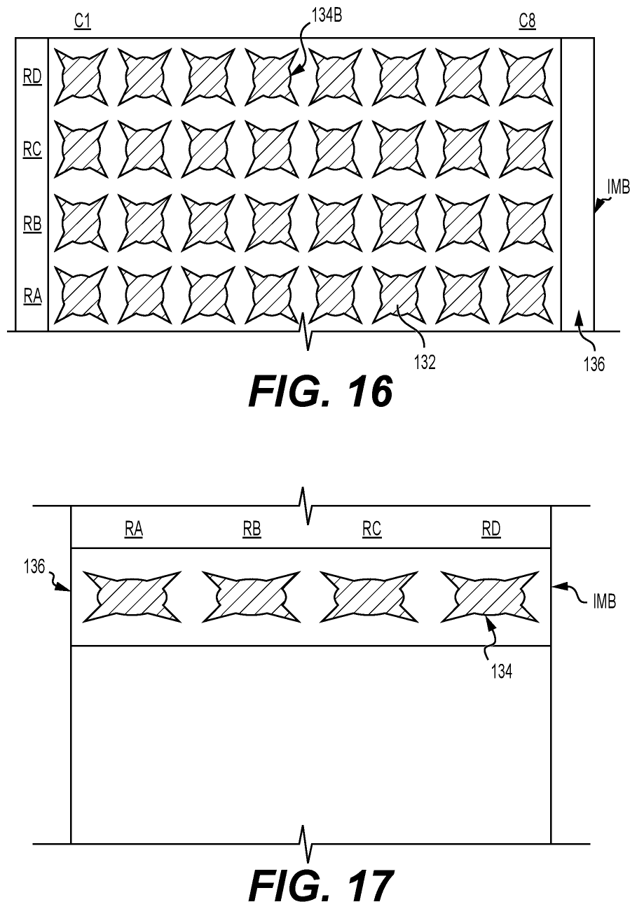

The IMB arrangement shown in perspective in FIG. 14 is shown in plan view in FIG. 16 (again schematically with the supports rods removed for added clarity as to the star shaped plates' spacing, etc., which is preferably the same spacing as described above for IMA) and in end view in FIG. 17 (with the “transparent” frame structure view as well). The darker shaded bluff body 132 depiction of each of the rows RA to RD is due to the noted all same orientation (and preferably all same angle) featured in IMB as compared to the light-dark sequence associated with the bluff-bodies in the IMA configuration shown in FIG. 10. The aforementioned blockage/passage open relationship for IMB is preferably similar to the above-described IMA embodiment.

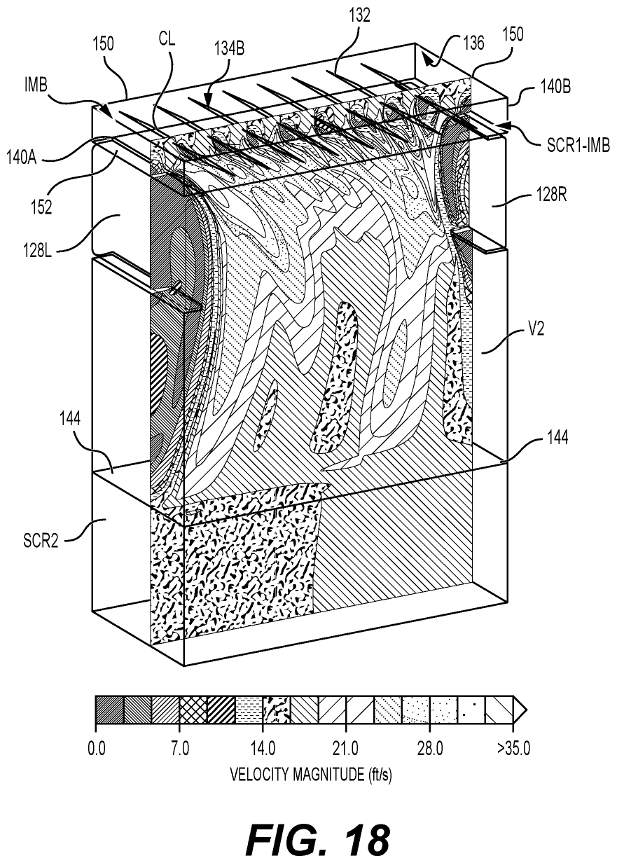

FIG. 18 shows a perspective view of a reference modeling set up for an illustration of results of a conventional computation fluid dynamics (CFD) software simulation run relative to a reactor system having the SCR1-IMB configuration. The simulation is shown relative to a vertical slice of the star shaped bluff bodies 132 having all rows angled right (+) (i.e., all having a common orientation) and all at an angle of 60°. FIG. 18 focuses on the pertinent region (relative to IMB intermixing) of the exhaust gas upon reaching the upstream inlet plane or interface border 150 which also constitutes essentially the exiting plane of the SCR1 module block(s) (blocking not shown in FIG. 18). For the flow pattern presentation generated by the CFD program there are different velocity magnitude representations for the simulated flow as per the key provided in FIG. 18.

The flow velocity magnitude pattern presentation shown in FIG. 18 is based on a vertical cut taken at 125 mm from the centerline CL (shown in the intermediate area of the frame structure 136 as extending parallel to the long side walls of that frame structure and bisecting row RB). This cross section is deemed to be a good location for a representation of the intermix patterns that develop in the exhaust flow due to velocity flow parameters. FIG. 18 shows that the simulated exhaust flow pattern initiates at the noted planar interface 150, passes through the IMB itself, travels through void V2, reaches the planar interface 144 (the border region between the end of void V2 and the initiation of SCR2), and then passes within SCR2.

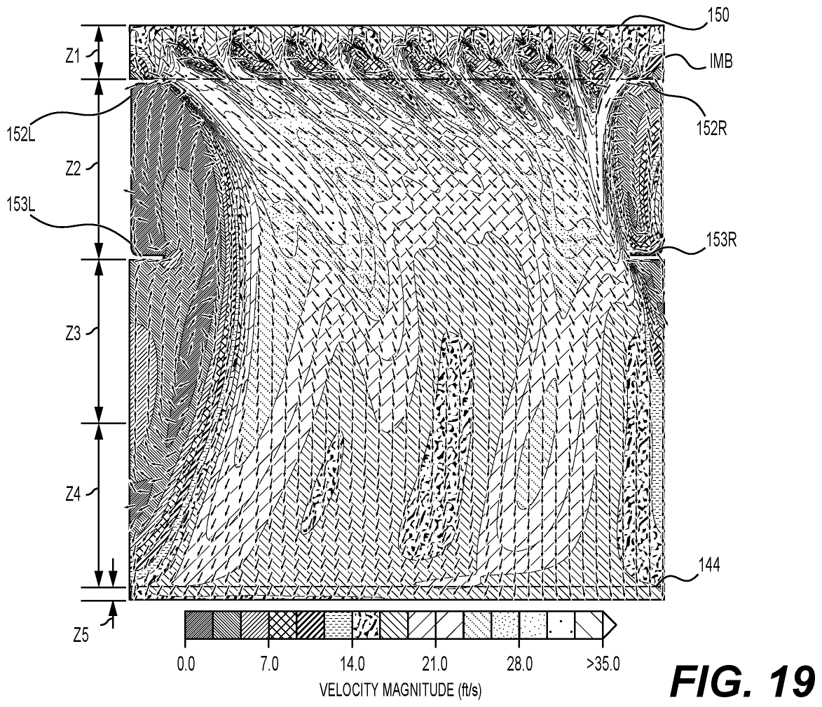

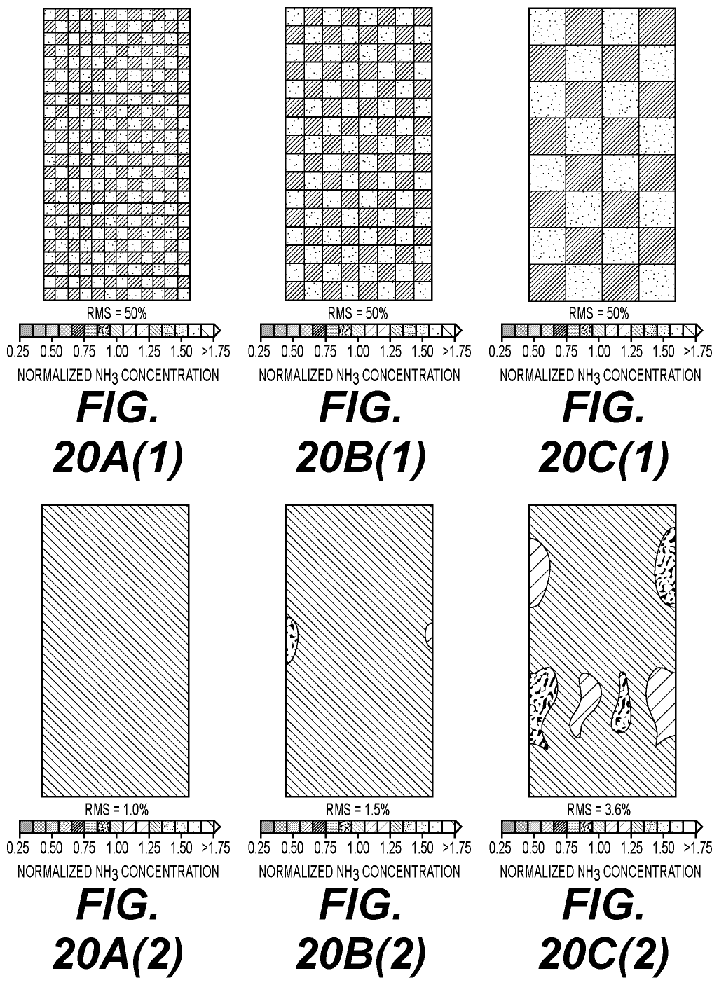

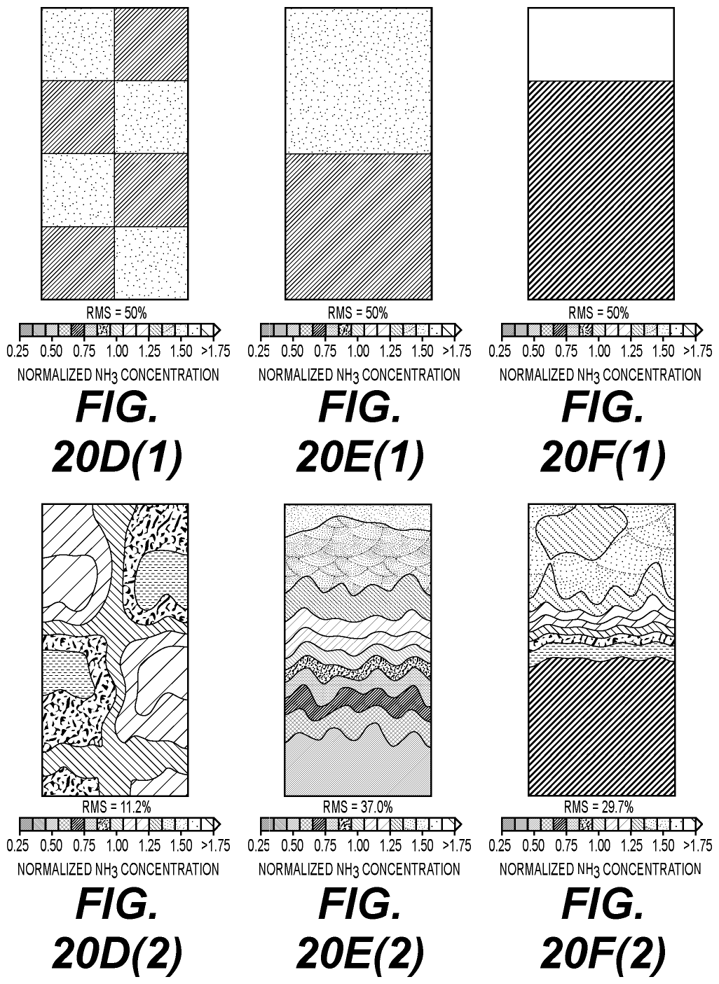

FIG. 19 provides a planar view of the flow velocity shown in perspective in FIG. 18 with a focus on that pattern alone (structure removed and expanded view of the pattern). Also, to facilitate the discussion below as to the changes in the flow pattern induced by IMB, vertically spaced reference zones Z1 to Z5 are set up in FIG. 19. Zone Z1 is representative of the exhaust flow velocity pattern computed with the CFD software as it travels through the IMB. The flow can be seen undergoing a series of transformations including a simulation as to conversion in flow velocity following receipt at the upstream plane 150 (start of IMB). Upon contact with the bluff body array 134 there can be seen the development of the bluff body slow velocity sub-zones directly under the bluff bodies and in general alignment with the angle of the bluff body. Within zone 1 there can also be seen the increased velocity regions that develop in-between or to the opposite sides of each bluff body in the array.

FIG. 19 shows relatively deep extensions of higher velocity segments of the modelling extending well into V2 in regions originating in the gaps formed between the ends of the bluff bodies closest to the shorter side walls of frame 136 and the upper flanges 152L and 152R of supports 128L and 128R. The higher velocity segments extending out between the bluff bodies edging are shown as being directed in a left-to-right diagonal in association with the bluff body angle, except at the right region of the simulation wherein the higher velocity last left-to-right jet is shown colliding with the right-to-left higher velocity segment squeezing through the far-right gap adjacent flange 152R. Zone Z2 extends from the exit end of the IMB to the lower support grid beam flange 153L,R, while the zones Z3 and Z4 split the length difference between the end of zone Z2 and start of zone 5.

FIG. 19 shows each of the left and right end region high velocity segments extend down to near the region where the lower support flanges 153L and 153R for the respective support beams 128L and 128R project. In turn, these higher velocity flow regions intermingle with the slower flow velocity zones in the region between the upper and lower flanges 152 and 153 of the respective 128L and 128R support beams. The nature of this downward directed bluff body induced higher and lower flow velocity regions shows how the bluff bodies can help in the general intermixing of the respective reductant reagent and exhaust flow gas as can be seen by the gradual lessening and general disappearance of the extreme slow and extreme fast regions in favor of, first, an intermediate flow region within zone Z3 in void V2, and eventually to the zone Z4 region wherein the more extreme velocity high and low gradients have disappeared in favor of more moderate flow velocity regions and lowered mal-distribution level by the time the flow passes completely through zone Z4 and into interior SCR2 flow within zone Z5 (see the generally consistent intermediate flow rate magnitude across the board at end of zone Z4).

Also, FIG. 19 further shows that despite all of the angle orientations being the same in the full array there is an initial bowing of the flow's higher velocity back toward the central region and with this gradual recentering (as the flow is driven down the void V2) leading to essentially a full recentering by the completion of flow travel to plane 144 (and also a longer longitudinal length slow velocity zone to the left in FIG. 19 as compared to the opposite shorter frame wall side toward which the angled bluff bodies initially direct the received mixed flow). That is, as seen from the left side view of FIG. 19 the slower flow indicia in the pattern on the left extends into each of the demarcated zones Z1 to Z5 before converting to a bit less slow and ultimately to an intermediate velocity magnitude that generally coincides with the remainder of the inflow into the reception region of the SCR2. On the right side there is seen that the slowest zone doesn't extend as deep vertically (just below flange extension 153R and about halfway into zone Z3) rather than nearly to the end of zone Z4 as on the left side.

To help further illustrate the ability of the IM to improve mixing characteristics in the reducing reagent/combustion gas (component) flow mix, as in an NH₃/NOₓ mix, the CFD program was provided with various simulation inputs and outcomes that are represented in the FIG. 20 set. FIGS. 20A1 to 20F2 show, in combination, a comparison of simulated inlet and outlet NH₃ concentration profiles for the array 134B in FIG. 18, but with each having a different ammonia level sub-zone concentration pattern or profile as demarcated by the different level indicia presented in the “Normalized NH₃ Concentration” or “NNC” key associated with the FIG. 20 set.

The FIG. 20 upper “(1)” sub-set shows simulated NH₃ concentration profile regions across the inlet end of the IMB (or outlet surface of the SCR1 catalyst block at that common interface plane 150). The simulated regions at this upper (“1”) location are each set up with a 50% RMS value at the inlet of the IM, but with that 50% RMS achieved in each case in a different manner. The FIG. 20 lower “(2)” set shows the CFD profile determination of the NNC at the planar interface 144 which represents the RMS nature of the mix reaching the inlet end of the SCR2 for treatment.

The FIG. 20 set shows how each sub-zone (e.g., a checkerboard square sub-zone) has an associated generally high/low NNC variation as seen from the indicia for each sub-zone and the associated indicia representation in the NNC key. FIGS. 20A to 20C show a fine/less fine/and moderate checkerboard design sequence for their sub-zones (as compared to FIG. 20D to 20F) reaching the inlet of the IMB. As seen by the indicia, the lighter squares in each of FIGS. 20A to 20C have a lower NNC range value while the adjacent, darker squares have a relatively “high” NNC level, and with the square size representing the level of initial segregation of the various high and low NNC sub-zones across the inlet of the IMB (a large number of small dark and light squares is indicative of a more greatly divided set of sub-zones across the plane for the NH₃, although still with an aggregate 50% RMS based on the high and low corresponding number and relative velocity). As seen by the FIG. 20 location “(2)” set for the interface plane 144 leading into the SCR2 block location representation, IMB is well suited for achieving RMS values below 5% (FIGS. 20A to 20C) for the input featured in the FIG. 20 location “(1)”, with FIGS. 20A and 20B also achieving below 2% RMS values.

Thus, with the more dispersed “checkerboard” squares represented in FIGS. 20A to 20C, there can be readily attained an RMS below 5% at the inlet of the SCR2. Thus, the IMB intermixer can be seen to work well with many input parameters often associated with combustion gas source plants.

Some plants, however, due to their overall flow region (large cross-sectional flow areas in ductwork will present different or varied module in-flow patterns across the full cross-section of flow at that layer) and/or other factors such as fouling, poor injector set ups, etc. present the potential for even worse flow patterns at an outlet end of the one or more modules representing the SCR1 layer of an SCR reactor. FIGS. 20D, 20E and 20F represent some CFD flow patterns that simulate an exaggerated degree as to a lack of sub-zone dispersion that may exist at the exit of the SCR1 for a particular module amongst a group of modules.

FIGS. 20D to 20F, while each showing a common overall 50% RMS distribution, feature a lesser number of high/low NH₃ sub-zones as compared to FIGS. 20A to 20C. As seen by a comparison of the NNC with FIGS. 20D and 20E there is seen a similar overall 50% RMS input value as was present for FIGS. 20A to 20C, but with FIG. 20D having a large block sub-zone dispersion featuring an 8 block set of high/low sub-zones within the simulated IMB peripheral area (as compared, for example, to a 32 block sub-zone simulation for FIG. 20C). Also, each of the darker and lighter sub-zones can be seen as each being in a moderate or middle concentration zone range in the respective high and low sub-ranges in the NNC key. There can be seen from the CFD modeling that despite such a poor sub-zone dispersion pattern a close to 10% level (11.2%) RMS value at the inlet plane of the SCR2 is simulated for FIG. 20D.

FIG. 20E(1) shows a two-block 50/50 generally high/low (same levels of moderate high/low NNC values as in each of FIGS. 20A to 20D; but with the extreme lack of cross-section sub-zone dispersion as seen by the 50/50 sub-zone split across the simulated cross-section of the IMB at plane 144). This set up is shown by the CFD and the FIG. 20E(2) 37.0% NNC at plane 144 to be the most difficult to achieve a low RMS leading into the SCR2. However, as an extreme is represented and the other less extreme presentment scenarios show high mixing, IMB is deemed suitable for some environments. However, as exemplified below, with alterations in the IM array design under the present invention the RMS reduction level even for more extreme scenarios (e.g., a more universal treatment to any of the various outputs of multiple SCR modules across a large ductwork area) can be brought significantly farther down under the present invention.

FIG. 20F(1) shows another altered CFD inlet pattern having a 25/75 split sub-zone coupled with a variation in the relative NNC high/low chosen values as compared to FIGS. 20A to 20E. That is, with a review of the key for the NNC there can be seen that the 25% zone is provided with a very high NNC (higher than the darker/higher NNC values for FIGS. 20A to 20E) while the 75% zone is provided with a lower NNC value than the lower values featured in FIGS. 20A to 20E. Thus, in light of the different input NNC values, the differential as to sub-zone occupation (25/75) is offset to result in a 50.0% RMS simulation value for the input shown in FIG. 20F(1). Like the FIG. 20(E) pattern, this highly one sided pattern in FIG. 20(F) shows a degree of difficulty in achieving a value relatively close to 10% RMS with the resultant value of 29.7% RMS shown in FIG. 20F(2). Again, since an extreme presentation is featured and the intermixing by the IM is considered rapid and sufficiently spread across the cross-sectional area despite a limited void length, it too is deemed well suited for some embodiments of the present invention (e.g., the average RMS values across a large cross-sectioned ductwork with multiple modules is unlikely to have such egregious readings over all modules and thus the average is likely to be farther below the noted amount in FIG. 20F(2) in many plant configurations, but the ability to knock down the most egregious regions facilitates pulling down the overall RMS value across the full area). Moreover, as noted above, the RMS reduction capability for even the presented extreme positions can also be significantly farther lowered via an alteration in the IM arrangement of the present invention as illustrated in the discussion below.

From a comparison between FIGS. 20A to 20C and FIGS. 20D to 20F there is seen that the latter arrangements with a limited sub-zone dispersion (e.g. a 50/50 overall area sub-zone split (each with moderate high/low NNC values) or a 25/75 two sub-zone split (with “higher high” end NNC and “lower low” end NNC values offsetting into a 50% RMS) are more difficult to reduce to close to 10% or below. With the less dispersed sub-zone patterns, the IMB facilitates within these difficult arrangements the generation of pockets of turbulence as well as the pushing of the opposite ended high/low NNC regions of gas toward each other and thus getting the simulated gas flow well intermixed by the time the flow reaches the end of void V2 and interface of the SCR2 layer at plane 144. The IMB, itself, is considered to help avoid or lessen the number of steps that may additionally be needed within the SCR reactor in an effort to satisfy the more stringent NOₓ and anti-NH₃ regulations (as in one or more of—increased SCR catalyst loading, increased void V2 length, added SCR layer units, etc.). None of these added steps are desirable and thus the ability to avoid one or more or all via the IMB design to facilitate higher RMS percentage drops between planes 144 and 150 is desirable (with some of the below described IM designs bringing the plane 144 RMS percentage level even lower than that achieved by the IMB for the more egregious limited sub-zone patterns). Again, the ability to lessen the extent of maldistribution in the flow reaching the inlet end of the SCR2 layer can lessen the need for one or more of the added steps noted above in an effort to bring the SCR system into compliance (e.g., a significant drop even for the more problematic limited sub-zone patterns would lower the amount of added catalyst that might be involved absent an IM)).

With the noted flow velocity magnitude at the upstream plane, the pressure loss associated with the added IMB is 0.06 IWC (inches water volume).

Provided below in TABLE 1 is a summary of the simulation pattern and plane level 150 and 144 RMS percentage levels for the FIG. 20 Set (which is considered illustrative of IMB performance).

TABLE 1
IMB performance

| FIG. 20 | A | B | C | D | E | F |
|---|---|---|---|---|---|---|
| Pattern | Fine | Less Fine | Moderate | Large | Full | Full 25/75 w/more |
| | Check | Check | Check | Check | 50/50 | diverse NNC |
| RMS (1) | 50% | 50% | 50% | 50% | 50% | 50% |
| RMS (2) | 1% | 1.5% | 3.6% | 11.2% | 37.0% | 29.7% |

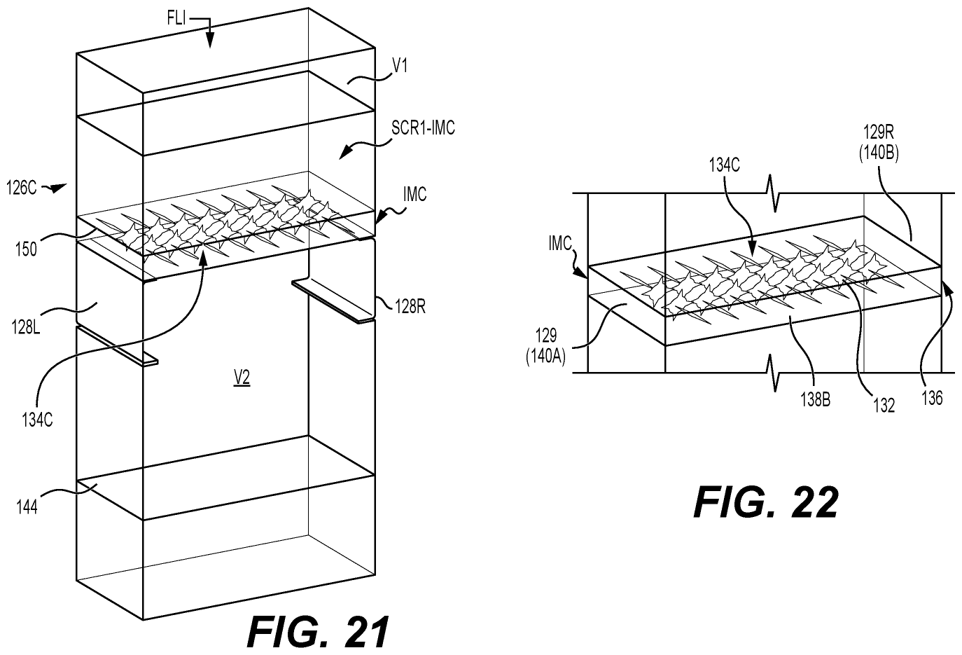

The below described FIGS. 21-27 and associated FIG. 28 set generally correspond, respectively, with FIGS. 13-19 and the FIG. 20 set earlier described, and thus the common components and attributes are not repeated. Rather the focus is on the differentiating IM nature of the illustrated different arrayed intermixer IMC as compared to IMB, for example. That is, wherein FIGS. 13-19 feature the IMB, FIGS. 21-27 are directed at IMC within an otherwise common SCR reactor set up as well as a common CFD simulation set up. Accordingly, FIG. 21 presents an illustration of SCR reactor structure 126C which shares similarities to the earlier described reactor structure 126 featured in FIG. 2A as well as reactor structure 126B in FIG. 13, but with a different IM configuration which is referenced in FIG. 21 as IMC (and the associated SCR1 layer module being referenced as SCR1-IMC (with the modules representing that layer each preferably having the featured IMC (although alternate embodiments include a mix of IM types as in IMB for some regions and IMC (or any mix of the described IMs herein) in other regions when the environment and flow characteristics result in such a mix being beneficial)).

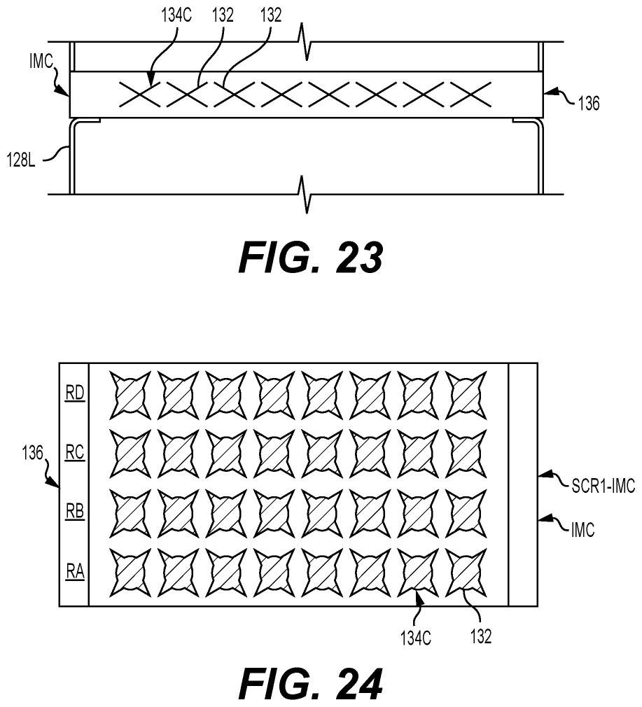

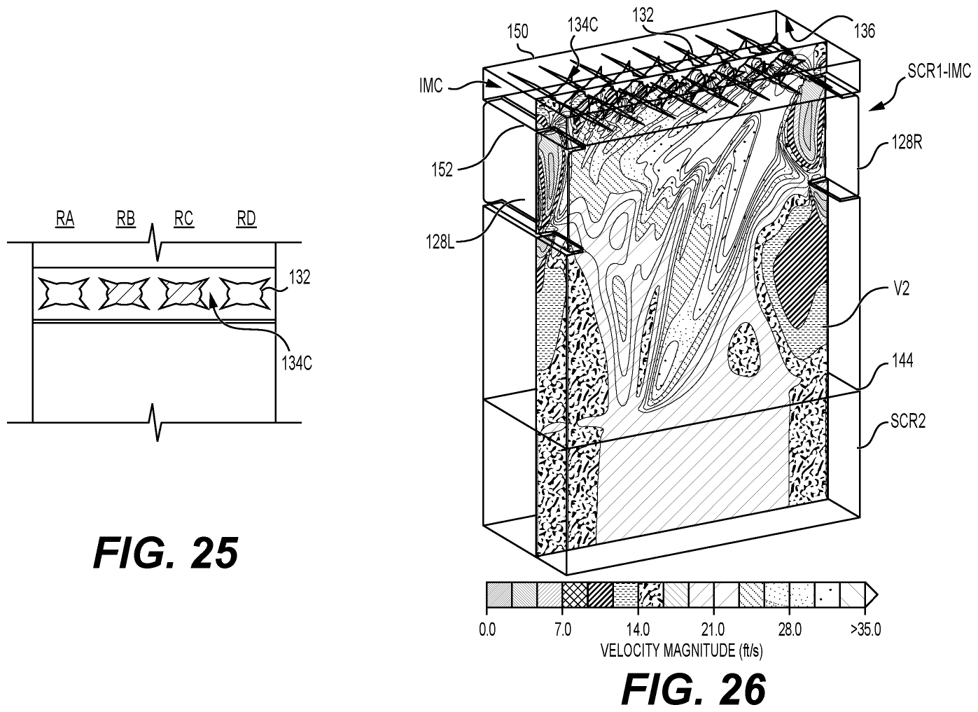

FIG. 22 shows a breakaway perspective view as to the region surrounding IMC in FIG. 21. FIG. 23 shows the same region, but in an elevational view facing the long side of the IMC frame structure 136. As seen from FIGS. 22 and 23, the intermixer IMC has a different array pattern 134C comprised of the same number and configured star shaped bluff bodies 132 as featured in FIG. 7 (i.e., this embodiment has the same star shaped plating). The pattern 134C of the bluff bodies is, however, different for reactor structure 126C. The pattern configuration 134C of IMC includes (relative to rows RA to RD) a {right (+)/left (−)/left/right} orientation, respectively; and, for this version of the invention, a common angle value for each, which in this case is 60°. Thus, for pattern 134C, each bluff body has the same plating configuration as described above and the same mount rod support (not shown in FIGS. 22 and 23 for clearer plate 132 illustration). Array 134C, however, features inward rows RB and RC having the noted common (side-by-side) orientation and thus are presented as two adjacent darker (−) shade blade sets 132 in FIG. 25 to show the common orientation nature, while the two outer rows RA and RD have lighter shading for plates 132 to show a different orientation for that outer set as compared to the interior plate rows in pattern 134C. This different orientation results in the “X” (certain rows with opposite orientation leading to a cross-depiction when viewed through a “transparent” long side of the IMC frame structure) as depicted in FIG. 23 for plates 132 in array 134C.

The IMC arrangement shown in perspective in FIG. 22 is shown in plan view in FIG. 24 (again schematically with the supports rods removed for added clarity as to the star shaped plates' spacing, etc.) and in end view in FIG. 25 (with the “transparent” frame structure view as well). The general dimensioning (e.g., spacing of plates and configuration of the frame and encasement, etc.) can be the same as that described above for IMA and IMB.

With reference to FIG. 26 there is seen a perspective view of the reference modeling set up for illustration of results by the same CFD program as described above but run relative to a reactor system having the SCR1-IMC configuration described above That is, star shaped bluff bodies 132 are arranged in a {right/left/left/right} orientation with all at an angle of 60°. In similar fashion to the above-described FIG. 18, the presentation in FIG. 26 focuses on the pertinent region relative to intermixing of the exhaust gas upon reaching the upstream inlet plane or interface border 150 which also constitutes essentially the exiting plane of the SCR1 module block(s) (not shown in FIG. 26). For the flow pattern presentation generated by the CFD program there is featured different velocity magnitude representations which correspond, respectively, with the common indicia depictions along the velocity magnitude (ft/s) key provided at the bottom region of FIG. 26. The vertical cross-section split location in FIG. 26 is preferably the same as that described above such that row RB is bisected (one of the (−) rows).

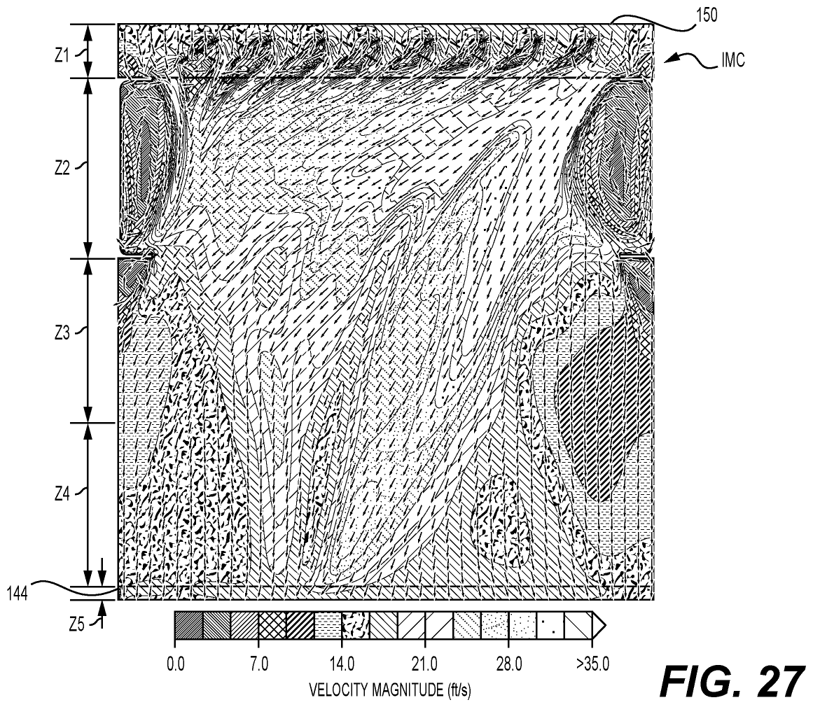

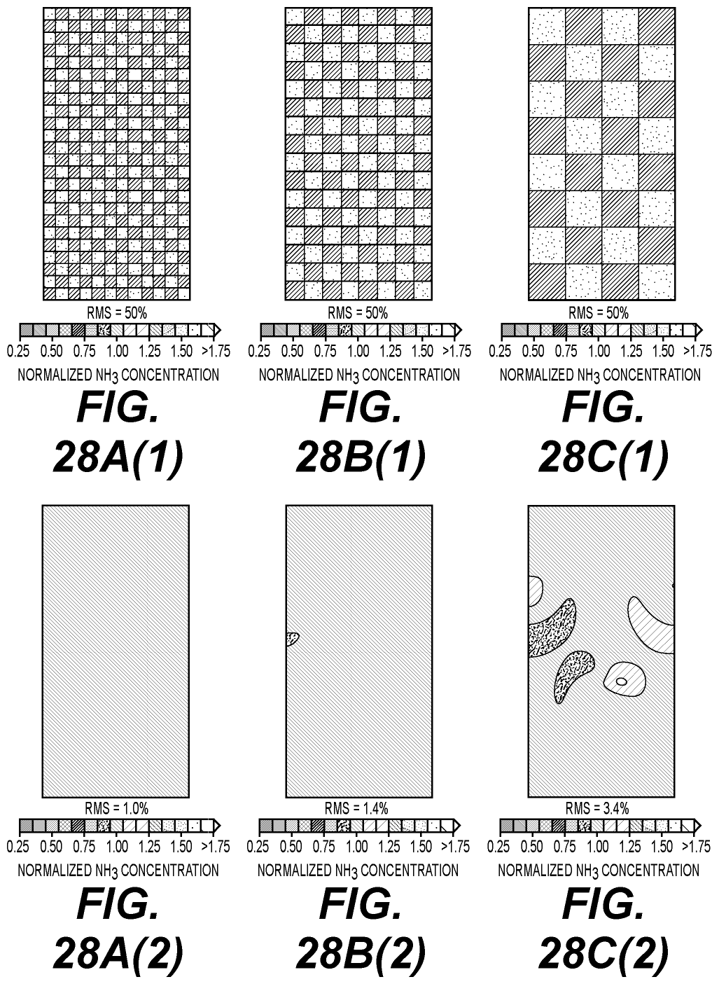

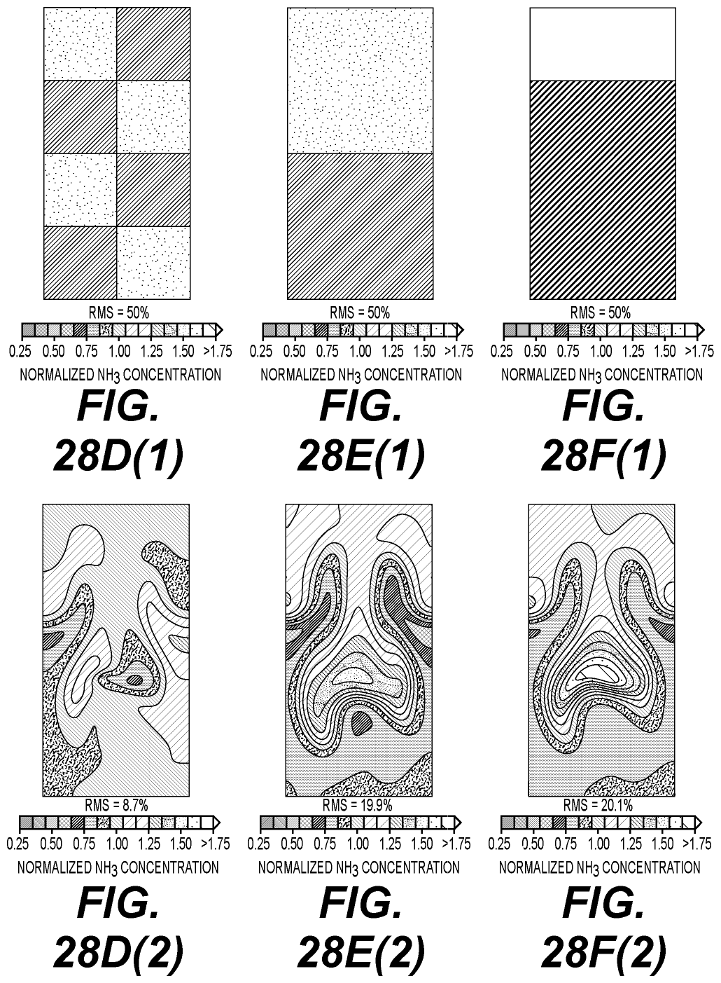

In FIG. 27 there can be seen the same earlier described reference zones Z1 to Z5. Zone Z1 is representative of the exhaust flow velocity pattern computed with the CFD software as it travels through the IMC. Upon contact with the bluff body array 134C there can be seen the development of the bluff body slow velocity sub-zones with turbulence that are located directly under the bluff bodies and in an extension direction in general alignment with the angle of the bluff body. Within zone 1 there can also be seen the increased velocity regions associated with the end gaps (inward flange extension and last in line adjacent plate gap) as well as those that develop in-between or to the opposite sides of each bluff body in the array. This is depicted with the faster velocity value indicia between the bluff bodies. As the cross-sectional location for the simulation cuts through the middle plate set RB there can be seen a right-to-left predominance in the jetting coming below the IMC which conforms with the (−) orientation of those middle rows. Although not shown in the single vertical cross-section shown in FIG. 27 a similar jetting velocity would be applicable to each side on rows RA and RD but the direction would be left-to-right in accord with the (+) orientation of the plates in those outer rows. This provides good intermixing without too much back pressure introduction. For example, the back pressure that results relative to the array 134C is 0.05 IWC (as compared to 0.06 IWC for 134B), although each of these back pressure values are considered low, particularly in view of the improvement in intermixing suggested by the simulated flow patterns.

A review of the different velocity magnitude regions (as shown by the key indicia presented to match the CFD determined flow patterns) shows a good resultant intermingling of flows with an essentially common moderate velocity magnitude entering the SCR2 at the cross-section location which is considered generally applicable across the whole inlet region of the SCR2 based on the equal number of orientations and the common angles for all plates (at the interface plane 144 representing the catalyst block 2 inlet surface).

A comparison to the flow pattern in FIG. 19 to FIG. 27 shows greater symmetry relative to the slower regions (referenced by the slower velocity indicia on each short side wall longitudinal length) in array 134C as compared to the less symmetric pattern generated by the all-common orientation plate configuration of array 134B. This is considered to carry over into improved NNC results as described below for the CFD simulations illustrated in the FIG. 28 set.

Like the FIG. 20 set, the FIG. 28 set is provided to help further illustrate the ability of the IM to improve mixing characteristics in, for instance, a reducing reagent/combustion gas (component) flow mix, as in an NH₃/NOₓ mix. The CFD program carried out for the FIG. 20 set was repeated but with a simulation of the IMC's array 134C. Thus, the various simulation inputs featured in the FIG. 28 set are set up to show, in combination, a comparison of the inlet and outlet NH₃ profiles for the array 134C in FIG. 26, but with each having a different ammonia level pattern or value as demarcated by the different level indicia presented in the “Normalized NH₃ Concentration” or “NNC” key associated with the FIG. 28 set.

As with the FIG. 20 set, the FIG. 28 upper “(1)” set shows simulated various NH₃ profiles across the inlet end of the IMC (or outlet surface of the SCR1 catalyst block at that common interface plane 150). The simulated regions at this upper (“1”) location are each set up with a 50% RMS value at the inlet of the IMC, but with that 50% RMS achieved in each case in a different manner via sub-zone variations and/or high/low value alterations. The FIG. 28 lower “(2)” set shows the CFD NNC profile determination at the planar interface 144 which represents the RMS nature of the mix reaching the inlet end of the SCR2 for treatment.

Since the FIG. 28 set parameters were the same as that for FIG. 20, reference is made to the discussion above as to the various nature of the sub-zones and associated NNC concentration parameters, etc., which CFD simulation parameters are applicable here as well. Provided below in TABLE 2 is a results table similar in fashion to that featured above for the FIG. 20 set arrangements, but for the FIG. 28 set.

TABLE 2
IMC performance

| FIG. 28 | A | B | C | D | E | F |
|---|---|---|---|---|---|---|
| Pattern | Fine | Less Fine | Moderate | Large | Full | Full 25/75 w/more |
| | Check | Check | Check | Check | 50/50 | diverse NNC |
| RMS (1) | 50% | 50% | 50% | 50% | 50% | 50% |
| RMS (2) | 1.0% | 1.4% | 3.4% | 8.7% | 19.9% | 20.1% |

A comparison of results Table 1 (IMB) and Table 2 (IMC) show that the patterns and RMS(1) input are the same but the intermixer is modified from IMB to IMC (with IMB featured in the FIG. 20 set and IMC in the FIG. 28 set). As to the results in the RMS(2) row in Table 2 as compared to Table 1 there is maintained a common 1.0% for the finest checkerboard of FIG. 28A, improvements of 0.1% (e.g., 1.5% to 1.4%) and 0.2% (3.6% to 3.4%), respectively, for the less fine and moderate checkerboard patterns of FIGS. 20B and 20C, and a significant drop for the large check pattern from 11.2 down to 8.7% driven by the array redesign from array 134B to 134C. The drop in RMS percentage, however, is even more pronounced for the NNC patterns featured in rows E and F in Table 1 and 2 above. A drop from 37% down to 19.9% for RMS(2) is achieved for simulation row E, and a drop from 29.7% to 20.1% is achieved for simulation row F in the tables above. This illustrates that the IM arrangement under the present invention can achieve high RMS reduction levels and is also highly adaptable to suit different input parameters that may be faced in the arrangement of the plant for which pollutants are being removed. Also, the use of a mix of orientations (plus/minus) is deemed to help in the quicker reduction relative to the more extreme inputs as evidence by the even larger drop in IMC as compared to IMB with the former having a mixed orientation array (plus and minus) and the latter a non-mixed (all plus) orientation array.

Reference is now made to FIGS. 29-35 and the FIG. 36 set featuring SCR reactor 126D which generally corresponds with each of the SCR reactor 126B and SCR reactor 126C embodiments (represented in figure sets of FIGS. 19-20 and FIGS. 21-28) discussed above. In view of the general correspondence noted, the common components and attributes amongst the noted SCR reactors are not repeated. Rather the focus is on the differentiating IM nature wherein FIGS. 13-19 feature the IMB for its module(s), FIGS. 21-27 are directed at IMC and FIGS. 29-31 describe a different IMD for use in the SCR reactor 126D having a combination SCR1-IMD described as follows.

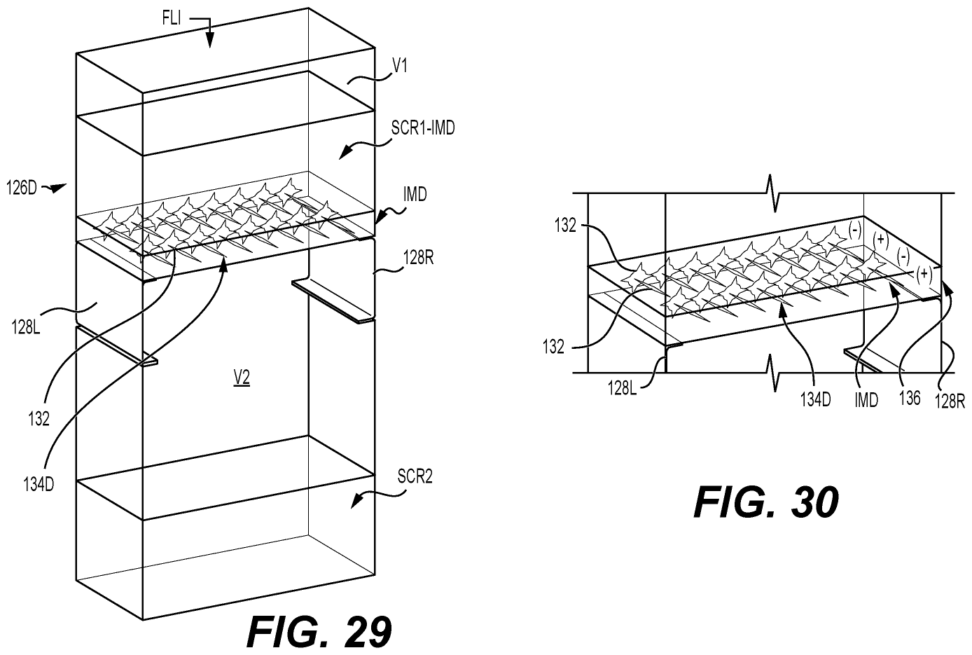

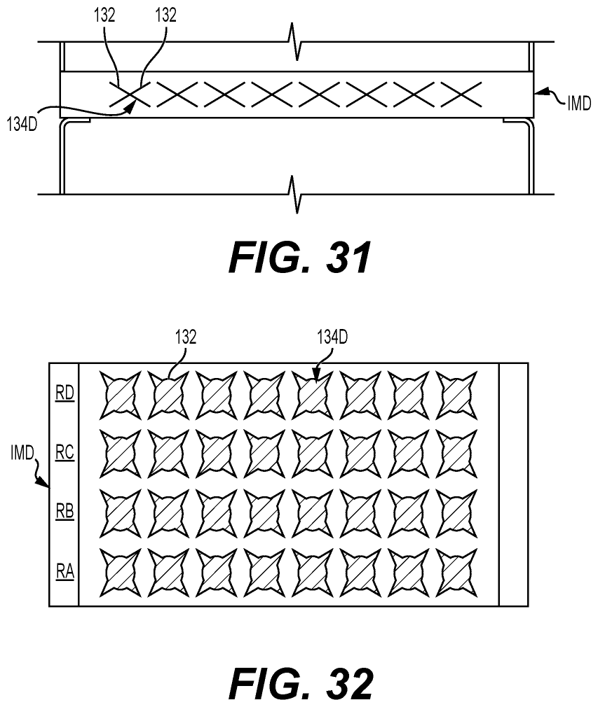

FIG. 30 shows a breakaway perspective view as to the region surrounding IMD in FIG. 29. FIG. 31 shows the same region, but in an elevational view facing the long side of the IMD frame structure 136. As seen from FIGS. 30 and 31, the intermixer IMD has a different array pattern 134D, which in the illustrated embodiment is comprised of the same number and star shaped bluff bodies 132 as featured in FIG. 7 (i.e., this embodiment has the same star shaped plating as described earlier). It is however noted that relative to the shaped plate bluff body arrays described herein, alternate embodiments include different plate designs such as rectangular plating, with all the different plating configurations preferably being arranged in a suitable one of the respective array configurations described in the present application).

As seen from FIG. 30, the pattern for array 134D is different for SCR reactor structure 126D than that for the other described array patterns. The pattern configuration for array 134D in IMD includes (with respect to rows RA to RD in sequence) a {right (+)/left (−)/right/left} orientation; and, for this version of the invention, a common angle value for each, which in this case is 60°. In the pattern for array 134D, each bluff body 132 preferably has the same “star shaped” bluff body plating configuration as described above and the same mount rod support (not shown in FIGS. 30 and 32 for clear plate 132 illustration).

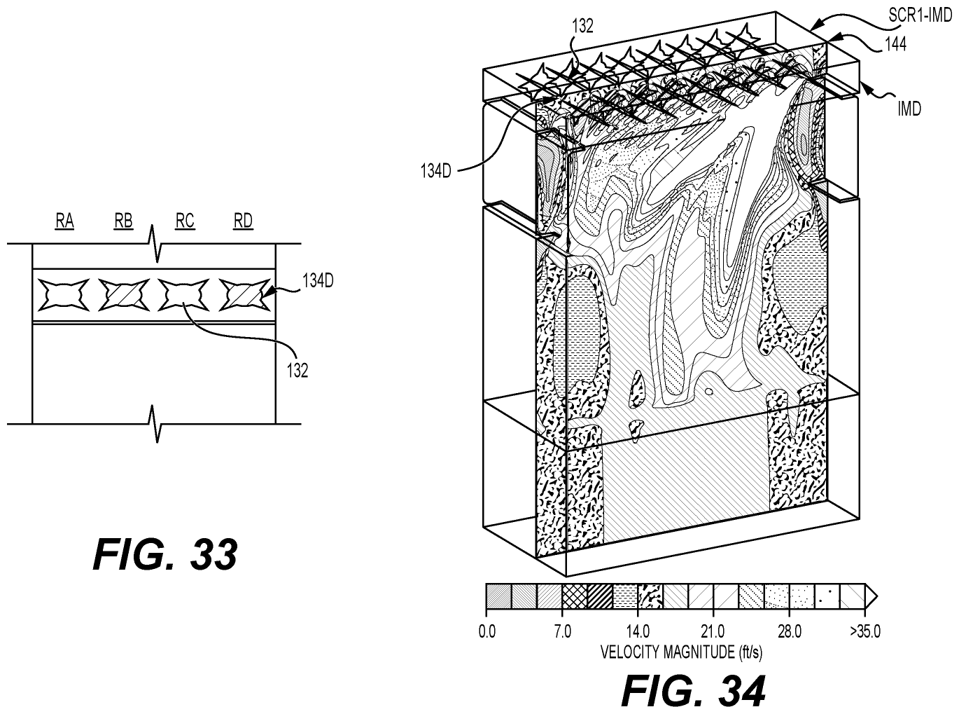

As represented above, array 134D has a different row sequence (common angle value) for its rows RA and RD with rows RA and RC shown tilted as to cause left-to-right through flow of the simulated flow input in FIG. 30; and rows RB and RD shown tilted as to cause a right-to-left through flow, and with each row having a 60° angle with the tilted (+) plates shown in lighter shading in FIG. 33 and the tilted (−) plates with the darker depiction in FIG. 33. As with the earlier embodiments featuring different orientation rows there results in the “X” (certain rows with opposite orientation leading to a cross-depiction when viewed through a “transparent” long side of the IMD frame structure) as depicted in FIG. 31 for plates 132 in array 134D. Also, as with the crisscross alternate orientation row sets in IMC there is a lower pressure loss (0.05 IWC for each of IMC and IMD compared to the “all same” orientation IMB having a 0.06 IWC pressure drop introduction).

The velocity flow pattern presentation shown in FIG. 34 is, like in the earlier embodiments, based on a vertical cut take at 125 mm from the centerline CL shown in an intermediate area of the peripheral frame structure 136 and extending parallel to the long side walls of that frame structure and through row RB. The simulated exhaust flow pattern in FIG. 34 is shown initiating at the noted planar interface 150, passing through the IMD itself, travelling through void V2, reaching the planar interface 144 (the border region between the end of void V2 and the initiation of SCR2), as well as a view of the mixed exhaust gas passing within SCR2.

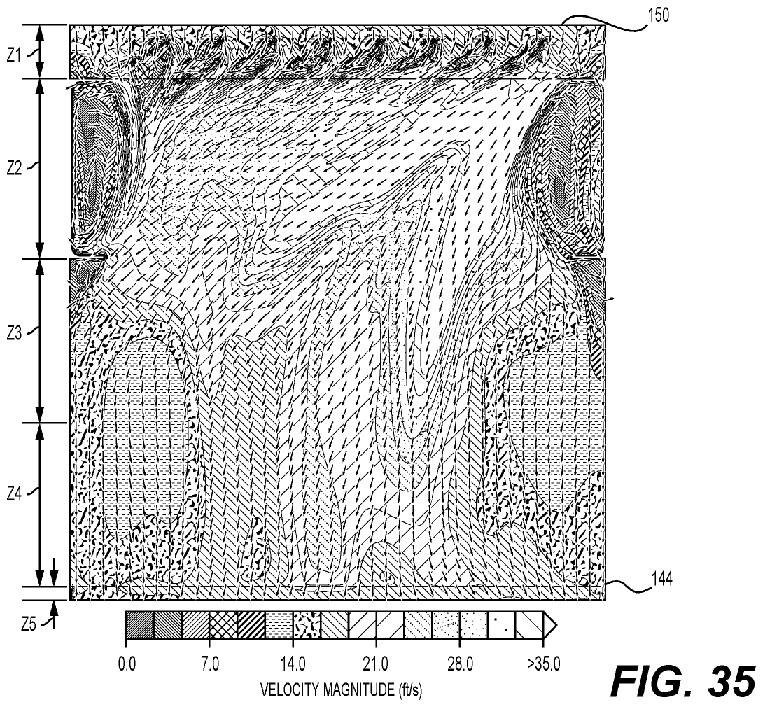

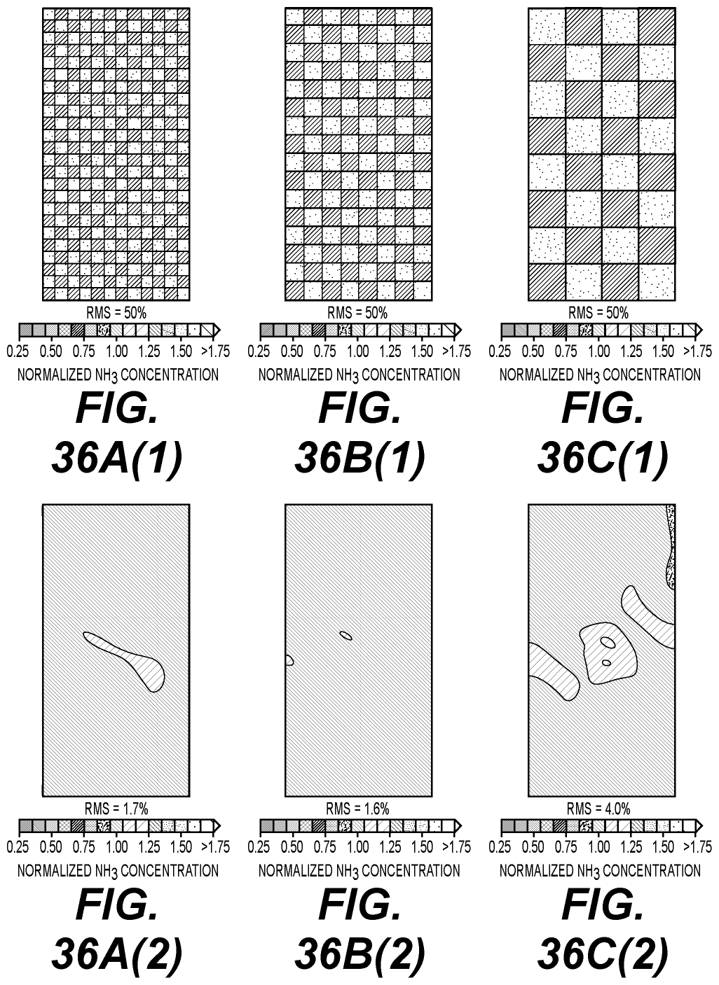

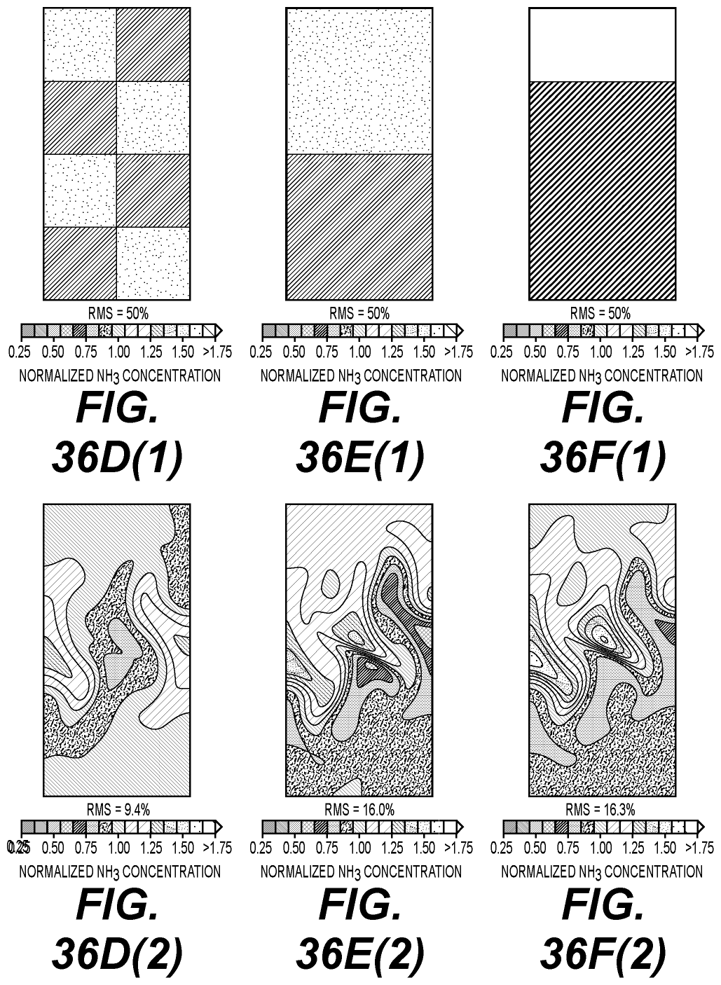

FIG. 35 presents an elevational view of that which is shown in FIG. 34, but with a focus only on the flow pattern (thus without a representation of the structure shown in FIG. 34 and with the flow pattern shown extending only between planes 150 and 144 with a slight extension into what would be the intake region of SCR2). In FIG. 35 there can be seen zones Z1 to Z5, with zone Z1 representative of the exhaust flow pattern computed with the CFD software as it travels through the IMD. The flow can be seen undergoing a series of transformations including receipt of an upstream flow (a simulation of partially mixed flow due to upstream injection of reduction reagent as in ammonia spray into an exhaust flow passing in the upstream region of SCR reactor zones with the standard RMS mal-distribution issues associated therewith) at the upstream plane 150 (start of IMD). Upon contact with the bluff body array 134D there can be seen the development of the bluff body slow velocity sub-zones directly under the bluff bodies and in general alignment with the angle of the bluff body. Within zone 1 there can also be seen the increased velocity regions that develop in-between or to the opposite sides of each bluff body in the array. Also there can be seen some similarities with the flow patterns featured in FIG. 27 as in the left and right slow flow zones extending about half-way down the short length side walls of the SCR reactor (only slightly into zone Z3) unlike IMB wherein the common orientation for all bluff bodies led to the much longer extension of the slower velocity flow rate into the lower part of zone Z4 (while the opposite side—the side toward which the orientation of the bluff bodies all directed the flow) had an extension similar to IMC and IMD (a region just into zone Z3). A comparison of the flow patterns in FIG. 27 (IMC) and FIG. 35 (IMD) shows a high velocity region from the right side extending in toward the middle in each (the cross-section orientation of that row directing the right to left toward middle flow pattern). However, that same comparison shows an earlier dissipation in flow velocity for the IMD as seen by the higher velocity indicia showing a high flow rate stoppage at about the Z3 and Z4 interface while the higher velocity indicia IMC extends nearly to the Z4 and Z5 interface. While not intending to be limited to any particular theory, it is believed that the side-by-side opposite orientation flow pattern (rather than the middle left-left adjacent orientations) helps in the quicker dissipation (oppositely directed side-by-side air flows helps in creating side-by-side air resistance) with the bluff bodies also creating a high amount of turbulence as due, for example, to the IM (in general) placement with its bluff bodies at the SCR1-IM downstream interface, without the creation of too much back pressure as can be seen by the common 0.05 IWC for each of IMC and IMD.

A review of the different velocity magnitude regions as shown by the key indicia presented to match the CFD determined flow patterns in FIG. 34 (which key applies as well to the enlarged, corresponding flow pattern depiction in FIG. 35) shows a good resultant intermingling of flows by IMD with an essentially common velocity magnitude entering the SCR2 at the cross-section location which is considered generally applicable across the whole inlet region of the SCR2 based on the equal number of orientations ((+) and (−)) and the common angles for all plates (at the interface plane 144 representing the SCR catalyst block 2 inlet surface).

This good resultant intermingling of velocity components is considered to carry over into improved NNC results as described below for the CFD simulations illustrated in the FIG. 36 set.

That is, like the FIG. 20 and FIG. 28 NNC depiction sets, the FIG. 36 NNC depiction set is provided to help further illustrate the ability of an IM to improve mixing characteristics in the reducing reagent/combustion gas (component) flow mix, as in an NH₃/NOₓ mix. The CFD program carried out for the FIG. 20 set was repeated but with a simulation of the IMD's array 134D. Thus, the various simulation inputs featured in the FIG. 36 set are set up to show, in combination, a comparison of the inlet and outlet NH₃ profiles for the array 134D in SCR reactor 126D, but with each having the same varying ammonia level pattern or value as demarcated by the different level indicia presented in the “Normalized NH₃ Concentration” or “NNC” key associated with the FIG. 36 set.

The FIG. 36 upper “(1)” set shows simulated regions across the inlet end of the IMD (or outlet surface of the SCR1 catalyst block at that common interface plane 150). The simulated regions at this upper (“1”) location are each set up with a 50% RMS value at the inlet of the IMD, but with that 50% RMS achieved in each case in a different manner. The FIG. 36 lower “(2)” set shows the CFD profile determination at the planar interface 144 which represents the RMS nature of the mix reaching the inlet end of the SCR2 for treatment.

Since the FIG. 36 set parameters were the same as that for FIG. sets 20 and 28, reference is made to the discussion above as to the various nature of the sub-zones and associated NNC concentration parameters, etc., which CFD simulation parameters are applicable here as well. Provided below in TABLE 3 is a results table similar in fashion to that featured above for the FIGS. 20 and 28 set arrangements, but for the FIG. 36 set's results.

TABLE 3
IMD performance

| FIG. 36 | A | B | C | D | E | F |
|---|---|---|---|---|---|---|
| Pattern | Fine | Less Fine | Moderate | Large | Full | Full 25/75 w/more |
| | Check | Check | Check | Check | 50/50 | diverse NNC |
| RMS (1) | 50% | 50% | 50% | 50% | 50% | 50% |
| RMS (2) | 1.7% | 1.6% | 4.0% | 9.4% | 16.0% | 16.3% |

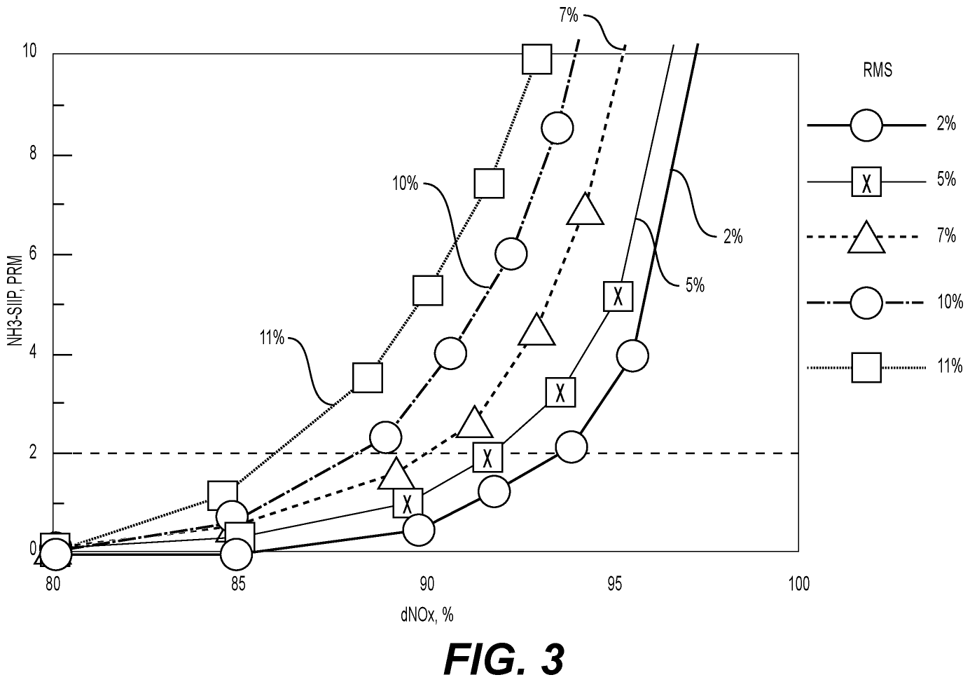

A comparison of results Table 1 (IMB) and Table 3 (IMD) reveals a slight uptick in RMS % for simulations A to C as seen by the following number comparisons for Table 1 and 3 [1.0:1.7% and 1.5:1.6% and 3.6:4.0%]. Thus, each of IMB and IMD is suitable for maintaining the RMS below 2% for simulation patters A to B and maintenance below 10% for simulations C and D (see FIG. 3 and how the NOₓ values can be more easily met with lowered RMS situations particularly at the lower value end as in the demarcated 2% RMS line in that figure). The simulation comparison between IMB and IMD shows generally relatively close RMS reduction values, but also shows that when the inflow has a finer checkerboard to moderate checkerboard pattern (lots of sub-zoning in place) a slight advantage falls with IMB over IMD.

The situation, however, flips when the sub-zoning amount is reduced in the inflow which can be attributed to many situations as in the varying nature of flow patterns across a large cross-sectioned ductwork and/or not having, for instance, a high precision reductant reagent introduction system, etc. leading to such a lower amount of relative sub-zoning. This flip in performance can be seen when comparing the IMB and IMD results relative to the less finely divided sub-zone patterns in D to F simulations, with the following comparison's facilitating that appreciation for Table 1: Table 3 values [11.2:9.4% and 37.0:16.0% and 29.7:16.3%]. The value of having the IMD pattern is thus seen as being particularly beneficial when, as can occur in many situations, the cross-sectional RMS sub-zoning is not that high in number. Also, while being worse in some respects (a relatively small jump up relative to IMB finer sub-zones) the level of reduction for the D to F is striking. The overall IMD performance, including the ability to achieve a relatively low across-the-board RMS set value (e.g., across the board below 17% RMS) makes IMD a more favorable intermixer in many environments as from the standpoint, for instance, of it providing a more universally workable SCR reactor that can provide relatively good performance under a large number of potential settings including some of the more egregious lack of good inflow pre-mixture of NOₓ and NH₃ environments (at least in some areas of flow cross-section within ductwork 116).

A comparison of results for Table 2 (IMC) and Table 3 (IMD) reveals a relatively low uptick in RMS % values in going from IMC to IMD relative to simulations A to D as seen by the following number comparisons for Tables 2 and 3 [1.0:1.7% and 1.4:1.6% and 3.4:4.0% and 8.7:9.4%]. The simulation comparison between IMC and IMD shows generally relatively close RMS reduction values relative to IMC and IMD for simulations A to D, but also shows that when the inflow has a finer checkerboard to moderate checkerboard pattern (lots of sub-zoning in place) a slight advantage falls with IMC over IMD. The situation, however, flips when the sub-zoning degree is reduced in the inflow. This flip in performance can be seen when comparing the IMC and IMD results relative to the less finely divided sub-zone patterns in the E to F simulations, with the following comparisons facilitating that appreciation (Table 2: Table 3 values) [19.4:16.0% and 20.1:16.3%]. While not as large a drop as there was in switching from IMB to IMD, the drop from IMC to IMD is of a high value in that the IMD is again shown to be more universal in helping to meet lower RMS values for a wide variety of input situations.

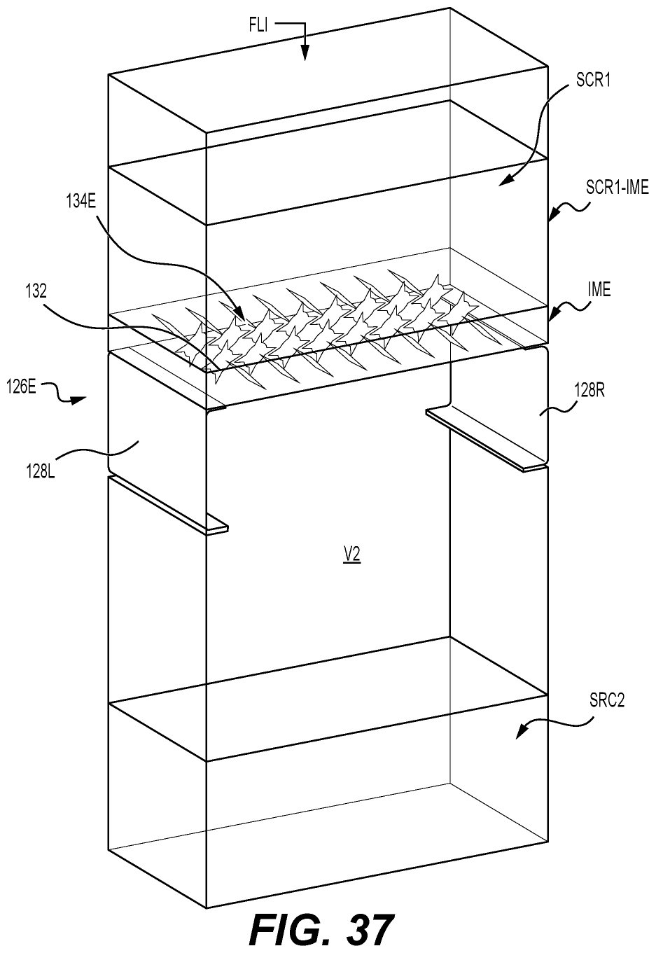

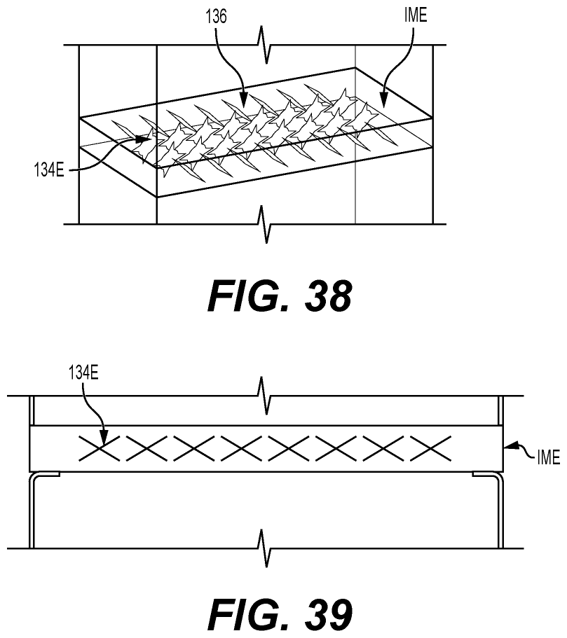

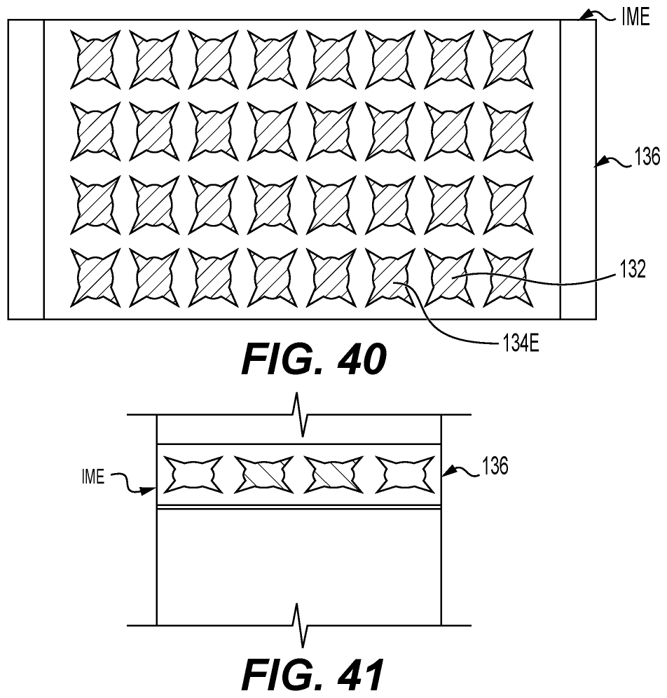

Some additional IM designs were also subjected to CFD modeling in similar fashion to the modeling parameters described above. In this regard, reference is made to FIGS. 37 to 43 and associated FIG. 44 set showing IME (and thus SCR1-IME) for SCR reactor structure 126E. As all attributes of intermixer IME is the same as that of IMC, including the nature of orientation of array 134E as compared to 134C and the usage of star shaped bluff bodies 132 as well as all the simulation set ups for the illustrated CFD modeling, only the one difference is discussed. Namely, rather than all bluff bodies 132 having a 60° angle as in the IMC, all bluff bodies 132 in the IME set have a 45° a angle. As such, the differences due to this different angle in the IME plates, as in the different CFD modeling results, is discussed.

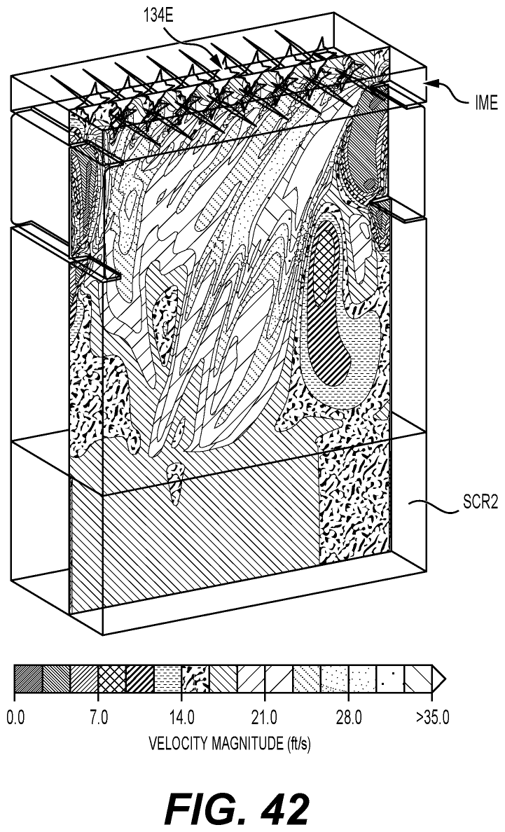

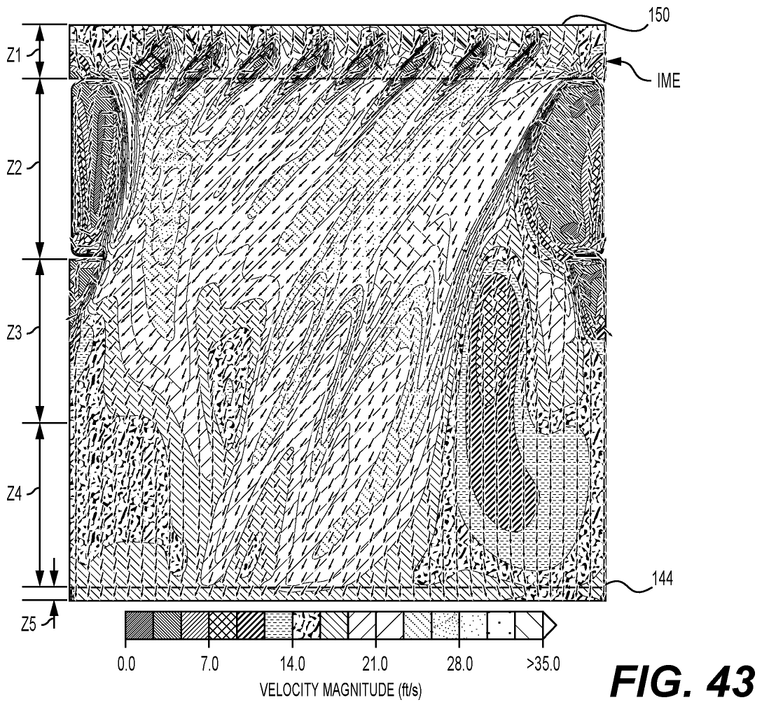

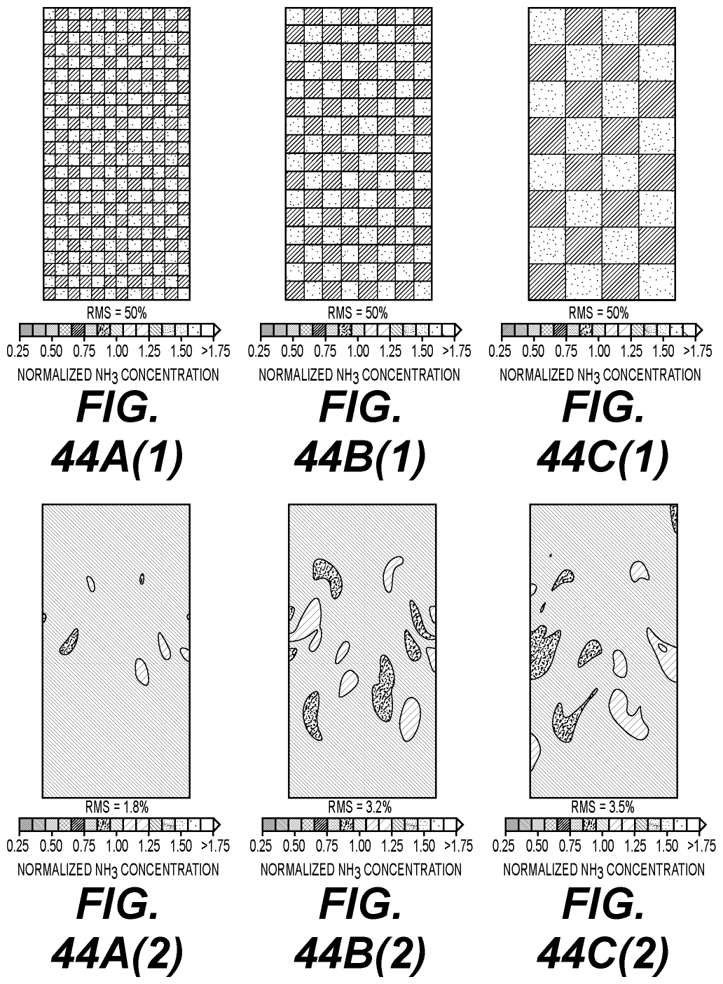

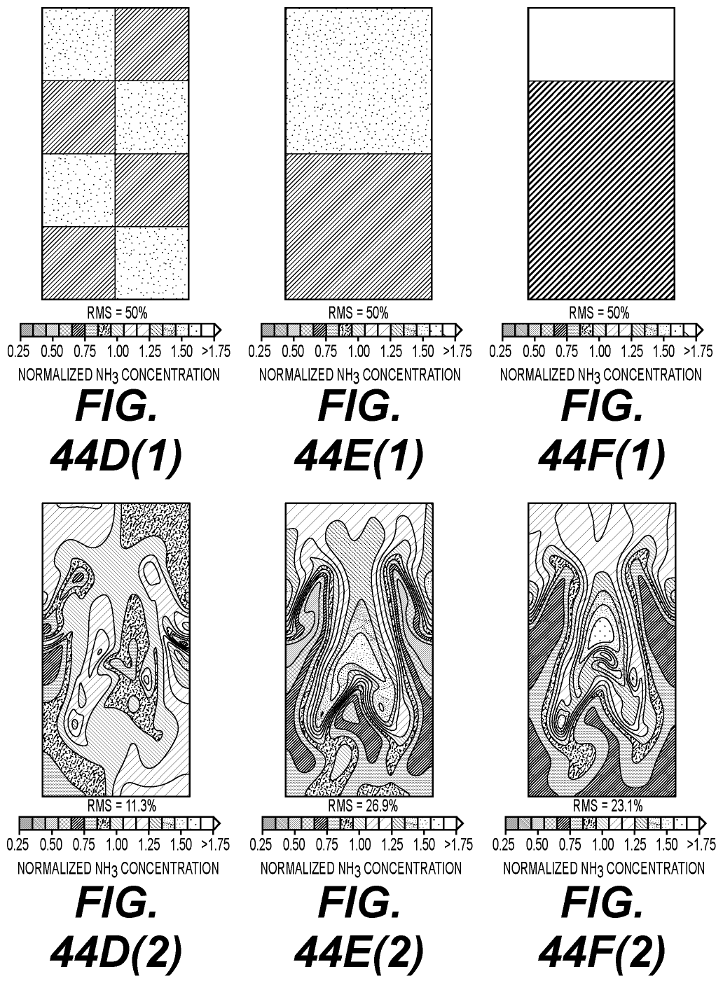

With reference to FIGS. 42 and 43 (showing the same cross-sectional velocity flow pattern modeling for the IME configuration as was carried out and represented in FIGS. 26 and 27) a discussion of the results for such modeling is provided. As seen from FIGS. 42 and 43 the level of velocity differential (the degree of highest velocity regions has dropped a bit due to the lowered bluff body angle; as has the degree of slow velocity and turbulence generation zones directly behind the bluff bodies). There is also a bit slower overall velocity zones on the right-side region as seen by the larger slow flow zoning adjacent the interior of 128R and extending through zones Z3 and Z4.

Table 4 below provides the NNC simulation results based on the same “checkerboard” etc. patterning as described above for the NNC simulations for IMB to IMD.

TABLE 4
IME performance

| FIG. 44 | A | B | C | D | E | F |
|---|---|---|---|---|---|---|
| Pattern | Fine | Less Fine | Moderate | Large | Full | Full 25/75 w/more |
| | Check | Check | Check | Check | 50/50 | diverse NNC |
| RMS (1) | 50% | 50% | 50% | 50% | 50% | 50% |
| RMS (2) | 1.8% | 3.2% | 3.5% | 11.3% | 26.9% | 23.1% |

The IME performance, while providing an improvement on lowering the RMS values between the planes 150 and 144 does not represent as good a performance as compared, for example, to IMC and IMD. Accordingly, under the environment simulated for SCR reactors 126C and 126D there can be seen a 60° array angle provides improved results over a 45° array angle even when the orientation of the same star shaped plates is one in the same. However, the relatively slower flow zones for the IME compared to the higher angled IMC can be advantageous under different environments as in different flow rates reaching the IM. Also, the ability to decrease rapidly the RMS value in the simulated region between IM output and SCR2 intake in IME, is considered a similar benefit as that featured in the other IMs such as IM, IMA, IMB, IMC and IMD as all provide a significant reduction under the simulated NNC patterns.

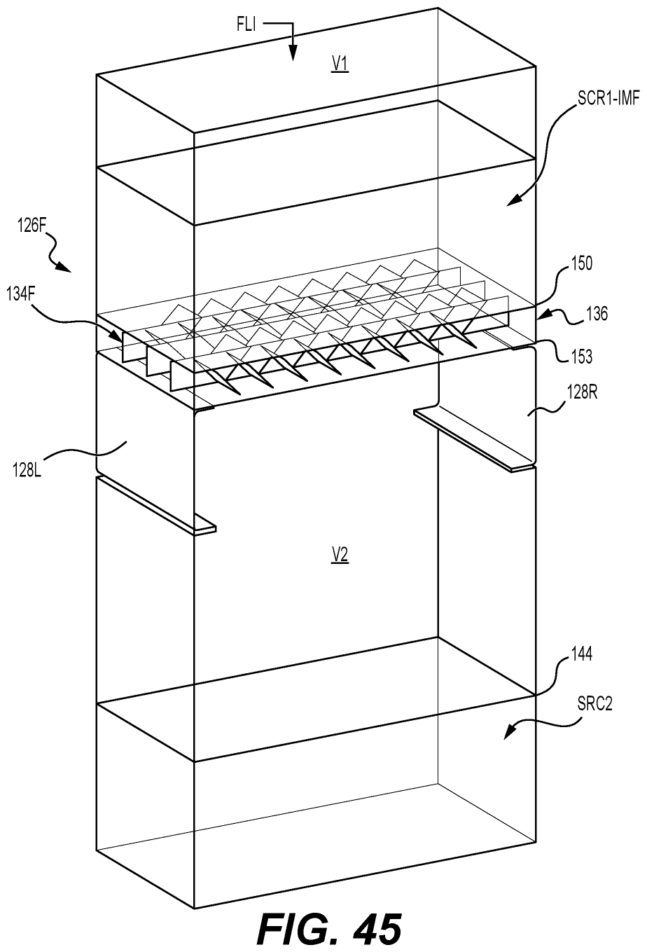

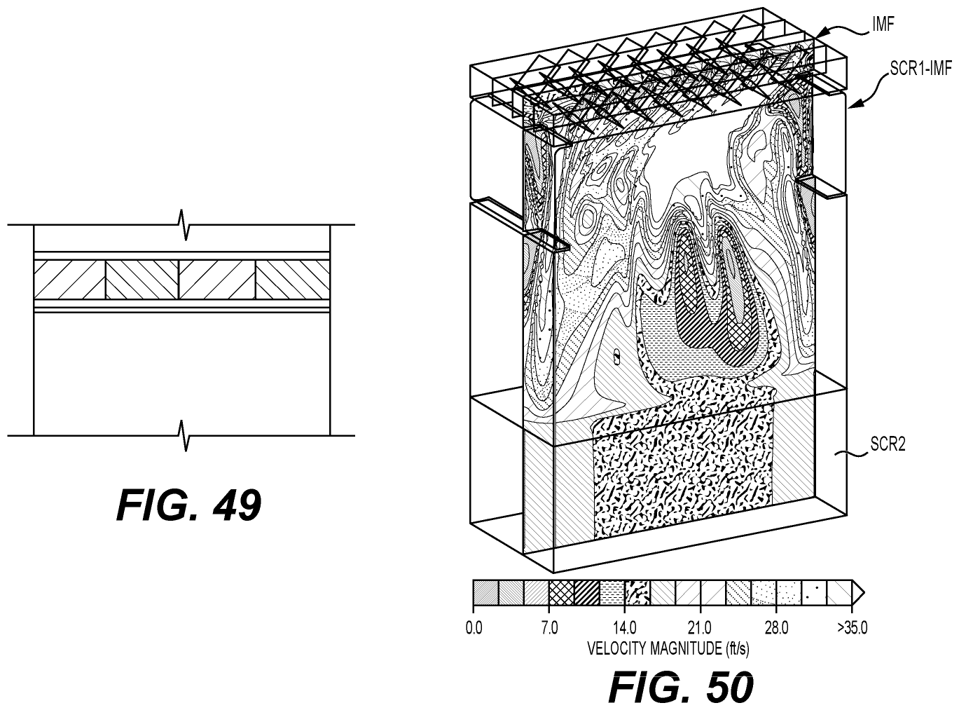

FIGS. 45 to 51 illustrate an additional embodiment of the present invention featuring IMF. Unlike the previously described star shaped plates as the bluff bodies, IMF features more simply configured rectangular plates. The sizing of such plates can be adjusted to suit the system requirements and sizing can be fine-tuned with CDF simulations with sizing such as featured from the outer extremities of the star shaped bluff bodies illustrative (e.g., 200 mm square rectangles or +/−100 mm relative to that square sizing as in 100 mm by 300 mm). While not shown in FIGS. 45 to 51, IMF further preferably features, like in the embodiments above, bluff body support bars extending along parallel to the longer side walls of frame 136 and through the center of the bluff bodies (with longer non-square rectangle lengths more horizontal (or vertical if system requirements are enhanced)) to support them at the preset angle. IMF additionally features a plurality of elongated (rectangular and generally flat with vertical plane arrangement) divider plates 142F. Each of the divider plates 142F extend across the frame structure at the plane defining the IM location (IMF—in this instance).

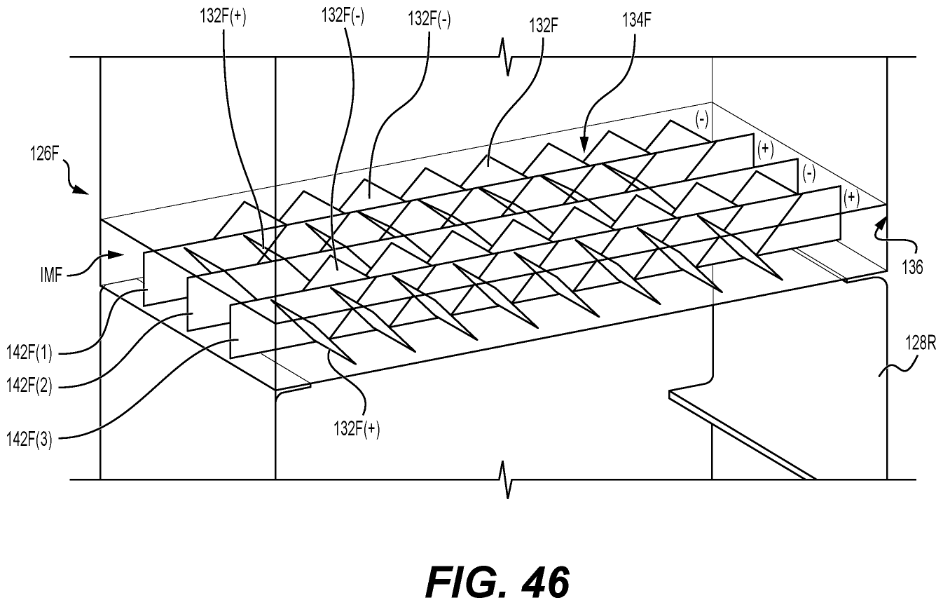

FIG. 45 illustrates SCR reactor 126F which has the same set up as the previously described SCR reactors (e.g., 126D) but has the modified IMF noted above. Thus, intermixer IMF has the same peripheral frame structure 136 as the previously described SCR reactors, but a different bluff body array structure 134F. With reference to the view of array structure 134F in FIG. 46, there can be seen three intermediately positioned elongated divider walls 142F(1); 142F(2) and 142F(3) extending within the confines of frame structure 136 and having a lower edge resting on the inward extending upper flanges 153L and 153R of the supports 128L and 128R. The upper edges of the divider walls 142 have a height at or below the upper edging of the peripheral frame portion 136 and have opposite ends adjacent or in contact with the interior surfaces of short walls shown for frame 136 (hence the reference to “within the confines”).

The bluff bodies 132F that are positioned within the central two rows (RB and RC) are shown as extending between adjacent support plates 142F(1); 142F(2) and 142F(3), while the bluff bodies 132F in the outer rows RA and RD extend between the interior frame wall's surfaces (along the long lengths of that frame 136) and the closest support plates 142F(1) and 142F(3). Also, as can be seen from the various array designs described above, a variety of different patterns can be implemented under the invention to suit the circumstances. For the illustrated embodiment of FIG. 46 there is featured an orientation sequence of {right (+)/left (−)/right/left} for rows RA/RB/RC/RD with the divider plates added as well for flow directing.

Also, (as with all IMs) different value angles can be implemented (both from a standpoint of all having a desired angle or a mix of different angles as in having some rows at one angle and other rows at a different angle such as outer rows being more or less angled relative to the angle of inner rows as when a higher velocity on the long sides adjacent to the frame walls as compared to the more central or interior space of that frame). The embodiment depicted in FIG. 46 has all plates having an angle of 45°.

As seen from FIGS. 46 and 48 the bluff bodies are positioned as to be staggered in closeness relative to respective short side walls of frame 136. As seen in the plan view of FIG. 48, there is a bluff body in each of rows RA and RC positioned closer to side wall 140A than the closest bluff body to the same side wall in rows RB and RD. At the opposite end, it is the bluff body in each of rows RB and RD that is closest to side wall 140B. Hence there is an added gap spacing in rows RB and RD adjacent side wall 140A and an added gap spacing in rows RA and RC relative to the closest side wall 140B.

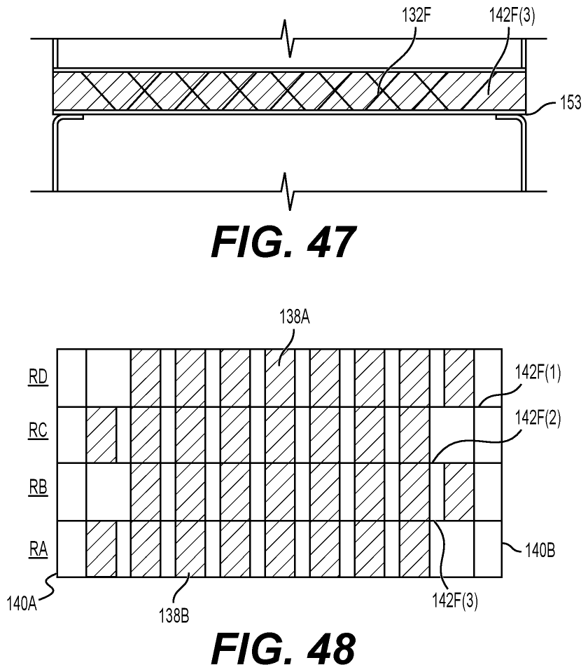

There can be seen in FIG. 47 (representing a similar long side elevational view for IMF) there is a crisscross presentation relative to the differently oriented bluff bodies in the non-cutaway rows. There can be seen the gaps positioned left of the adjacent left most one of the last bluff body for rows RB and RD and gaps to the right of the adjacent right most bluff body in rows RA and RC in FIG. 48.

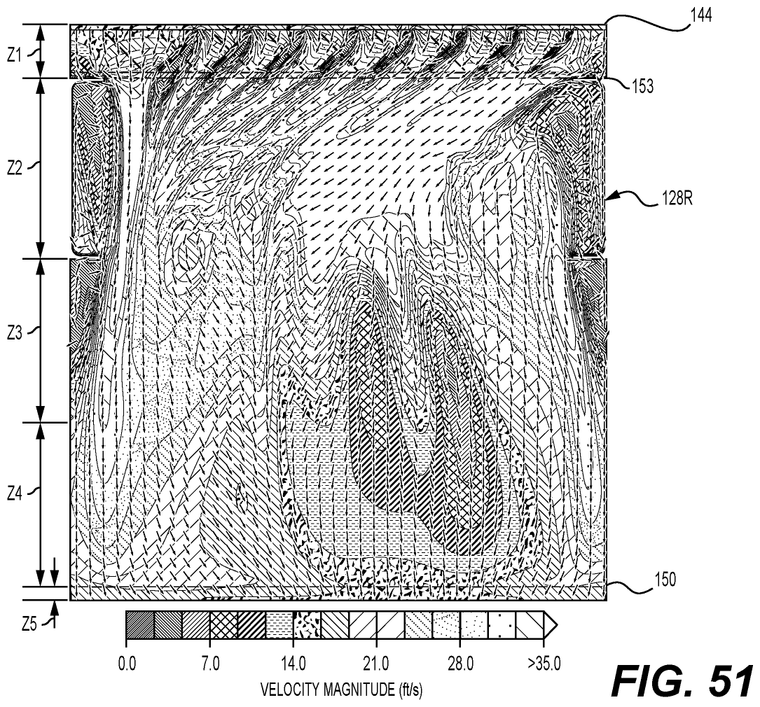

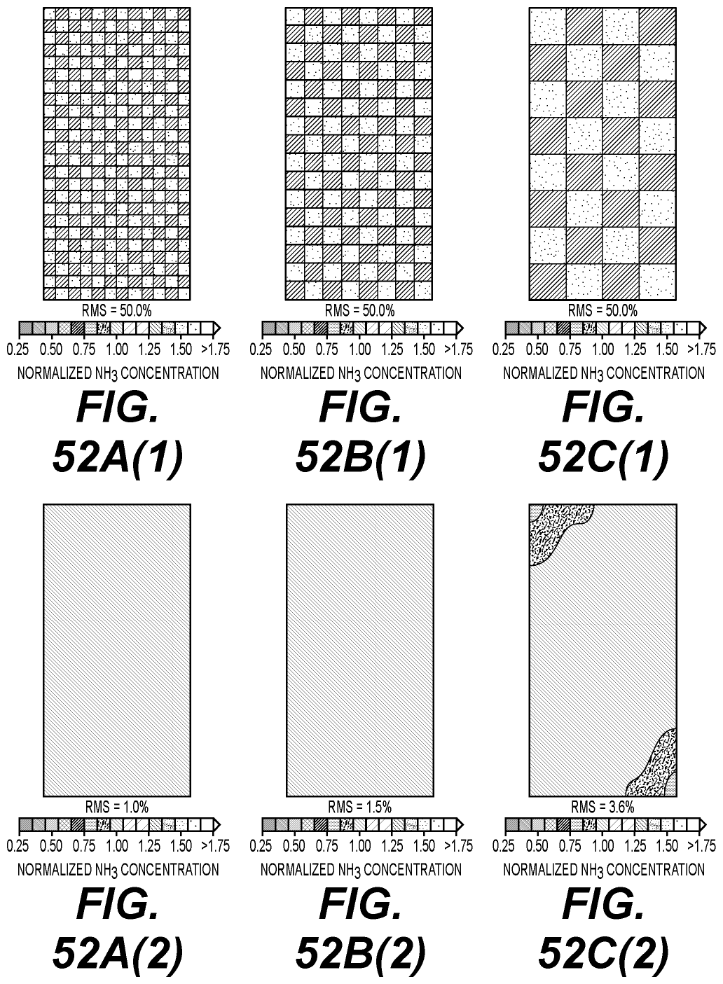

Similar CFD simulating (both cross-sectional velocity magnitude (ft/s) as well as normalized NH₃ concentration (NNC) simulations at the SCR1 block (of the SCR1-IMF combination) between the outlet of SCR1 at plane 150 and the SCR2 inlet surface at plane 144 were undertaken relative to IMF. FIGS. 50 and 51 show the noted cross-sectional velocity magnitude taken at the same locations as that earlier described as along row RB.

In the velocity magnitude flow simulation shown in FIG. 50 and in greater detail in FIG. 51 there can be seen that the aforementioned gap in row RB causes a higher velocity surge region therethrough, while the associated orientation of the bluff body plates lead to a slow region (high turbulence) shown below each plate as well as high flow velocity regions in a right to left direction (based on plate orientation) in between each of the plates. There is also seen that the common short side wall slow zones extend a bit further down toward the end of zone Z3 than some other flow pattern presentations. There is also a slow zone pocket at a central location in the transverse direction that extends nearly all the way through each of zones Z3 and Z4.

There can also be expected a similar opposite flow arrangement for adjacent rows RA and RC (having an opposite directed higher flow rates between the bluff body plates (left to right directed) as well as gaps closer to the end 140B of frame 136 (the latter not shown) as to complete the velocity flow pattern for IMF.

IMF, with its dividers, oppositely oriented bluff bodies {right (+)/left (−)/right/left} at 45° and noted end gaps results in a normalized NH₃ concentration flow patterns as depicted in FIG. set 52. FIG. set 52 has the same flow and RMS(1) at essentially 50% and checkerboard sub-zone arrangements as in the earlier described NNC flow simulations presentations.

Table 5 below shows the flow parameters in similar fashion to Table 1 to 4 presented above.

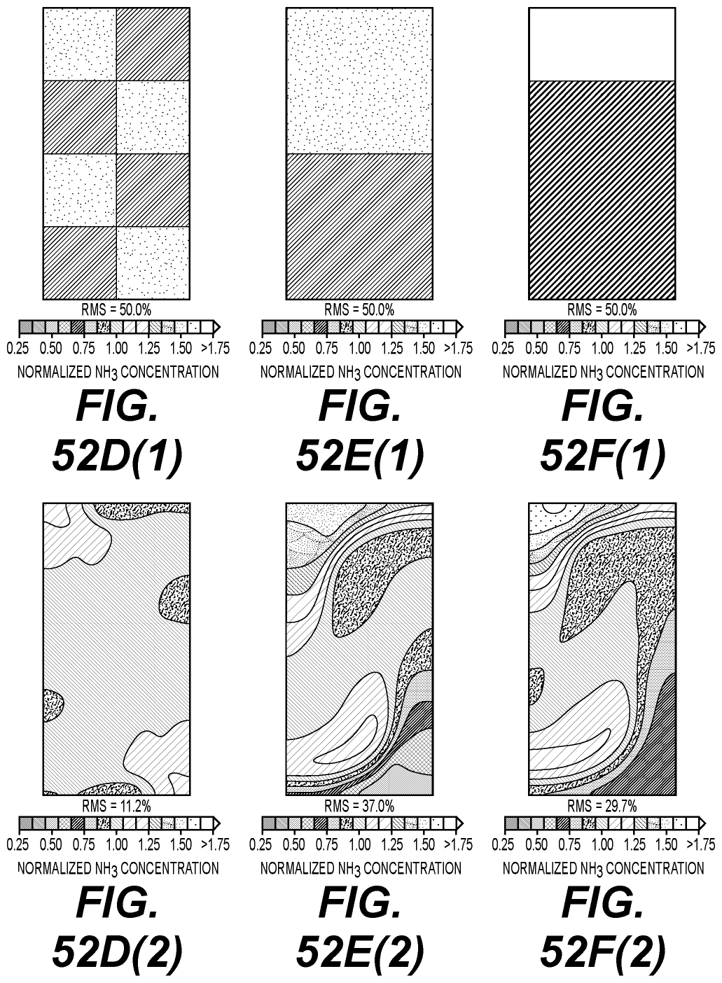

TABLE 5
IMF performance

| FIG. 52 | A | B | C | D | E | F |
|---|---|---|---|---|---|---|
| Pattern | Fine | Less Fine | Moderate | Large | Full | Full 25/75 w/more |
| | Check | Check | Check | Check | 50/50 | diverse NNC |
| RMS (1) | 50% | 49.9% | 50% | 50% | 50% | 50% |
| RMS(2) | 0.6% | 0.8% | 3.8% | 5.6% | 20.9% | 19.1% |

The results show SCR reactor 126F provides good performance particularly when the upstream set up relative to the mix is good (lots of well dispersed sub-zones versus few sub-zones, each with a respective high/low NH₃ gas concentration characteristic). When the sub-zones lessen such that the infeed is of limited diversity once hitting the IMF, there can be seen moderate results in that the results are better than some of the star mixer performances (e.g., IME) but poorer than that of the IMD as the zones become less sub-divided. Thus, IMF provides good results but is less universal relative to the inflow nature than the IMD. While for some situations this more universal nature is not of importance, if it means that a strict limit on a regulatory level will be violated under some input circumstances, the more universal approach elevates in importance if it can preclude such a situation across the board relative to the SCR system's operation or if can prevent the need for heavy catalyst loading and/or an added SCR layer each with an associated added backpressure component.

The backpressure associated with the IMF introduction into the system is 0.1 IWC. A comparison of the relative backpressure for the star mixer bluff bodies reveals that the combination of rectangular plates and dividers results in an increased backpressure relative to the earlier described IM's (e.g., 0.03%; 0.05% and 0.06%). Thus, the IMF introduces a somewhat relatively higher backpressure component which can introduce an added issue in some environments where a backpressure concern may already arise as due to system configurations but is considered generally low enough for many situations particularly in light of the improved intermixing of the components in the flow.

Due to the added open regions presented by the end gaps the open area percentage can be considered increased (the BA/BO ratio). However, use of the different (rectangular) plate configuration for the bluff bodies is considered to provide a generally greater blockage area (e.g., 200 mm×200 mm such) such that the area vs open area relationships (again under a plan view approach) is similar. If desired, however, via added gapping and/or larger or smaller area occupation plate bodies, the percentage of blockage versus open area can be adjusted to best suit the intended environment. For many environments, the blockage and open percentages (ratios of BA/BO) described above can be considered also suitable for the rectangular shaped plate bodies.

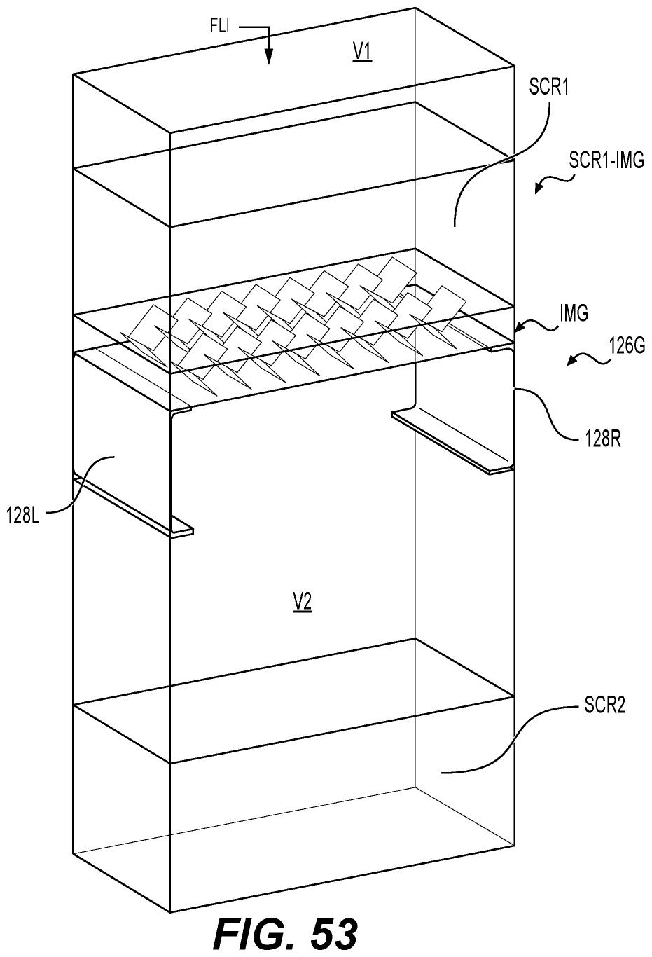

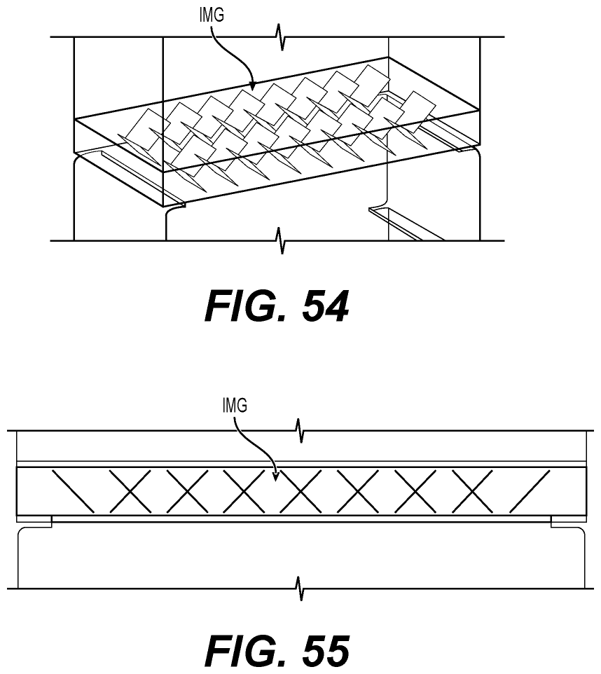

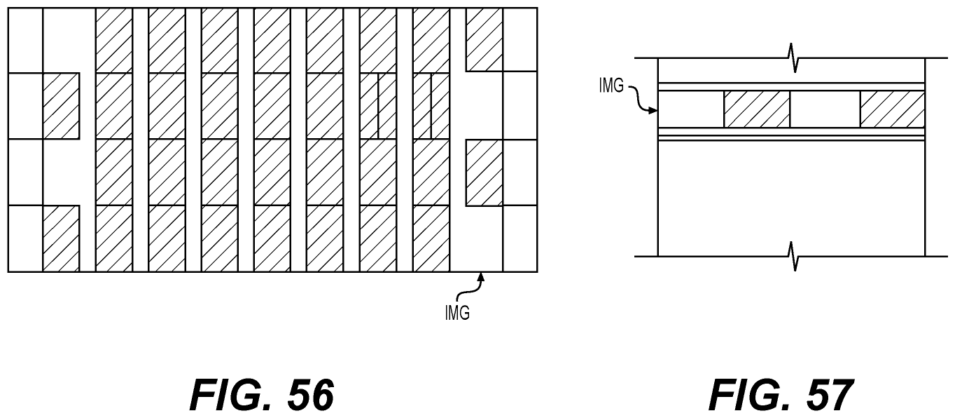

FIGS. 53 to 57 correspond with the earlier presented figure sets for the various IMs and thus a detailed discussion as to the corresponding features is not provided. A comparison with SCR reactor 126G with that of SCR reactor 126F reveals that the only difference between the two structurally is that the IMG for SCR reactor 126G is free of the divider walls 142F(1)-(3) present in IMF. That is, the rectangular plate configuration and array arrangement in IMG is the same as that in IMF (i.e., IMF and IMG feature a {right/left/right/left}−45° angle set up).

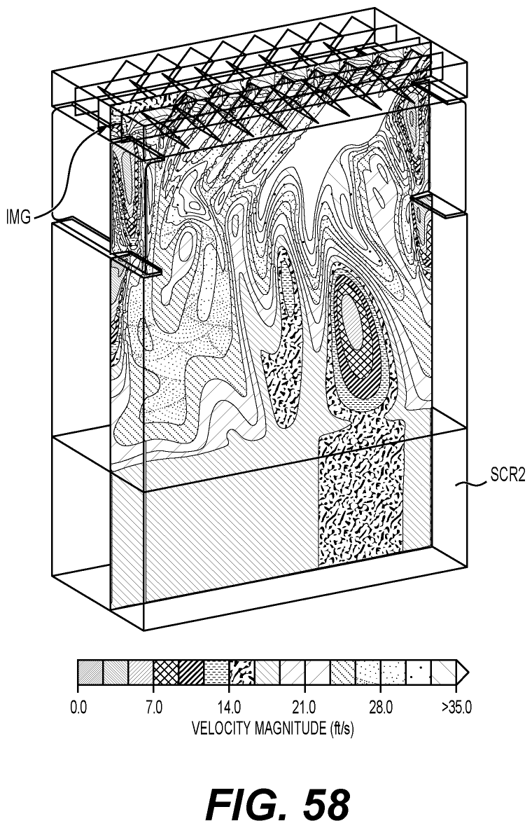

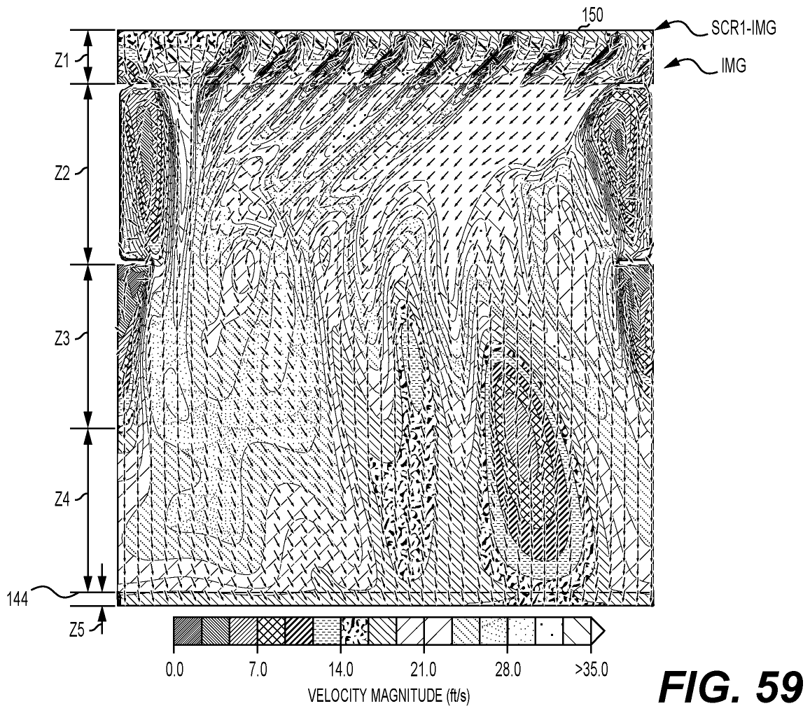

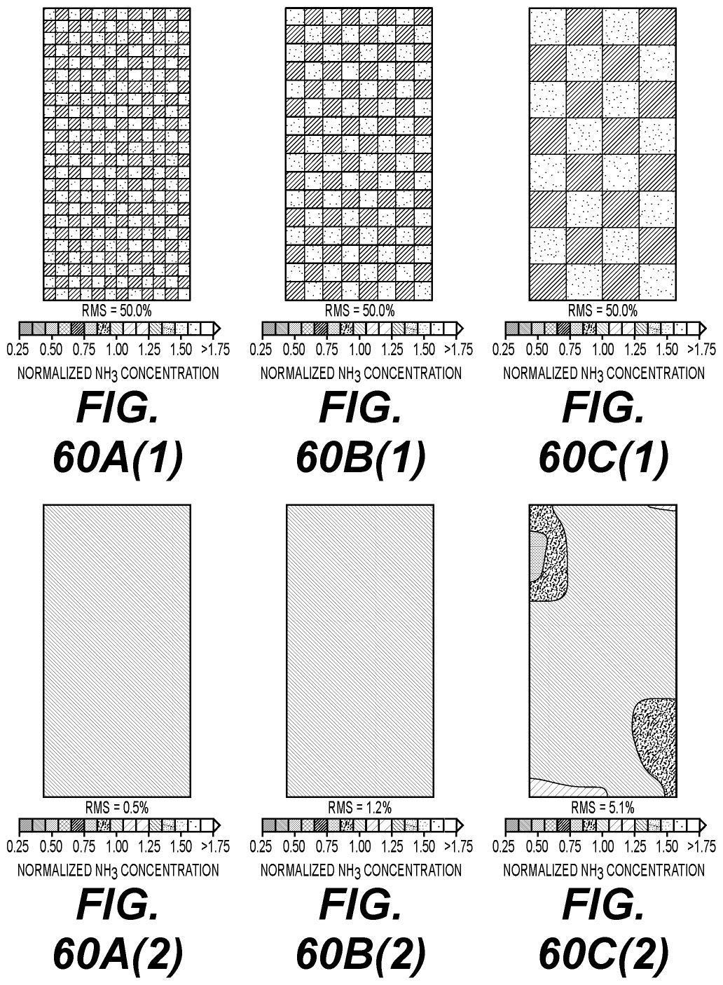

With that noted differential (no divider plates), a discussion of the flow patterns depicted in FIGS. 58 to 60 is provided. The velocity magnitude flow pattern featured in FIG. 58 and in greater detail in FIG. 59 shows some similarities with respect to IMF as may be expected with the common bluff body configuration and bluff body array patterns. The removal of the dividers can be seen in a comparison of the respective velocity flow patterns to introduce some differences. While the slower velocity regions behind the angled bluff bodies and the right-to-left high velocity regions are both present, the depth of the higher velocity between bluff bodies is slightly less than that of the IMF. Further, while there is a similar left side high velocity due to the relative spacing of the rows of rectangular bluff bodies it is not quite as intense or deep as the IMF, presumably due to the loss of the added channeling effect of the IMF dividers into the gaps. The NNC performance illustrated in FIG. set 60 is summarized in Table 6 below.

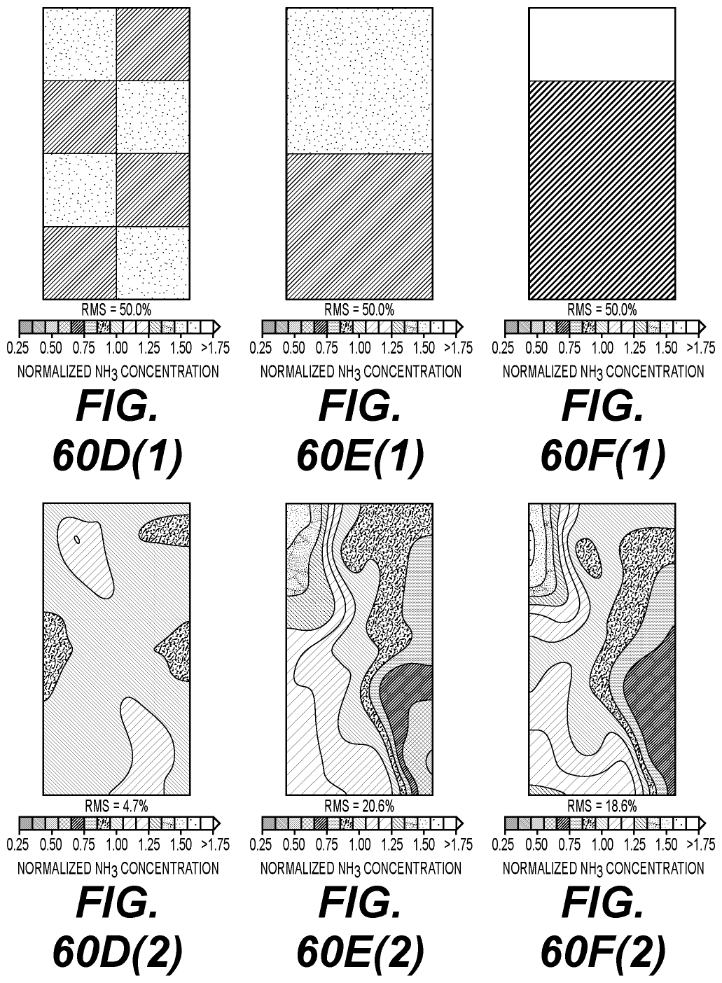

TABLE 6
IMG performance

| FIG. 60 | A | B | C | D | E | F |
|---|---|---|---|---|---|---|
| Pattern | Fine | Less Fine | Moderate | Large | Full | Full 25/75 w/ |
| | Check | Check | Check | Check | 50/50 | more diverse NNC |
| RMS (1) | 50% | 49.9% | 50% | 50% | 50% | 50% |
| RMS (2) | 0.5% | 1.2% | 5.1% | 4.7% | 20.6% | 18.6% |

A comparison of the IMG performance with IMF performance shows some minor improvement when the sub-dividing is limited as in rows D to F above which may be due to the added channeling effect of the dividers 142F making it more difficult to help disperse over the entire area, while on the other hand the inclusion of dividers works better in some instances when the sub-zone number is higher at the input (compare rows B and C of each).

The results of the simulation for the IMG show that IMD still works best at the higher extremes of lower sub-dividing as represented by rows E and F in the summary tables presented above. Also, while the pressure drop of 0.08% (IWC) for IMG represents an improvement over IMF (0.1% IWC), presumably due to the removal of the dividers as that is the only structural difference between IMF and IMG, the IMG backpressure of 0.08% IWC is still higher than the earlier described star shaped bluff bodies as in the 0.05% IWC for IMD.

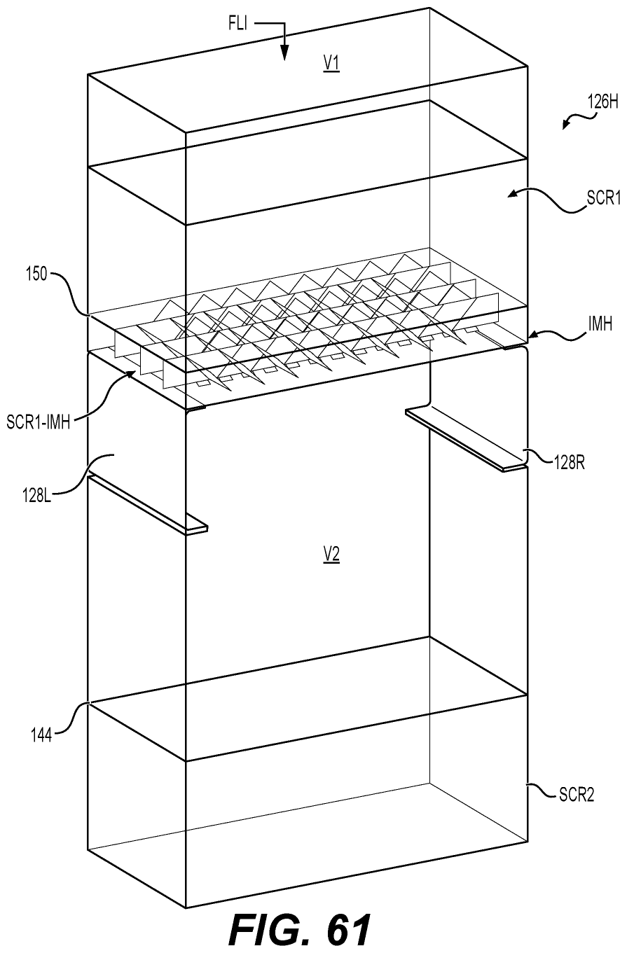

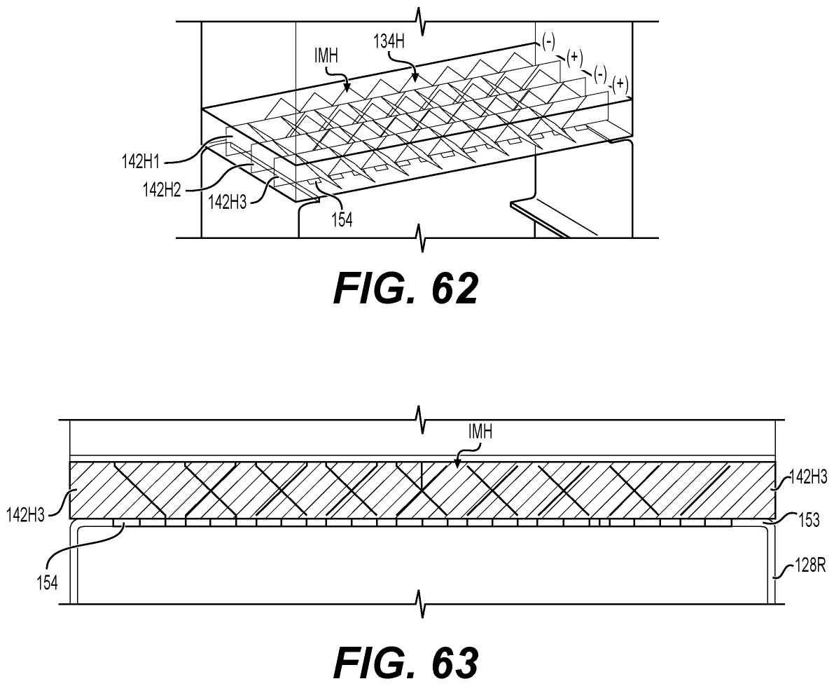

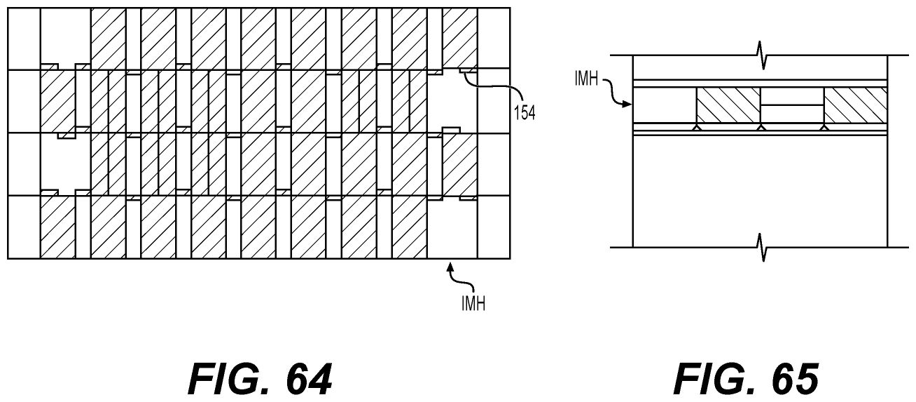

FIGS. 61 to 67 and FIG. set 68 correspond with the earlier presented figures for the various IM's and thus a detailed discussion as to the corresponding features is not provided. A comparison with SCR reactor 126H with that of SCR reactor 126F reveals that the only difference between the two structurally is that the IMH for SCR reactor 126H has added tabs 154 extending off divider walls 142H (1) to (3) (same as divider walls 142F(1)-(3) that are present in IMF). As best shown in FIGS. 62 to 64, tabs 154 are of limited upstream-to-downstream length (at or less than 20% of the peripheral frame structure height and more preferably of the same vertical height or less than the support beam flange thickness of the supporting grid SG1 supporting the frame device 129), in extending down from the supporting bottom edges of the respective divider walls and to the bottom plane region of the SCR1-IMH (essentially at the bottom of zone 1 at plane 153). As also seen from FIGS. 63 and 64 the tabs 154 are arranged as to be peripherally within the confines of the interior edging of the supporting flanges of the support grids, do not extend below the lowest surface of those supporting flanges and along the length of the divider walls extend in an inward angle and outward angle is repeating sequence along the divider walls. Tabs 154 are shown as being positioned in the gaps between the angled plates of the array 134H and to deflect outward toward an adjacent divider or long wall of the frame structure and thus to either the right or left (relative to the long walls of the frame). Further all tabs in a common gap are directed as a group in the same (left or right) direction while the next gap is provided with the opposite left or right deflection. The angling of the tabs can be fine-tuned with simulation although a starting point of 45 degrees (left or right) is illustrative of a potential starting point. Also, the rectangular plate configuration and array arrangement in IMH is the same as that in IMF (i.e., IMF and IMH feature a {right/left/right/left}−45° angle set up) but for the inclusion of the noted tabs 154.

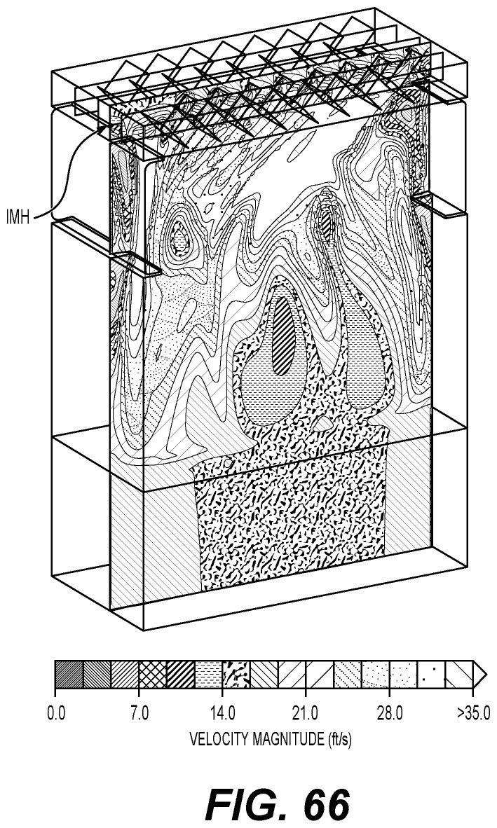

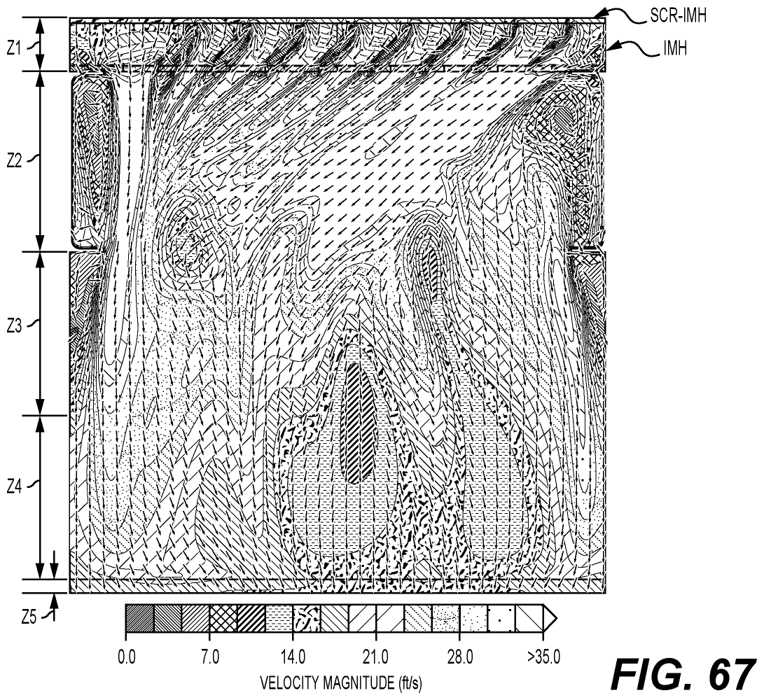

With that noted differential, a discussion of the flow patterns depicted in FIGS. 66 to 68 is provided. The velocity magnitude flow pattern featured in FIG. 66 and in greater detail in FIG. 67 shows some similarities with respect to IMF as may be expected with the common bluff body configuration and bluff body array patterns. The flow pattern's velocity magnitude deviation between IMF and IMH can be seen in a comparison of the respective velocity flow patterns to introduce some differences. For example, the addition of tabs 154 is considered to alter both the backpressure level and both the flow velocity pattern and the NNC pattern to some extent.

From a velocity magnitude viewpoint as best presented in a comparison of FIG. 67 of IMH (with tabs) with FIG. 51 of IMF (without tabs but otherwise the same) shows some similarities including the left side gap higher velocity area and the universal (all IMs) lower velocity regions directly behind the bluff bodies associated with each IM. A noted difference is the lessening of the relatively large zone Z4 slower velocity section between the two as well as a slightly finer break up as to the high-speed jets originating between the bluff bodies and extending down to the zones 3 and 4 interface area in each case.

Further a comparison between the rectangular bluff body embodiments and the star shaped (e.g., IMD) bluff body is a greater area region of lower velocity below the respective bluff body. That is, the IMs with the rectangular bluff bodies have a thinner, more crescent shaped slow region below bluff bodies while the stars have a less crescent, slightly more bulbous slow region below the bluff bodies associated therewith.

The NNC performance illustrated in FIG. set 68 of IMH is summarized in Table 7 below:

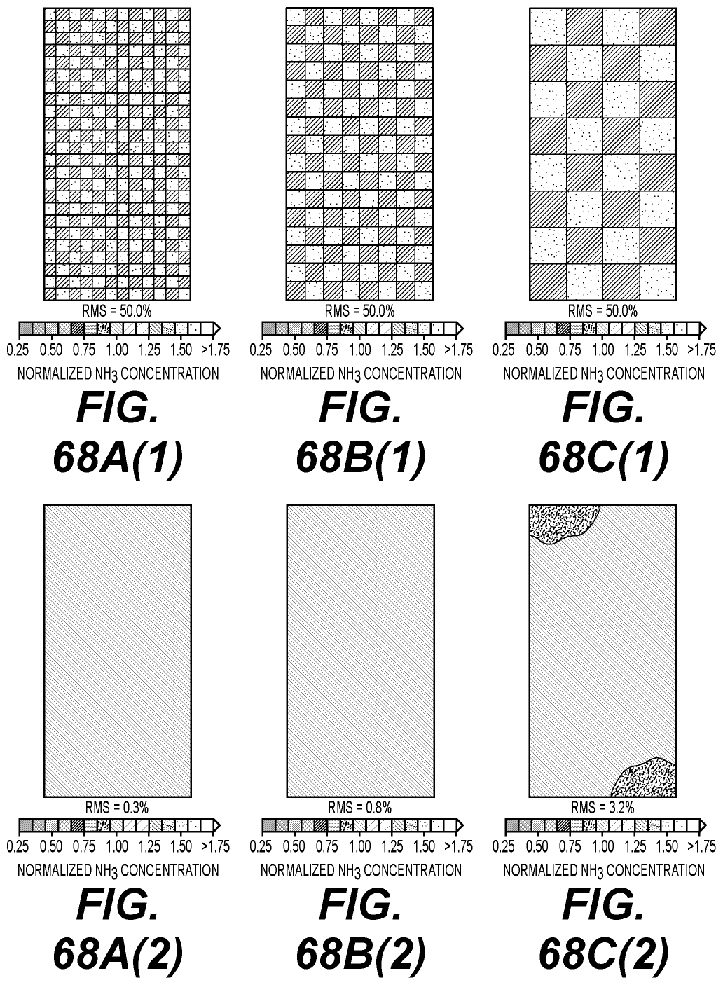

TABLE 7
IMH performance

| FIG. 68 | A | B | C | D | E | F |
|---|---|---|---|---|---|---|
| Pattern | Fine | Less Fine | Moderate | Large | Full | Full 25/75 w/ |
| | Check | Check | Check | Check | 50/50 | more diverse NNC |
| RMS (1) | 50% | 49.9% | 50% | 50% | 50% | 50% |
| RMS (2) | 0.3% | 0.8% | 3.2% | 6.1% | 19.9% | 17.6% |

A comparison of the IMH performance with IMF performance shows some improvement in IMH (tab added embodiment) but for FIG. 20D, which improvement may be due to the added disruption toward additional regions of the cross-section of flow referenced at plane 153.

While the right end (columns D to F) of the sub-dividing spectrum reaching the IM shows some benefit in IMH relative to IMF, a comparison of IMD to IMH shows that the IMD is still better suited to bring the RMS value down the most relative to patterns E and F. Thus, the results of the simulation for the IMH show that IMD still works best at the higher extremes of lower sub-dividing as represented by rows E and F in the summary tables presented above. Also, the inclusion of the tabs (and dividers) results in a somewhat larger pressure drop in IMH (0.1% IWC) for the IMH as compared to other IM arrangements as in the 0.05% IWC for IMD. Accordingly, in some cases the benefits of the simpler bluff body configuration (rectangular vs star pointed) while enabling a desired reduction value to be achieved under a backpressure deemed suitable for the given situation may be determinative. Alternatively, the added NNC benefit of included dividers and/or tabs coupled with the still less complicated rectangular bluff body design may be deemed advantageous under certain inflow environments despite the rise in backpressure.

Simulations above show that there can be achieved variations in the flow patterns which can be fine-tuned relative to the anticipated in flow of the mix. Further, the SCR reactor can be provided with an IM that can handle a wide range of inflow variations in the mix passing in the system, including a limited upstream sub-zone diversity. SCR reactor 126D with SCR1-IMD combination tested to be the best able at handling the more extreme lack of sub-division and thus is considered an SCR reactor well suited to facilitate achieving desired NOₓ reduction with limited slip (as in the above noted regulatory ranges for each). The inclusion of a supplemental turbulence generator, as in one placed in the upstream AIG area and/or an added torque generator in the intermediate area defined by void V2, can be featured as a supplement to the IMs featured herein or not utilized when the IM provides the degree of NOₓ reduction and slip avoidance sought for a given SCR reactor system (noting as well an added turbulence generator either upstream or downstream of the IM or both will introduce an associated further increase in backpressure). Also, if the system requirements dictate the IMs of the present invention can further include an added SCR3 layer (although as noted above the ability to avoid the introduction of an added SCR layer is an example of a benefit under certain criteria where the IM benefits are sufficient with only SCR1-IM and SCR2 layering). An added benefit of the IMs herein is that the increased drop in RMS can provide for lesser catalyst amounts (and lesser associated backpressure typically) than would be required with a conventional system in achieving a common NOₓ reduction and slippage value outcome as in one directed at achieving compliance with a regulatory requirement. In alternate embodiments where added backpressure is acceptable or there is a desire to attempt to achieve additional removal of NOₓ without ammonia slip there can be included such added turbulence generators downstream of the plane 153 (an inlet of the added turbulence generator (not shown) being positioned downstream of the IMs exit end (with the IM's exit corresponding with the SCR1-IM module block and frame device combination's exit end).

Table 8 below consolidates the SCR2 plane NNC readings for all the simulations described above to facilitate an appreciation as to how some arrays perform better than others relative to the given parameters.

TABLE 8
Consolidated RMS (2) values for the various IM structural embodiments
when faced with the above described NNC simulation patterns.

| FIG. 60 | A | B | C | D | E | F |
|---|---|---|---|---|---|---|
| @ RMS(2) | Fine | Less Fine | Moderate | Large | Full | Full 25/75 w/more |
| | Check | Check | Check | Check | 50/50 | diverse NNC |
| IMB | 1.0% | 1.5% | 3.6% | 11.2% | 37.0% | 29.7% |
| IMC | 1.0% | 1.4% | 3.4% | 8.7% | 19.9% | 20.1% |
| IMD | 1.7% | 1.6% | 4.0% | 9.4% | 16.0% | 16.3% |
| IME | 1.8% | 3.2% | 3.5% | 11.3% | 26.9% | 23.1% |
| IMF | 0.6% | 0.8% | 3.8% | 5.6% | 20.9% | 19.1% |
| IMG | 0.5% | 1.2% | 5.1% | 4.7% | 20.6% | 18.6% |
| IMH | 0.3% | 0.8% | 3.2% | 6.1% | 19.9% | 17.6% |

The above Table 8 shows circumstances where a star shaped body performs better than a rectangular simpler shaped rectangular bluff body, although under some circumstances the array adopted can result in worse performance for the star shaped bluff body as compared to the simpler rectangular shaped body (e.g., see the 37% performance for IMB as compared to the IMG's lower 20.6% RMS percentage value)

TABLE 9
provides a summary description of the array patterns featured.

| IM | | |
|---|---|---|
| type | Bluff body type | Pattern (angle) |
| IMB | Star shaped | all rows right (+) - (60 degrees) |
| IMC | Star shaped | right/left (−)/left/right - (60 degrees) |
| IMD | Star shaped | right/left/right/left - (60 degrees) |
| IME | Star shaped | right/left/left/right - (45 degrees) |
| IMF | Rectangle shaped | right/left/right/left - (45 degrees) w/divider |
| | | walls |
| IMG | Rectangle shaped | Same as IMF but no divider walls (45 degrees) |
| IMH | Rectangle shaped | Same as IMF but with added tabs (45 degrees) |

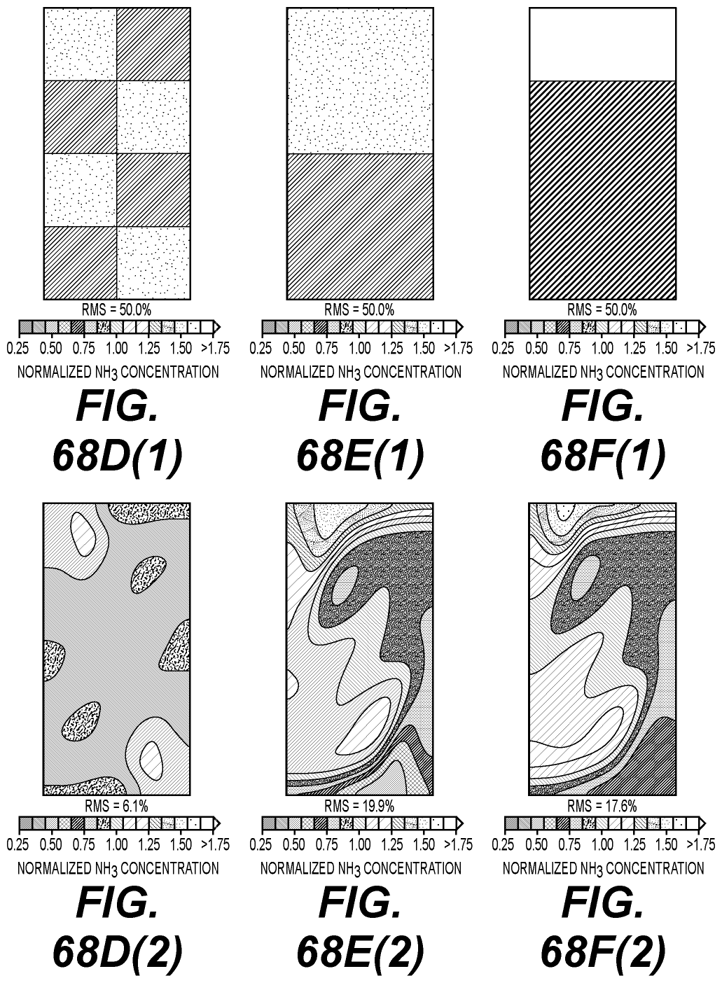

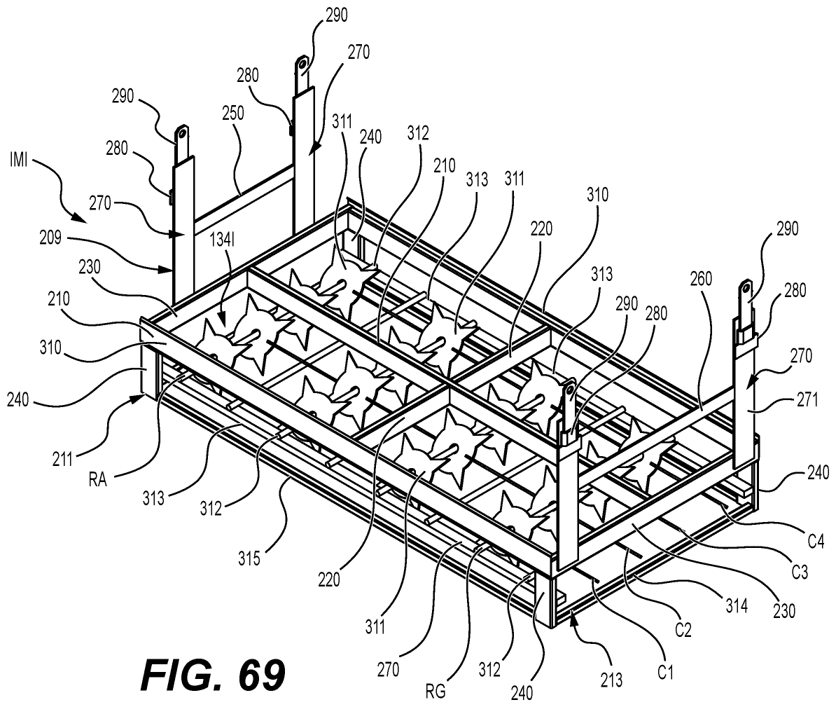

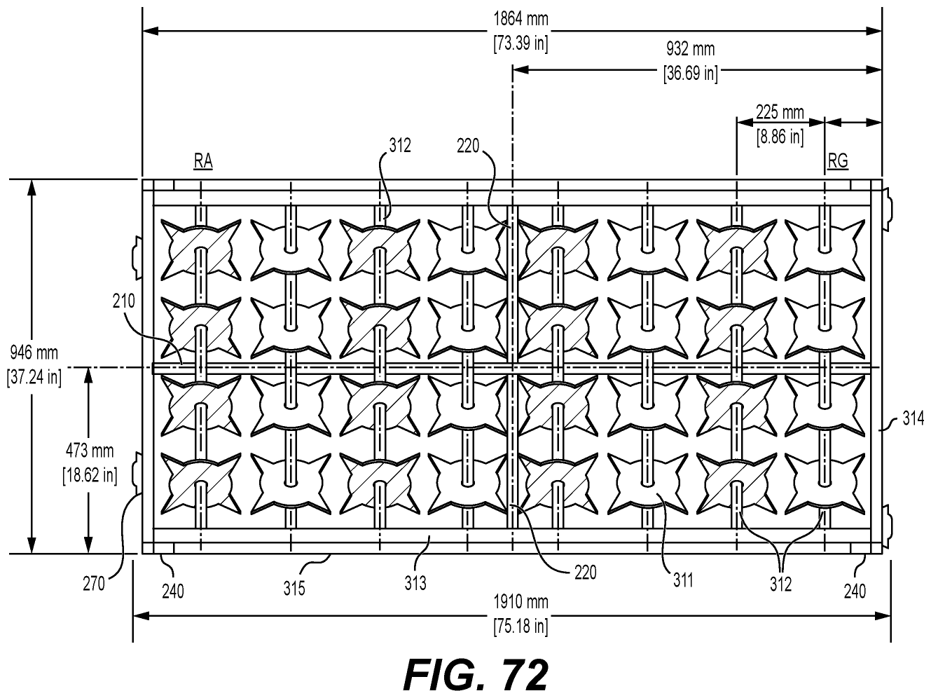

FIG. 69 shows a perspective view of intermixer IMI featuring a modified array 134I with some of the bluff bodies removed (see FIG. 72 for the full set view) to provide a clearer view of other components of intermixer IMI and to illustrate the potential adjustment in the array configuration when environmental characters dictate. For instance, flow conditions for the exhaust gas passing through the intermixer IM (and any RRI introduced) can vary depending on, for example, the type of combustion source 5 featured in the associated SCR reactor system, as in a flow range of 100,000 lb/hr to 11,000,000 lb/hr. IMI features frame device 209 that includes peripheral frame structure 211 which provides a robust multi-component structure (e.g., formed of CS ASTM A36 carbon steel) that can support the SCR1 module block associated with IMI (not shown in FIG. 69 as the focus is on the frame device for supporting the SCR1 module block in use). The carbon steel material is also well suited for a variety of component securement means as in welding.

Peripheral frame structure 211 is shown as having three transversely spaced elongated (longitudinal in the longer length direction of the rectangular peripheral frame structure shown) receiving tubes (longitudinal support members) 210 that are designed for SCR1 module unit or block support and retention (and thus each member 210 has a length well suited for receiving an SCR1 module block set such as featured in FIG. 2 (with a receiving tube length of 1813 mm being a non-limiting example designed for receipt of the roughly 1000×2000 mm SCR1 module block described above)). The three longitudinal support members are shown as forming an upper region of the three tier (in height) peripheral frame structure 211. Peripheral frame structure 211 further includes in the upper tier thereof a plurality of transverse support members that are represented in FIG. 69 by opposite end transverse receiving tubes (transverse end support members) 230 and an interior pair of transverse receiving tubes 220 that have interior most ends fastened (e.g., welded) to opposite vertical sides of the mid-section of the middle one of the three longitudinal support members 210. Thus, the middle longitudinal support member 210 and the two interior extending transverse support members 220 form together a support cross within the interior of the peripheral frame portion (rectangular in this case) represented by the two outer longitudinal support members 210 and the two transverse end support members 230 (again all preferably being welded together to provide a robust upper tier contact and support region for the SCR1 module block received by the peripheral frame structure 211).

Extending down from (preferably down from the lower edging of the upper tier frame peripheral frame structure components) are four corner struts 240. Each of the struts is further attached to the lower portion 213 (lower tier) of peripheral frame portion 211 that is comprised of two transversely spaced, longitudinally extending lower support members (e.g., steel square tubes) 315 and two longitudinally spaced, transversely extending lower support members 314 ((e.g., steel square tubes).

Peripheral frame structure 211 of frame device 209 further includes an intermediate or middle height tier represented by two longitudinally extending, transversely spaced support bars 313 that are fixed (at a preferred mid-height location) to the interior surface of respective pairs of the struts 240. The upper surface of support bars 313 thus provides a convenient support (and weld fixation) location for array support bars 312 on which is supported the bluff bodies (e.g., the same star shaped bluff bodies as described above and shown in FIG. 9). In FIG. 69 only ½ of the 8 illustrated array support bars are shown occupied with the bluff bodies to help illustrate the other peripheral frame and array components in clearer detail (and to show the option of not filling all potential support locations with bluff bodies if more gap spacing is desired). The array support bars or rods 312 are shown as extending essentially the full transverse spacing defined by peripheral frame structure 211 as to be well received by the upper surface of the two intermediate height support bars 313 such that the bluff bodies are suspended in the mid-tier region of the peripheral frame structure 211 of frame device 209. As in the earlier described embodiments the array support bars 312 preferably extend through a mid-region of each bluff body arranged along a respective one of the bluff bodies. Also, the bluff bodies are preferably equally spaced apart along the transverse length of the array support bars as to define 4 columns (see the C1 to C4 demarcations showing column alignment of the mounted bluff bodies shown) with respect to the 8 rows (sample rows RA and RG of the potential rows RA to RH demarcated) represented by the extension direction of the array support bars (only 4 of the potential 8 rows being occupied in FIG. 69).

As described above, the peripheral frame support structure 211 is well suited for supporting a plurality of different types of array designs inclusive of different bluff body shapes other than the star shape shown (e.g., different shaped bluff bodies as in a rectangular bluff body (version of which are described above and below) as well as different orientations and/or angles. In FIG. 69 there is shown a common orientation for all the bluff bodies supported within the peripheral frame structure 211 (fully encased via the mid-tier suspension of the array but for the preferred windows provided on all sides as for the aforementioned gas cannon cleaning). Further, array 134I features one common angle value in addition to the common orientation, with any of the aforementioned angles being available and with the illustrated embodiment featuring a 45° angle value.

FIG. 69 further shows frame device 209 of IMI as comprising attachment bars 270 having base bar section 271 fastened (e.g., welded) to a respective one of the transverse end support members 230, with the illustrated right-side set of base bar sections 271 being spaced farther apart in the transverse direction (e.g., (as shown in FIG. 72) to be vertically aligned with the longitudinally extending intermediate height support bars 313) and with the opposite end set of base bar sections 271 being less spaced apart in the transverse direction relative to their attachment to the left side transverse end support member 230 (e.g., (as shown in FIG. 72) to be aligned with the longitudinally extending columns C1 and C4 of the array 134I). This arrangement provides added stability as when the attachment bars 270 are being used for SCR1 module manipulation as in delivering and placement/removal upon an SCR1-IM access requirement such as during reactor assembly manufacture, refurbishing, module element updating, cleaning, etc.)

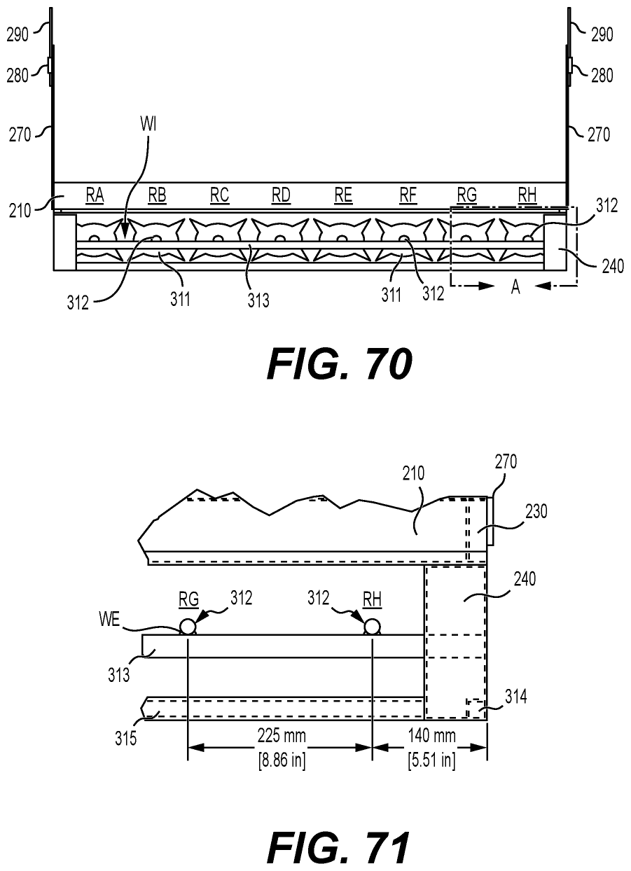

FIG. 70 shows a front view of that which is shown p FIG. 69, and in this view all bluff bodies that are in the first column relative to the 8 rows (RA to RH) are shown in position on respective support rods 312. FIG. 70 also shows the support relationship provided by the two intermediate tier support bars 313 (one shown). There can also be seen via the long open window W1 featured along the front view side shown that the bluff bodies are all encased within the peripheral frame structure 211 components both peripherally and from a height standpoint (noting the adjustment as well in top and bottom edging associated with the illustrated 45° angle α).

FIG. 71 shows a more detailed view of referenced detail A in FIG. 70. Also, in FIG. 71 the bluff bodies depicted in that region in FIG. 70 have been removed for added clarity. FIG. 71 further shows the meshing nature of the various components of the three-tier frame structure as well as weld WE shown relative to one of the support rods 312 to fix that rod (and supported bluff bodies when present) in the suspended state for the array 134I.

FIG. 72 shows a bottom view of that which is shown in FIG. 69 and thus there can be seen in greater detail the peripheral frame structure 211 components forming the lower tier including the aforementioned square tube members (314 and 315) which together (in conjunction with the lower end of struts 240) define the peripheral framing at that lower tier (as well as the intended resting surface for the entire SCR1-IM relative to the underlying support grid SG1). FIG. 72 also shows the full set of bluff bodies in position which turns the common orientation presentation of FIG. 69 into one with both plus and minus orientations and with all having the common 45° angle. In conjunction with the aforementioned about 1000×2000 mm SCR1 module block example, there is shown some suitably non-limiting dimensions well-suited for handling such module blocks. For example, the transverse extension length of the transverse portion of the peripheral frame structure 211 is also of a similar length (e.g., about 1000 mm) as to conform in dimensioning (relative to the support and retention function in frame device relative to the received SCR1 module block). The height from the lowest surface of frame device 209 to the upper edge of the four attachment members 270 shown is also preferably designed with the height of a double vertical stack module unit set up in the SCR1 block of the module as shown in breakout in FIG. 1 for example.

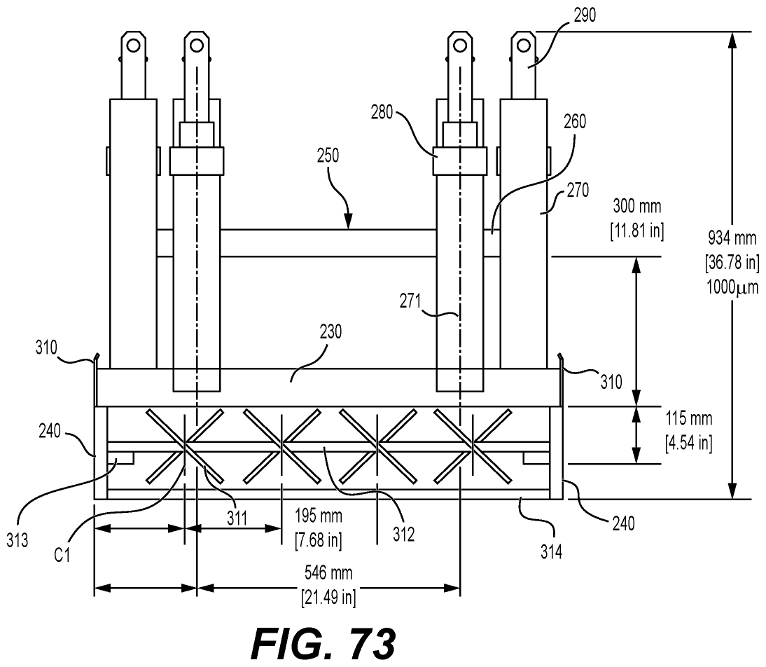

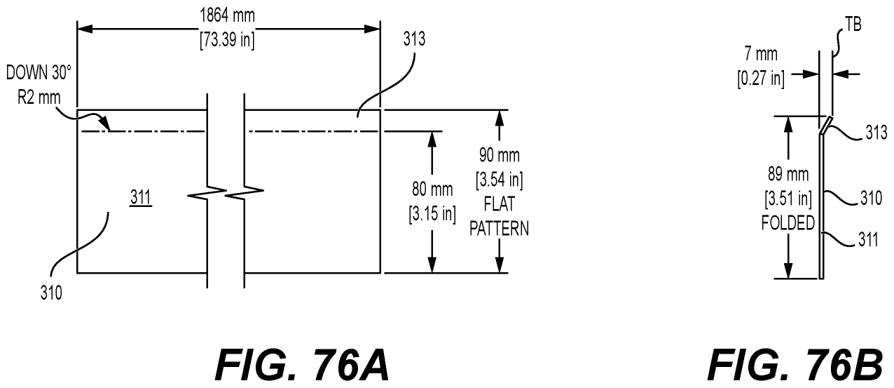

FIG. 73 shows a left-side view of that which is shown in FIG. 69 (together with some non-limiting corresponding dimension examples). Thus there can be seen via the crossing nature of the various bluff bodies along a common column. FIG. 73 also presents a view of retaining plates 310 which are fixed to opposite outer longitudinal support members 210 as to extend higher than those members (highest extending components in the upper tier peripheral frame structure). A more detailed view of retaining plates 310 can be seen in FIGS. 76A and 76B wherein there can be seen the base portion 311 as flat (vertical steel sheeting of 2 mm, for example) and the upper height portion (e.g., upper 20% as in about 10%) is bent as to extend inward relative to the mounting location on the noted upper tier longitudinal support members). The degree of inward bend for the upper portion of each retaining plate is of a length to help in retention position of the SCR1-IM module block without too much disruption relative to mounting of the module block SCR1 on the frame device 209 (e.g., a 7 mm inward bend extension). Retaining plates 310 also extend preferably for a similar longitudinal length as the longitudinal support members 210 as seen by the corresponding, non-limiting dimensions provided.

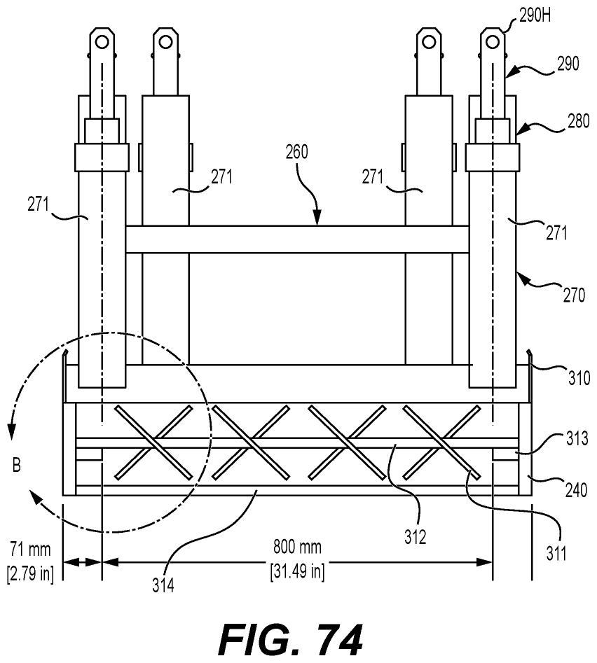

FIG. 74 shows a right-side view of that which is shown in FIG. 69 and is similar to the opposite view (but for the presentation of stabilization bars 250 and 260 which are arranged such that the longer of the two struts 260 extends across for connection with an interior side (at about the mid-way height location relative to base bar sections 271), while the shorter of the two struts 250 extends to an exterior side of the other end set of base bar sections 271 at the same mid-way location.

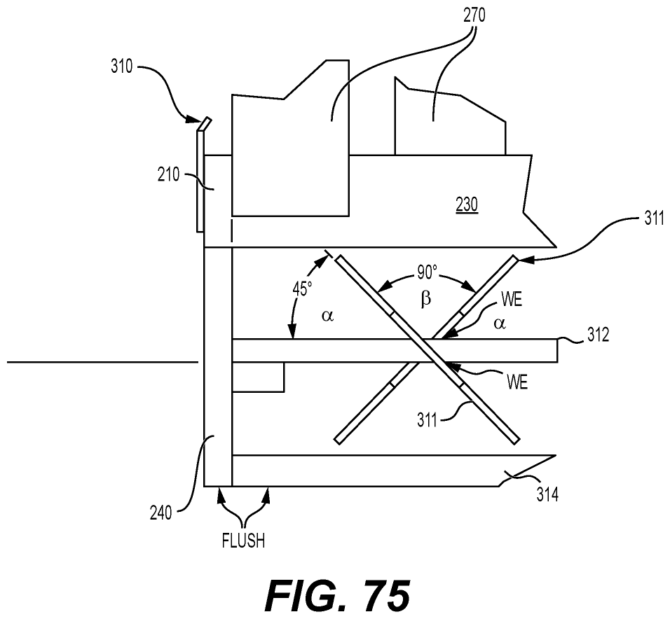

FIG. 75 shows a more detailed view of referenced detail B in FIG. 74 including a clearer view of some of the star shaped bluff bodies in column C1 of array 134I. There can be seen the longitudinally spaced crossing of the two different oriented bluff bodies (the first two bluff bodies in the column C1 that are longitudinally spaced apart in the peripheral frame structure 211) is based on the nature of attachment of those bluff bodies to their respective support rods. This attachment in FIG. 75 is shown by way of welds at the vertices of the bluff-body contact with the respective support bar. In array 134I the α angle is shown to be the same (e.g., each) 45° relative to the horizontal plane represented by bars 312 and with the crisscross relationship resulting in an upper between angle of (180-2α) or 90° for the α=45° featured in FIG. 75

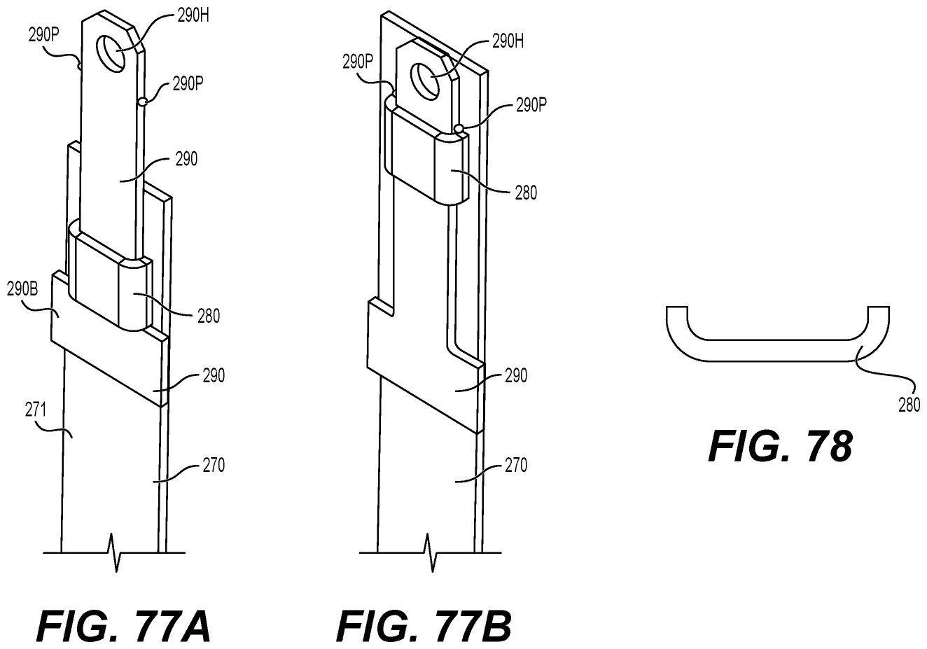

FIG. 77A shows a cut-away, closer view of the T-shaped lifting lug 290 in an “up” ready for engagement state as well as its slide/retention arrangement that enables it to retract and slide up without falling off from its supporting (respective) attachment member 270. FIG. 77B shows it in its disengaged or slid down state. While in the engaged or up state the upper holding aperture 290H is made available (exposed) for hook or other engagement means attachment as in a cable hook set up relative to a supporting gantry or other lifting and dropping means. While in its lifting up state (engagement state) the horizontal base 290B of the T-shaped lug 290 catches the underside of C-shaped bracket 280 as to block from sliding farther up on the receiving slide surface of base 271 of attachment member 270. FIG. 78 shows C-shaped bracket 280 in a separated state (prior to welded fixation to the noted slide surface of base 271) as well as its C-shape with curved free ends and straight intermediate section.

FIG. 77B shows a view of the T-shaped lifting lug of FIG. 77A in a “down” disengaged state. As seen, T-shaped lug 290 has a pair of stop projections 290P to opposite side edges of the vertical part of the T-shaped lug (closer to the engagement hole 290H near the free end of the vertical part). Upon sliding down, the T-shaped lug's stop projections 290P abut on the upper surface of the fixed C-shaped bracket as to preclude further slide down (or separation of the lug from the remainder of the attachment member 270). FIG. 77B shows that the upper edge of the lug 290 is commensurate (on a common horizontal plane) with the upper free edge of the base 271) and preferably does not extend above the upper surface of the SCR1 module block in the disengaged setting, but can extend above or clear the module block when moved up into the engagement state.

Thus, frame device 209 of IMI has the noted peripheral frame structure 211 as well as the attachment means represented by the attachment members 270 with associated sliding L-shaped lugs with aperture and stop projections as well as the fixed attachment base members 271 extending up from the peripheral frame structure.

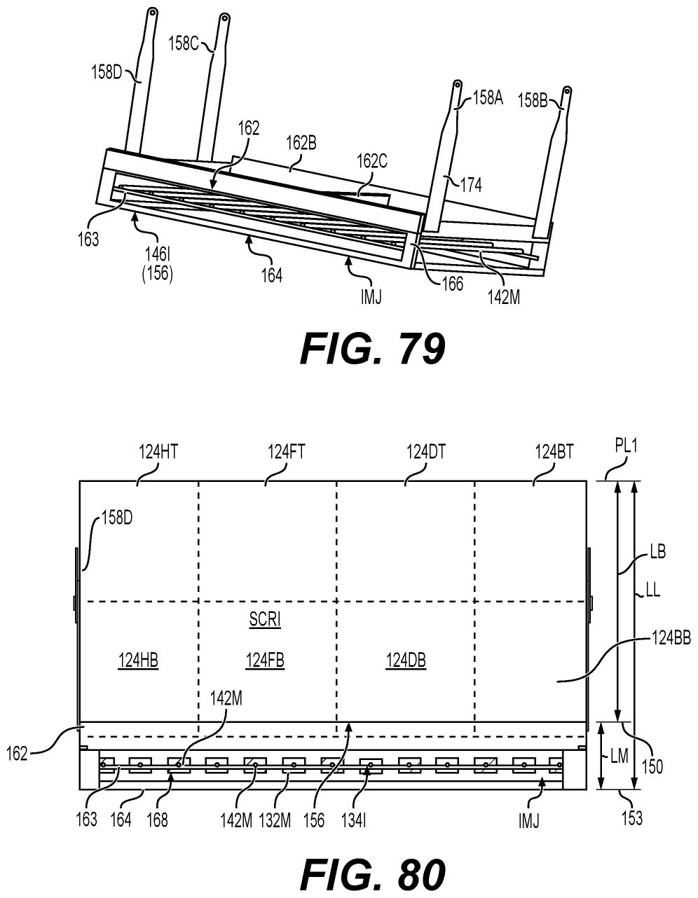

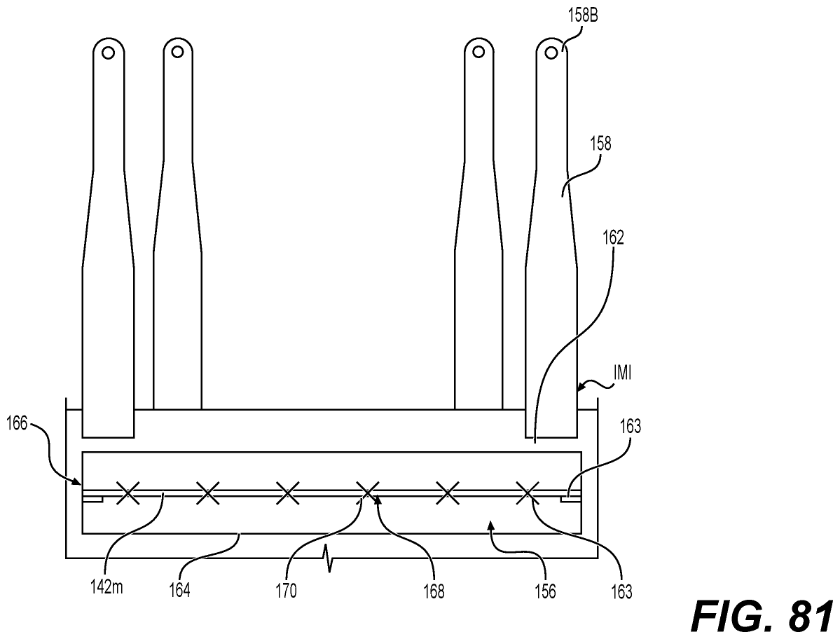

FIG. 79 shows a perspective view of the three-tier frame structure 156 of intermixer IMJ with the plates in array 134J removed for frame structure 156 clarity. FIG. 81 shows a short side elevational view of that which is shown in FIG. 79 with the open “windowed” short side ends depicted and with the array 134J depicted. FIG. 80 shows a front elevational view along the “windowed” long side of that which is shown in FIG. 79 again with array 134J depicted.

Intermixer IMJ is shown as comprising a modified frame structure assembly 156 that shares similarities with the other IMs (including the potential for added attachment extensions 158 for attachment with cabling via hooked engagement to facilitate placement of the modules as on a receiving support grid as in a respective one of SG1 to SG3). The noted attachment extension 158 can also be provided with the retractable slide constructions 290 feature in FIG. 73. IMJ also is shown below a similar SCR1 module unit stack (e.g., a double height 8×2 SCR module element block stack like that featured in FIG. 1 but on an IM frame). Like the IMI array frame arrangement, the IMJ frame structure assembly 156 is shown with an altered array support arrangement featuring a switching of the support bars 142M supporting the bluff bodies from a long length extension to a short length extension (in series across essentially the full area of the interior of the periphery of the base region of the peripheral frame structure of frame structure assembly 156). Frame structure assembly 156 includes peripheral frame structure 160 having a similar three-tier height arrangement with an upper (or first) frame structure portion 162, an intermediate (or second) array support structure portion 163 designed to support the array bars 142M, and a lower (or third) frame structure portion 164. Each of the first, second and third frame structure portions are dimensioned for supporting a received SCR1 layer module block with the upper frame structure portion preferably having a vertical peripheral extension portion in which the module block set is partially received. Frame structure portion 162 is also defined by internal crossed-frame structure portion 162C (adding strength to the rectangular shaped frame structure assembly 156 as well as providing an underlying support platform for the SCR1 module block provided thereon).

FIG. 80, further illustrates the SCR layer as including frame structure assembly 156 of height L_{M} and with the exposed part of the SCR1 block of height L_{B} as to retain a common height configuration with the corresponding (IM less) frame structure and received module block of SCR2.

Frame structure portion 162 is shown as having two parallel long side walls and two parallel short side walls. Frame structure assembly 156 further shows the intermediate array support structure portion 163 falling midway between the upper and lower frame structures. Lower frame structure portion 164 also having two corresponding in peripheral length size (relative to the four walls of the frame structure portion), but of a thinner vertical width dimension and without the cross-frame structure portion 162C. At each intersection of the longer and shorter sets of walls in both the upper and lower frame structure portion there are a plurality of spacer corner struts 166 which complete the frame structure by joining the upper and lower frame structure portions together with “window” gaps along each of the four sides not already occupied by frame structure components. As noted, this window provides convenient access to cleaning (built up soot, for example) for the bluff bodies and bluff body array supporting structure as by way of air cannons strategically placed inside the ductwork as to blast air in the noted windows.

As with the earlier embodiments, intermixer IMJ has a bluff body array 168 comprised, in this case, of a plurality of rectangular bluff bodies 170 (like those rectangular ones described above although a different bluff body shape is contemplated for IMJ if the environment dictates (e.g., flow rates, pollution levels, etc.) as is true for the other IMs described herein). Each bluff body 170 of array 168 (or 134J) is supported by a respective one of the plurality of the array bars 142M that extend perpendicularly between the long side walls for frame structure 156 and are fixed to the intermediate or second frame structure portion 163 at opposite ends (as best shown in FIG. 79). The number of rows and columns as well as the number (and relative size of bluff bodies) can be varied to achieve the desired intermixing as well as level of backpressure that can be accepted. In the array 168 there are more rows and columns (a matrix of 13 rows (equates with the number of array bars 142M) with each row having equally spaced bluff bodies arranged in series on bars 142M with the number in that series being variable to suit a particular desired flow pattern and with parallel extending (parallel with long side walls) of the frame support 163. FIG. 81 shows that there are six columns as represented by the aligned bluff bodies positioned on the respective array bars 142M. As with the earlier described IMs, support bars 142M extends through a receiving central aperture of each bluff body being supported by a particular support bar, with each shown having a particular orientation that is preferably common on a common support bar but is shown varying from bar to bar. As with the above IMs the bluff body pattern can be designed to suit an anticipated SCR reactor environment with the array 168 having a desired orientation pattern as well as a plate angle like any of the above-described angle of ranges (common throughout the array or an angle variation as in from row to row or in sub-regions of the area of the IM).

FIG. 80 shows a right-left-right . . . sequence for the bluff bodies from one column to the next as seen by the light-dark (or dashed/not-dashed) sequence. This different orientation can be seen by the crossed bluff body presentation in FIG. 81. Also, with a preferred common length-width arrangement for the periphery of frame structure assembly 156 and with a preferred similar BA/BO relationship retained, it can be seen that the increased number of bluff-bodies shown can be relative to smaller plate sizes as described above, or if a greater blockage percentage is desired the plate sizes in FIG. 80 can match those previously described.

The invention is further inclusive of a method of assembling an SCR reactor apparatus such as any one of the aforementioned SCR reactor apparatuses (e.g., SCR reactor apparatus 126D) that includes the combining of an SCR module block (with SCR catalyst material) and a frame structure (preferably three tiered) having one of the various SCR-IMs described above such that a bluff body array of the SCR-IM is arranged for exhaust flow contact with a mix of flow components as in NOₓ and NH₃ components exiting the SCR module block supported on the frame structure.

The invention includes a method of assembly an SCR reactor assembly comprising placement of an SCR reactor apparatus (any one of the various SCR reactor apparatuses described above having different SCR-IMs (any of the various SCR-IMs described above)) within ductwork of the SCR reactor assembly, at a location downstream of a reduction reagent injection means (e.g., an AIG) as well as upstream of a downstream SCR layer (e.g., SCR2).

The invention includes a method of assembling an SCR reactor system that includes placing any one of the above-described SCR reactor assemblies in exhaust flow communication with a combustion gas source such as a coal fired combustion plant.

The invention includes a method of assembling a mixing device which includes assembling a three-tier frame structure and supporting a bluff body array in a suspended state on the middle tier. The method of assembling the mixing device further includes providing vertically extending attachment means with lockable, extendable-retractable attachment ends.

The invention includes mixing a combination pollutant (e.g., NOₓ) and reduction reagent (e.g., NH₃) with any one of the aforementioned mixing devices or SCR reactor apparatuses in order to lower an RMS % value of the combination passing past the SCR reactor apparatus. The invention further includes a method of operating an SCR reactor assembly including passing the noted combination through any one of the aforementioned SCR reactor assemblies. The invention is still further inclusive of a method of treating the combination sourced from any of the aforementioned combustion gas sources within any one of the SCR reactor assemblies (with the SCR reactor assembly utilized, and the combustion gas source utilized (e.g., a coal fired plant) together defining an SCR reactor system).

Exemplary embodiments of systems, methods, and apparatus are described above in detail. The systems, methods, and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

In the present disclosure it is also intended that value points are inclusive of all intermediate points (and all sub-ranges within a larger specified range) at a common index unit value—as in a range of 1 to 10 is inclusive of 2, 3, 4 . . . to 9 as well and available sub-ranges therein as in 3 to 5), or as in a range of 1.0 to 10.0 is inclusive of all intermediate points 1.1, 1.2, 1.3 . . . 9.9) (and all sub-ranges within a larger specified range as in 1.3 to 1.7).

1. A selective catalytic reduction (SCR) apparatus suited for use in a stationary SCR catalyst environment, comprising:
an SCR module unit or block having one or more SCR module elements and an intermixer, wherein the intermixer includes a peripheral frame structure that supports an array of bluff bodies and on which peripheral frame structure is received the one or more SCR module elements such that a combination of gas flow components passing through the one or more module elements is contacted by the array of bluff bodies before exiting the SCR apparatus.

2. The SCR reactor apparatus of claim 1, wherein the SCR module unit comprises a plurality of module elements with each containing SCR catalyst material.

3. The SCR reactor apparatus according to claim 1, wherein the bluff bodies are received entirely within the confines of the peripheral frame structure both from a standpoint of confinement relative to a direction of flow of the combination and relative to a cross-sectional plane perpendicular to that direction of flow.

4. The SCR reactor apparatus according to claim 1, wherein the peripheral frame structure is at least a three tier structure and the angled bluff bodies are arranged in a bluff body array supported on an intermediate tier as to be suspended within the peripheral frame structure.

5. The SCR reactor apparatus according to claim 1, wherein the combustion gas includes NOₓ pollutant, and a reduction reagent comprising NH₃, with the combination being intermixed by the intermixer.

6. The SCR reactor apparatus according to claim 1, wherein the bluff body array includes both angled and different oriented bluff bodies arranged in different orientation rows, and wherein different oriented bluff bodies include bluff bodies with the same angle of incline of from 30° to 70° but in different orientations that are defined by different bluff body rotation directions relative to a plane extending through the intermixer at a center of one or more of the bluff bodies.

7.-9. (canceled)

10. The SCR reactor apparatus according to claim 6, wherein the bluff body angle of rotation is from 45° to 60°.

11. The SCR reactor apparatus according to claim 1, wherein the intermixer comprises a plurality of star shaped bluff bodies that are arranged in different angle direction orientations in series across the peripheral frame structure of the intermixer.

12. The SCR reactor apparatus according to claim 1, wherein the intermixer introduces backpressure of less than 0.06 IWC.

13. (canceled)

14. The SCR reactor apparatus according to claim 1, wherein the bluff body array includes different oriented bluff bodies arranged in different orientation rows, and the intermixer different orientation rows include some bluff bodies having left side initial flow contact lead edging placed above a plane extending though the bluff bodies and some bluff bodies having right side initial flow contact lead edging placed above said plane as to define a right-left or left-right sequence in the bluff body array.

15. The SCR reactor apparatus according to claim 14, wherein the bluff bodies have a right/left/right/left (or left/right/left/right) array orientation sequence across the plane extending through the bluff bodies.

16. (canceled)

17. The SCR reactor apparatus according to claim 1, wherein the one or more SCR module elements having SCR catalyst material includes a plurality of module elements having an outer casing within which is positioned SCR catalyst material, and the module elements are supported on an upper portion of the peripheral frame structure of the intermixer.

18. The SCR reactor apparatus according claim 17, wherein there is a double layer of stacked module elements in flow through alignment that are supported on an upper portion of the peripheral frame structure of the intermixer.

19. The SCR reactor apparatus according to claim 1, wherein the peripheral frame structure of the intermixer includes one or more cleaning gas burst access windows, which one or more windows are on a common plane perpendicular to the flow direction as to provide cleaning gas burst contact access relative to the bluff body array of the intermixer.

20. The SCR reactor apparatus according to claim 1, wherein the peripheral frame structure has a three-tier configuration with an upper frame portion for supporting module elements of the SCR module unit, an intermediate frame portion for supporting the bluff body array, and a lower frame portion for underlying ductwork framing support contact.

21. An SCR reactor assembly, comprising:
ductwork that channels a combination of exhaust gas and reduction reagent within an inlet portion of the ductwork;
a first SCR1 catalyst layer structure that comprises the SCR reactor apparatus according to claim 1 and is positioned for flow contact with the channeled combination;
a second SCR2 catalyst layer structure that is positioned within the ductwork as to be positioned downstream from the first SCR1 catalyst layer structure and is positioned for contact with the combination after the combination is subjected to a reduction in RMS value by the SCR1 layer, and
a reduction reagent injector having an injector outlet that feeds into the ductwork upstream of the SCR1 layer structure.

22. The assembly of claim 21 wherein the SCR1 layer structure has a total length LL and the upstream to downstream length LM occupied by the peripheral frame structure of the intermixer within the SCR1 layer structure is less than 20% percent of that length LL, and wherein the bluff body array of the SCR1 layer structure includes different oriented bluff bodies arranged in different orientation rows at an interface region of the one or more SCR module elements and the intermixer.

23. (canceled)

24. The SCR reactor assembly according to claim 22, wherein the different orientation of the bluff bodies includes the same angle of incline but in different orientations, with the different orientations in the bluff bodies being defined by different rotation directions to a plane extending through the peripheral frame structure of the intermixer at a center of one or more of the bluff bodies.

25. The SCR reactor assembly according to claim 21, wherein an SCR2 layer structure inlet is positioned downstream of the SCR1 layer structure outlet (a length Lv), which is essentially the same length as the distance between the outlet end of the intermixer and the downstream SCR2 layer structure inlet, and a void defined by the ductwork over the length Lv is free of any designed turbulence generating device.

26. (canceled)

27. An SCR reactor system comprising the SCR reactor assembly according to claim 21 and a combustion source that feeds combustion to an inlet of the ductwork.

28. The SCR reactor system of claim 27 wherein the combustion source is a coal fired plant.

29. A method of operating the reactor system of claim 27 comprising feeding combustion gas generated by the combustion gas source to an inlet end of the ductwork for channeling of the combustion gas together with ammonia or ammonia precursor as the reduction reagent to the SCR1 layer structure in the ductwork and exhausting a mix of the combustion gas and ammonia or ammonia precursor as the reduction reagent toward an outlet end of the ductwork.

30. (canceled)

31. A method of assembling the SCR reactor assembly according to claim 21, comprising positioning each of the first SCR1 catalyst layer structure and a second SCR2 catalyst layer structure within the ductwork.

32.-33. (canceled)

34. A mixing device for mixing a reduction reagent and pollutant traveling with an exhaust flow from a combustion source, the mixing device comprising:
a bluff body array; and
a frame structure configured to receive a selective catalytic reduction (SCR) module unit, wherein the bluff body array is secured to the frame structure as to be positioned internally within the periphery of the frame structure and such that the pollutant in the exhaust gas and the reduction reagent exiting the module unit are mixed within the bluff body array.

35. The mixing device of claim 34 wherein the frame structure is configured to receive a stationary SCR module unit comprised of a set of SCR module elements, and wherein the bluff body array includes a plurality of plates that are dimensioned to be encompassed by the frame structure both from a peripheral standpoint and a flow direction standpoint.
